(19) United States
(12) Patent Application Publication
(10) Pub. No.: US 2023/0196471 A1
(43) Pub. Date: Jun. 22, 2023

(54) METHODS AND APPARATUS FOR INTEGRATED HEALTHCARE ECOSYSTEM

(71) Applicant: WeissComm Group, Ltd., d/b/a Real Chemistry, San Francisco, CA (US)

(72) Inventors: Marcos A Mendell, New York, NY (US); Rita Marie Glaze-Rowe, Crystal Lake, IL (US); Hollie Paula Francesca Noble, Brooklyn, NY (US)

(73) Assignee: WeissComm Group, Ltd., d/b/a Real Chemistry, San Francisco, CA (US)

(21) Appl. No.: 17/702,785

(22) Filed: Mar. 23, 2022

Related U.S. Application Data
(60) Provisional application No. 63/215,819, filed on Jun. 28, 2021.
(60) Provisional application No. 63/297,777, filed on Jan. 9, 2022.
(60) Provisional application No. 63/234,013, filed on Aug. 17, 2021.

(51) Int. Cl. G06Q 40/08; G06Q 30/0207

(52) U.S. Cl. CPC G06Q 40/08; G06Q 30/0207; G06Q 2220/00

(57) ABSTRACT

Some embodiments relate to computer implemented methods and apparatus for integrating healthcare related events and services for a customer having insurance coverage provider via a web-based platform. The method and system enables providing a link to a customer that enables the customer to access the platform so as to enter healthcare information that includes insurance information relevant to the healthcare insurance provider during an initial registration session, identifying a pharmacy that is local to the customer and accepts the customer's healthcare coverage, transmitting a communication to the customer that includes an uncovered cost due for the therapeutic or diagnostic, facilitating the payment process from the customer to the healthcare provider via a secure payment processor, and notifying the customer of the identified pharmacy.

### BACKGROUND

Some embodiments provide methods and apparatus for therapeutic, diagnostic and prescription management and overall healthcare management. However, other embodiments can pertain to management of concepts outside of healthcare context.

The decentralized management of US pharma and healthcare industry is a significant reason behind the disconnect between patients, insurance companies, drug manufacturers and drugstores. This major disconnect bears the need for an omnichannel integrated platform to connect patients, healthcare providers, pharmacies, insurance companies, medical and pharmacy benefit systems, copay benefits providers, and payment processors all in a turnkey solution. The COVID-19 pandemic further exacerbated this disconnect.

### SUMMARY

Patients typically use a variety of services to obtain a healthcare product or service, pay for, and ultimately fulfill their healthcare need, such as, e.g., healthcare providers, insurance companies, phlebotomy services, and pharmacies (physical or online). Different resources and specialized personnel are needed to run, maintain, and staff these services, and the patient flow between where the patient initially seeks healthcare services and receives their medication is frequently broken when these separate services meet, due to causes such as lack of coverage or inability to validate benefits, lack of affordable generic alternatives, or pharmacies lacking the prescribed medication. As a result of these challenges and opportunity in addition to the COVID-19 pandemic, telehealth services have become more popular. While they attempt to connect these steps, at least providing access to virtual physicians and nurse practitioners via an app or web-based platform, they lack the ability to connect telehealth patients to pharmacies, or to offer a robust selection of services and lack the artificial intelligence to interact meaningfully with patients about brand and therapeutic area or diagnostic services before referring them to the most relevant service.

It may also be beneficial to provide an interconnected service to retain customers, ensure they receive the scripts they need, then track delivery/pickup and drug outcome. Thus, some embodiments are directed to methods and apparatus that handle those seeking healthcare and/or in need of pharmaceutical prescriptions though the entire healthcare process, from healthcare service advertising, data collection, phlebotomy services, telehealth and in-person visits, prescriptions, pharmacy operations including prescription fulfillment, and medication receipt by the patient. By monitoring where the patient interacts with the service, healthcare provider, etc. the program can identify gaps in performance, and some embodiments handle those gaps by directing clients away from underperforming telehealth providers, checking for benefit coverage to match clients to covered/affordable services and medications, providing financial support solutions such as copay cards, financial support referrals, sending e-scripts directly through the program instead of needing a paper script, etc.

It may be beneficial to provide patients with transparent and direct services that utilize digital assets. 75-80% of behavioral or mental health visits can be done virtually. 35-40% of medical care in the US can be virtualized. Broader virtual health solutions can also be provided, such as “digital front door” or lower-cost virtual-first health plan.

Current systems and platforms address certain aspects or sub-elements of the healthcare process, but no system or platform addresses the entire healthcare process. Some of the present embodiments are able to address the entire process by attracting customers via online and physical advertising, deploying an intelligent AI agent/conversational artificial intelligence (CAI) agent to ask screening questions and direct patients to telehealth providers that meet their needs, receiving scripts from telehealth providers, providing a list of pharmacies alongside benefit coverage and competing drug costs, allowing the patient to choose the pharmacy that will receive their script, sending that script to the pharmacy, supporting and monitoring prior authorizations required by benefit providers, monitoring fulfillment and updating the client when their script is received and ready, monitoring drug outcome, and reporting progress and changes to the patient's doctor.

Some embodiments are directed to a platform for managing a healthcare need of a patient from the beginning to the end. Some embodiments provide a seamless and integrated customer experience by merging various stakeholders of healthcare industry which are historically fragmented in a single platform.

Some embodiments are directed to creating a seamless and integrated customer experience in healthcare industry by merging various stakeholders in a single platform and creating value by forming partnerships with service providers to address brand, patient and healthcare provider unmet needs.

Thus, some embodiments are related to an online platform implemented with machine learning software to provide otherwise unobtainable transaction-based data and platform operations. Some of these embodiments are more specifically related to methods and apparatus for integrating and facilitating transactions involving goods and/or services related to health, beauty and wellness.

The present platform seeks to streamline the healthcare process by: (1) Maximizing commercialization by forecasting market size, competitive landscape, and potential ROI; (2) Utilizing statistics to model the number of cases of a disease are present in a particular patient population at any given time; (3) Identifying the physical, biological, social, environmental, cultural, and behavioral factors that influence health; (4) Profiling patients to understand their lives, attitudes, and behavioral factors that influence their health and conditions; (5) Creating a treatment journey map to understand the composition of care events and touchpoints toward a successful diagnosis and treatment plan; (6) Uncovering patients who are undiagnosed and/or misdiagnosed; (7) Identifying influential HCPs in diagnosing and treating patients; (8) Identifying and prioritizing HCPs relevant to certain brands while allocating resources for promotion based on profiles; (9) Creating a network of referrals; and (10) Discovering the profiles of each specialty to determine behavioral observations and (11) Creating a knowledge map of medical professionals by analyzing their past influences to predict their future behavior and provide full transparency.

Thus, some embodiments are directed to a computer implemented method and system for integrating healthcare related events and services for a customer having insurance coverage providing a link to a customer. This enables the customer to access the platform so as to enter healthcare information that includes personal information relevant to the healthcare insurance provider during an initial registration session; receiving and storing the entered healthcare information via a secured storage medium; receiving and storing coverage information from the healthcare insurance provider including indications as to whether a certain diagnostic or therapeutic is covered by the insurance provider; comparing the entered healthcare information to the coverage information to determine whether the certain diagnostic or therapeutic is covered by the insurance provider during the initial registration session; upon determining that the therapeutic or diagnostic is covered by the insurance provider, transmitting a communication to the healthcare provider indicating that the certain therapeutic or diagnostic is covered by the insurance provider; upon determining that the therapeutic or diagnostic is not covered by the insurance provider, transmitting a communication to the customer that includes an uncovered cost due for the therapeutic or diagnostic and facilitating the payment process from the customer to the healthcare provider via a secure payment processor; and identifying a shipping pharmacy or one that is local to the customer and accepts the customer's healthcare coverage.

In some other embodiments, the step of providing a link enables the customer to enter healthcare information further includes name, date of birth, Insured's zip code, shipping address, SSN, Medical benefit information, and gender.

In some other embodiments, the step of providing a link enables the customer to enter healthcare information further includes a conversational AI agent configured to request the customer to accept a service and HIPAA agreement before receiving and storing the customer healthcare information.

In some other embodiments, upon determining that the therapeutic or diagnostic is not covered by the healthcare insurance provider, the web-based platform may offer a discount program for a customer without insurance coverage for the healthcare related events and services.

In some other embodiments, upon determining that the therapeutic or diagnostic is not covered by the healthcare insurance provider, the web-based platform may offer a cash only option for the customer without insurance coverage for the healthcare related events and services.

In some other embodiments, upon determining that the therapeutic or diagnostic is not covered by the healthcare insurance provider, the web-based platform may facilitate a claim process between the customer, the identified pharmacy and healthcare insurance provider to enable the customer to access the healthcare related events and services.

In some other embodiments, upon determining that the therapeutic or diagnostic is not covered by the healthcare insurance provider, the web-based platform may offer a cash only option for a customer without the insurance coverage for the healthcare related events and services and facilitate a payment process via a secure payment processor.

### BRIEF DESCRIPTIONS OF DRAWINGS

Each figure connects sequentially as part of a larger logical process. Various exemplary aspects of the systems and methods will be described in detail, with reference to the following figures, wherein:

FIG. 1 is a flowchart showing how visitors access the platform via a plurality of methods.

FIG. 2a+FIG. 2b are flowcharts that are a continuation of FIG. 1 for screening questions the program asks to collect healthcare information and benefits for new users are verified.

FIG. 3 is a flowchart that is a continuation of FIG. 2 and is where insurance, copay and cash payment options are presented to the users for their telehealth visit.

FIG. 4 is a flowchart that is a continuation of FIG. 1 process for users to initiate a refill of their Rx.

FIG. 5 is a flowchart that is a continuation of FIG. 4 and where insurance, copay and cash options are presented to the users for their Rx refill.

FIG. 6 is a flowchart that is a continuation of FIG. 1 process for users to transfer care from one provider to another.

FIG. 7 is a flowchart that is a continuation of FIG. 1 process for transferring script from one pharmacy to another.

FIG. 8 is a flowchart that is a continuation of FIG. 1 process for managing Rx for managing Rx autofill via the platform as well as SMS.

FIG. 9 is a flowchart that is a continuation of FIG. 6 synchronous telehealth appointment process within the transfer care process.

FIG. 10 is a flowchart that is a continuation of FIG. 3 process where payment capture occurs and telehealth appointment options are presented to the user.

FIG. 11 is a flowchart that is a continuation of FIG. 10 process where telehealth consult occurs after capture of payment.

FIG. 12 is a flowchart that is a continuation of FIG. 11 process where pharmacy fulfillment is managed after telehealth visit.

FIG. 13 comprises of two flowcharts, the first showing SMS updates provided to users (e.g., script updates, reminders, feedback requests, etc.) and the second showing the SMS shortcuts available to users to interact with the service and manage their account

FIG. 14 is a flowchart showing how a proprietary algorithm embedded in the platform is used to identify medical professionals around the world to create a knowledge map.

FIG. 15 is a flowchart showing overall steps of the overall healthcare management the platform provides for its users and other stakeholders in the healthcare industry.

FIG. 16 is a schematic showing structural elements including the network, platform, processor, and other devices.

FIG. 17 is a flowchart showing a specific method how visitors access the platform, namely through healthcare provider activations.

### DETAILED DESCRIPTION

These and other features and advantages are described in, or are apparent from, the following detailed description of various exemplary embodiments. Before embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

It will be understood that when an element is referred to as being “on”, “connected”, or “coupled” to another element, it can be directly on, connected, or coupled to the other element or intervening elements that may be present. In contrast, when an element is referred to as being “directly on”, “directly connected”, or “directly coupled” to another element, there are no intervening elements present. As used herein the term “and/or” includes any and all combinations of one or more of the associated listing items. Further, it will be understood that when a layer is referred to as being “under” another layer, it can be directly under, or one or more intervening layers may also be present. In addition, it will also be understood that when a layer is referred to as being “between” two layers, it can be the only layer between the two layers, or one or more intervening layers may also be present.

It will be understood that, although the terms “first”, “second”, etc. may be used herein to describe various elements, components, regions, layers, and/or sections, these elements, components, regions, layers and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of exemplary embodiments.

In the drawing figures, the dimensions of layers and regions may be exaggerated for clarity of illustration. Like reference numerals refer to like elements throughout. The same reference numbers indicate the same components throughout the specification.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For exemplary, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized embodiments (and intermediate structures) of exemplary embodiments. As such, variations from the shapes of the illustrations as a result, for exemplary, of manufacturing techniques and/or tolerances, are to be expected. Thus, exemplary embodiments should not be construed as limited to the particular shapes of regions illustrated herein but are to include deviations in shapes that result, for exemplary, from manufacturing. For exemplary, an implanted region illustrated as a rectangle will, typically, have rounded or curved features and/or a gradient of implant concentration at its edges rather than a binary change from implanted to non-implanted region. Likewise, a buried region formed by the implantation may result in some implantation in the region between the buried region and the surface through which the implantation takes place. Thus, the regions illustrated in the figures are schematic in nature and their shapes are not intended to illustrate the actual shape of a region of a device and are not intended to limit to scope of exemplary embodiments.

Unless otherwise defined, all terms (including technical and scientific terms) used herein have the same meaning as commonly understood by one of ordinary skill in the art to which exemplary embodiments belong. It will be further understood that all terms, such as those defined in commonly used dictionaries, should be interpreted as having a meaning that is consistent with their meaning in the context of the relevant art and will not be interpreted in an idealized or overly formal sense unless expressly so defined herein. As used herein, expressions such as “at least one of”, when preceding a list of elements, modify the entire list of elements and do not modify the individual elements of the list.

When the terms “about” or “substantially” are used in this specification in connection with numerical values, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%. Moreover, when the words “generally” and “substantially” are used in connection with geometric shapes, it is intended that the precision of the geometric shape is not required but that latitude for the shape is within the scope of the disclosure. Although the tubular elements of the embodiments may be cylindrical, other tubular cross-sectional forms are contemplated, such as square, rectangular, oval, triangular, and others.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For exemplary, when a device structure (e.g., a memory cell structure or transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

Reference will now be made in detail to embodiments, exemplary of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain exemplary embodiments of the present description, which is divided into the following sections.

### Overall Operation

The disclosed platform pertains to a healthcare management system which can be used to manage the composite information about a patient, connect them to healthcare practitioners, and monitor prescription receipt and fulfillment. A patient benefits by having possession and control over their healthcare treatment as is manifested by a closed loop healthcare delivery system including automatic electronic verification that the diagnostic and therapeutic is delivered and this is communicated with the patient.

There are many steps involved in connecting end-users to prescribed diagnostic or therapeutic. Medical professionals must assess the individual's condition, write the script, and send this to a pharmacy or other fulfillment service. Then, the prescription must be fulfilled, and the client updated on the status, so they know when to pick it up/expect a delivery. There are many touch points in this chain where clients could be lost due to difficulty in reaching the next step, being unable to verify coverage and connect benefits, etc. Most healthcare delivery services fail to connect broadly different areas of medicine or fail to reach out to consumers in the first place and remain in use by and through the health care providers themselves.

The present platform imagines a beginning-to-end, omnichannel direct to patient solution for the above problem. The process seeks out initial client interest, drives engagement, connects clients to telehealth providers and healthcare providers connecting patients to the platform, integrates real-time pharmacy benefit and medical coverage verification, and communicates with the customer until their healthcare product/service is picked up/delivered. While some customers currently manage this frustrating process on their own, many are unable to (such as the elderly or disabled) or would simply prefer to seek out easier experience solution.

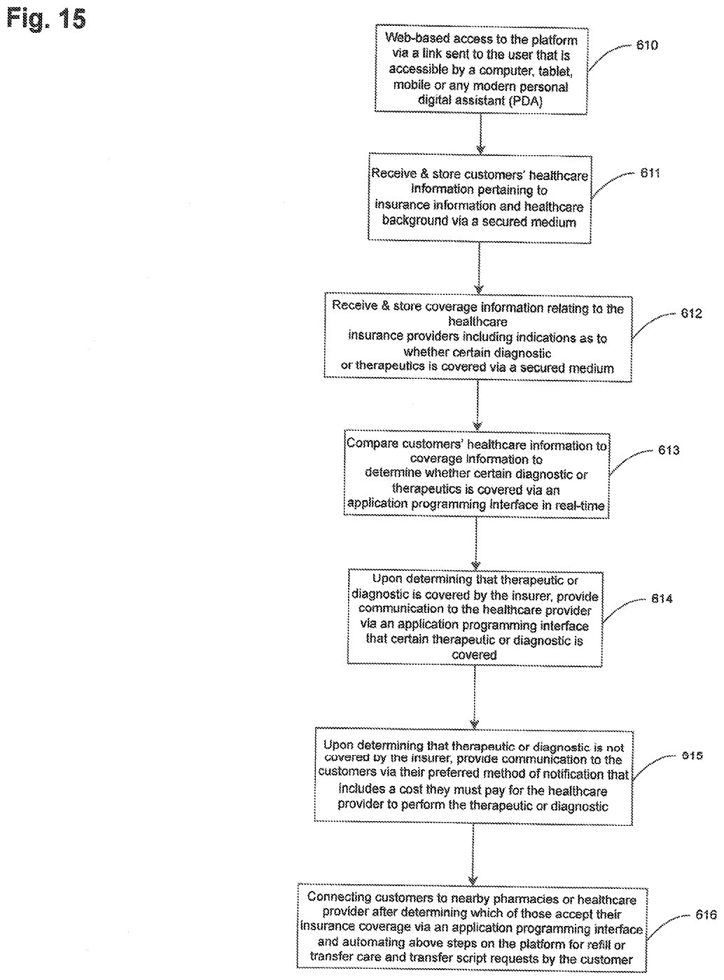

FIG. 15 is a visual representation of the main tasks handled by the omnichannel platform. As shown in point 610, users can access to the platform by a link sent by the collaborators of the platform. A QR code, blockchain phrase, SMS can replace the link and provide alternative access points to the platform. This web-based platform can therefore be accessible by any mobile device, tablet or modern personal digital assistant.

Moving to point 611, platform database receives and stores users' healthcare information pertaining to insurance and their medical background via a secured medium.

Moving to point 612, platform database receives & stores coverage information relating to the healthcare insurance providers including indications as to whether certain diagnostic or therapeutics is covered via a secured medium.

Moving to point 613, platform processor compares customers' healthcare information to coverage information in order to determine whether certain diagnostic or therapeutics is covered via an application programming interface in real-time.

Moving to point 614, upon determining that therapeutic or diagnostic is covered by the insurer, platform processor provides communication to the healthcare provider via an application programming interface that certain therapeutic or diagnostic is covered.

Moving to point 615, upon determining that therapeutic or diagnostic is not covered by the insurer, platform processor provides communication to the user via an application programming interface that includes a cost they must pay for the healthcare provider to perform the certain therapeutic or diagnostic requested.

Moving to point 616, platform ultimately connects customers to nearby pharmacies after determining which of those accept their insurance coverage via an application programming interface and automating above steps on the platform for refill or transfer care and transfer script requests by the user.

### Patient Outreach and Onboarding

In some embodiments, platform may be equipped to onboard patients via a plurality of sources, which may include but not limited to earned media, partnerships, influencers, in-person activations, banner ads, brand websites.

The platform may have a plurality of collaboration with external stakeholders to streamline the outreach process to potential patients and patient education into the platform.

The collaborations may include participating physical pharmacies. Pharmacists may verbally inform patients regarding the platform, the features of the platform, its functionalities and how it works. Alternatively, this can be achieved by QR code advertisements that are placed in the pharmacies that would inform patients on their choice of device with a potential treatment journey plan and how that would look like if they elect to utilize the platform.

The collaborations may also include utilizing an array of web-based video services that would lead potential patients to the platform. Educational health videos by professionals, thought leaders and social media influencers may be utilized, with a link to the platform at the end of the video for patients interested in specific brand of drugs or specific type of drug.

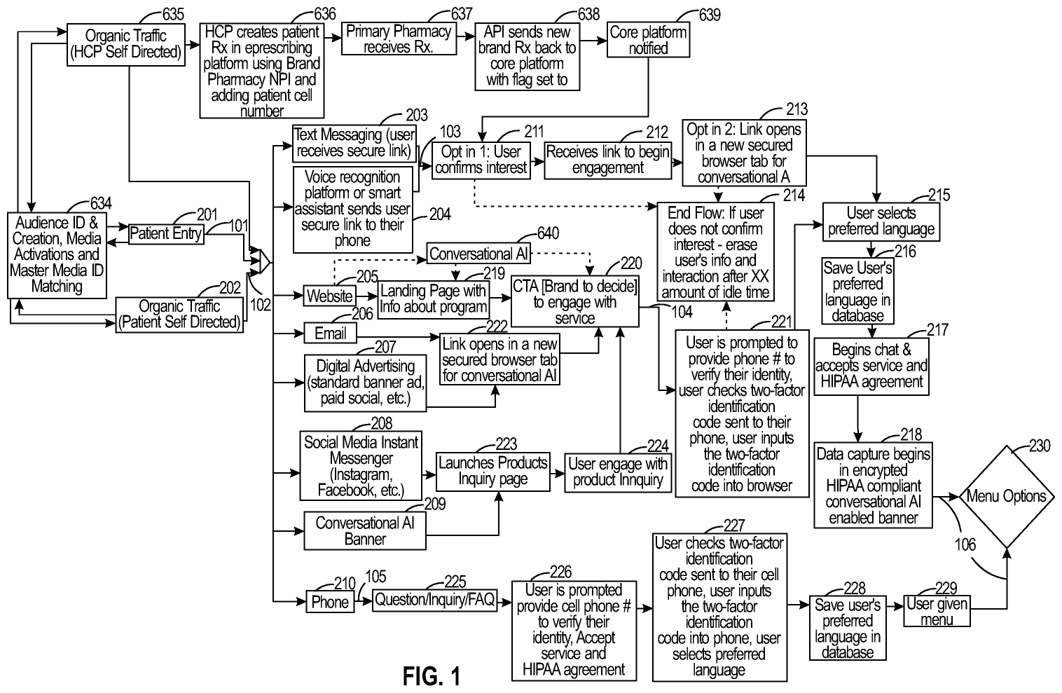

In some embodiments, the platform may identify if a patient is a new user or existing user and offer separate paths in accordance with their status. The platform may also be equipped to recognize the patient by matching its inbound traffic information to past login data from its main database and recognize the patient to streamline a portion of the process. The platform may also be equipped to contain a plurality of databases to perform identity matching in order to streamline the customization process of the menu and options offered to each patient arriving on the platform organically. This is shown in FIG. 1 point 202.

As mentioned above, the platform may be equipped with an extensive patient database that is able to recognize the patient by matching its inbound traffic information to past login data from its main database and recognize the patient to expedite certain steps that are required to advance and reach more features in the platform. This can be seen in module 634, wherein a user arriving on the platform is assigned a unique identifier and recorded in the database regardless of the method of their arrival as a result of a process called Master ID matching.

Advertisements for the program could include QR code or vanity URL advertisements within participating physical pharmacies, educational health videos and/or podcasts with a link to the service at the end, an automated AI calling system to reach out to potential customers and then direct them to humans, a manual email or calling program that may be ‘informed’ by additional database information or ‘scraped’ web information that can provide greater personalization, and/or an email campaign (that may be used independently or in concert with the systems mentioned above) that may be personalized and may also use decision tree logic to allow for a multi-interaction campaign. This campaign may be informed by databases or web-based behaviors or history or other data about prospective users.

One of the collaborations mentioned above may be engineered by Swoop, which is a subsidiary of the company. Swoop powers pharmaceutical brands to better educate patients about disease states and the therapies that could remedy their conditions, as well as enable them to become active participants in their treatment journey. Swoop's HIPAA-certified and NAI-accredited system of activation has uncovered over 1,800 unique target audiences for precisely activating patient populations and their healthcare ecosystems through cross-channel marketing strategies. Patient entries that are engineered by one of the healthcare providers that collaborate with Swoop to streamline patients interested in a specific brand of drugs are shown in point 201 in FIG. 1.

Information from the above marketing campaigns in terms of ‘open rates, engagement’ or other measures can be used to inform the other channels of prospective end-user communications. The system may also be used with machine learning algorithms to both create optimal language and interactions both in aggregate as well as individualized.

The platform could also implement a system for referrals and such system may also enable a ‘loyalty’ or reward programs to encourage growth of the program amongst users. This program may include an individualized ‘code’ or other data to enable awarding rewards as well as aggregating different ‘rewards programs’ to determine and optimize the use of such programs as well as their marketing. There may also be programs that HCPs can participate in the program and enroll patients.

Turning now to FIG. 1, a flowchart showing how visitors access the secured HIPAA compliant engagement is shown. The path marked 101 represents the flow of via media activations engineered by the company via collaborations mentioned above and path marked 102 represents the flow of organic traffic potential patients that are self-directed to the platform. Users may also be organically onboarded to the platform through a variety of methods, listed as digital programming (e.g. online streaming services), voice access such as Amazon's Alexa, digital marketing such as from websites or emails, text messaged links, digital advertising such as banners, and social media instant messengers such as those used by Facebook, Instagram, etc. as be seen in path 102 in FIG. 1.

As mentioned above, the platform may have a plurality of partner programs to onboard users. In one of these methods, the users of the platform can be onboarded through healthcare providers that are participants of the platform's program as seen in point 635. Healthcare providers that are treating the patients can elect to prescribe their patients electronically through the platform as seen in point 636. This can be a soft introduction of the platform for the patient in an organic fashion.

Once the HCP electronically prescribes the patient, the pharmacy that the patient is currently using receives their Rx as seen in point 637. After that, API sends new brand Rx back to core platform as seen in point 638 and core platform is notified accordingly regarding a potential patient arriving to the platform.

If the users access the platform through HCP activations on path 101, the platform may then send a text message to their phone which includes a secure link as shown in point 203. The platform may alternatively send the secure link by use of Alexa or any other smart assistants as shown in point 204.

Once the user shares their contact information, they are considered pass opt in level 1, which confirms their interest in the specific brand of drugs or the platform in general as shown in point 211. The user receives a link to begin engagement, as seen in point 212. Similar to other inbound methods, once the potential patient clicks on the link they would be taken to a secured browser, where they are connected with an AI agent as can be seen in 213. Once the patient is connected, AI will try to hold the engagement enough to either pass the patient to a real human service or HIPAA agreement signed so transfer of information can occur in a secure environment as shown in FIG. 1 path marked 103. If the user does not confirm interest, the platform is programmed to delete that user's information and interaction as shown in point 214.

In some embodiments, the users may organically arrive at the platform through a website that has been created as a collaboration product to receive customers by the platform and the specific brand of drugs as shown in point 205. The users will be shown a landing page that may contain informative and educative content regarding the brand and the platform as seen in point 219.

In some embodiments, the users may also be reached via email campaigns that contains a secure link as shown in point 206. Alternatively, the users may be exposed to digital advertising on the world wide web which may attract their interest to a specific brand of product or service the platform as shown in point 207. If the users have interest in that specific brand of product or service the platform they would click the link in above mentioned email campaigns or paid social promotions which would take them to a secure browser tab equipped with conversational AI as shown in point 222.

In some embodiments, the users may also be reached via social media instant messengers such as Instagram, Facebook, TikTok. These instant messages can come from accounts that are associated with the platform or alternatively HCP influencers can contact users via direct messages that would contain the link as shown in point 208. Alternatively, the users may be exposed to conversational AI banners on the world wide web which may attract their interest to a specific brand of product or service or the platform as shown in point 209. In both instances, once the user clicks on the link they would be taken to a product inquiry page as shown in point 223. Product inquiry page may contain several FAQs and topics for the users to explore and communicate with the AI agent as shown in point 224.

As can be seen in FIG. 1, point 219, 222 and 224 will lead to call-to-action to engage with the service that platform will offer to its users for that specific brand of product or service. This call to action may be designed and decided by the healthcare company and offered in collaboration with the platform as shown in point 220. The user is then prompted to provide their phone number to verify their identity, where they may enter a code into the secure browser that was sent to their phone as shown in point 221. In some embodiments, this verification may be processed via other methods such as confirmation through biological features such as fingerprint, eye scan as well as crypto wallet number and phrase verification and any other verification methods that may be prevalent in the future in modern society as these methods will likely shift with the advancement of technology.

The platform onboarding process may include AI agents that will be equipped with ability to communicate in a plurality of languages. The platform is ultimately designed to simplify the entire healthcare management process for patients therefore the offering of different languages is going to be highly desirable for patients from different backgrounds to create an inclusive solution. As can be seen in FIG. 1 paths marked 103, 104 and 105, potential patients need to select and confirm their preferred language to proceed with registration as shown in point 215. The platform may be equipped to store preferred language information associated with each patient's profile as shown in point 216.

In some embodiments, AI agents may be equipped to communicate in both voice and text-based communications in order to accommodate the elderly and disabled patients.

In some embodiments, platform may be equipped with secure browsers and conversational AI interface in order to capture patient data in encrypted HIPAA compliant format as shown in point 217. The platform may obtain the authorization from the patients to capture their data by plurality of methods which may include a secure link sent to their mobile phone or email address to initiate the data capturing process as shown in paths marked 103, 104 and 105 in FIG. 1.

The platform AI agent may utilize an array of algorithms to train its AI agent using Natural Language Processing, Natural Language Understanding, and Machine Learning to perform a plurality of tasks during the initial engagement with the client. AI agent may structure the conversation to increase engagement with the incoming patient to platform and validate the interest of the patient in the potential of the platform or the benefit of a specific drug or a healthcare provider. AI agent may utilize a link or code sent to a phone number, email, crypto wallet or any other digital address in order to validate the identity of the client. The validation of the client is followed by a communication of either another link or code that would enable the patient to opt-in to certify and understand their rights within the HIPAA policies and data privacy before they are granted an access to the main menu of the platform as shown in point 218.

The platform may also be equipped with engagement functionalities that would serve patients with certain disabilities that would otherwise limit them to fully engage with the platform. AI agent may utilize voice communications over text messaging for visually impaired patients and text messaging for hearing impaired patients. It is particularly important for this omnichannel platform to be as accommodating as possible and patients with disabilities constitute a large part of the target market, which means certain features would be customized to accommodate every segment possible.

The omnichannel platform intends to achieve a multi-level integration with a plurality of stakeholders to achieve the seamless patient experience that it intends to offer. This particular goal requires a real-time flow of information from one stakeholder to another without any friction. Typically, flow of information in this described fashion is not an easy feat. In order to ensure the flow of information is occurring seamlessly on patient's side, acquiring the necessary authorization from patients to comply with HIPAA is a cornerstone step for this platform. The platform will need an array of information from the patients to diagnose, treat, provide necessary healthcare operations, bill for treatment and other related activities as can be seen in path marked 106 in FIG. 1.

The platform may acquire necessary information from its patients in order to perform common payment activities which include but are not limited to: determining eligibility or coverage under a plan and adjudicating claims, risk adjustments, billing and collection activities, reviewing health care services for medical necessity, coverage justification of charges, utilization review activities, disclosures to consumer reporting agencies.

The platform may acquire necessary information from its patients in order to perform common healthcare operations which include, but are not limited to: conducting quality assessment and improvement activities, population-based activities relating to improving health or reducing healthcare costs, case management and coordination, reviewing the competence or qualifications of HCP and evaluating provider, health plan performance, underwriting or other activities relating to the creation, renewal, or replacement of a contract as well as transfer cases from one provider to another, manage healthcare product/service and related payments.

Patients may also be reached via phone as can be seen in FIG. 1 point 201 and path marked 105. The method of access is preferably a telephone voice line, in which case the caller calls the client, who accesses the system via a client computer, or a central operator, who accesses the system via the network of computers. The caller may optionally use other means of access such as e-mail, the Internet, or a direct computer connection to directly access the system. When the method of access is a telephone line, the system may use multiple telephone lines in order to provide the system or the client with preliminary identification information about the caller and/or the caller's request. For example, members affiliated with one client may be directed to use one primary telephone number to access the system, while members affiliated with another client may be provided a different access number. The communication method may establish the communication directly between the caller and a central system operator, or it may establish communication between the caller and the client. Members may also be provided with separate telephone numbers for separate types of service. For example, callers may dial one number to obtain pharmaceutical information, a different number for health or disease management counseling, and a third number for customer service information. An automated call distributor routes the call to the client, the central system operator, or to a specific client operator based on the telephone number the caller uses to access the system. The registration with the platform and HIPAA compliant data intake begins only after the potential patient confirms interest and agrees to terms of service. FIG. 1 path marked 106 shows the array of menu options that the patient can access on the platform once they are registered and have accepted the terms of service.

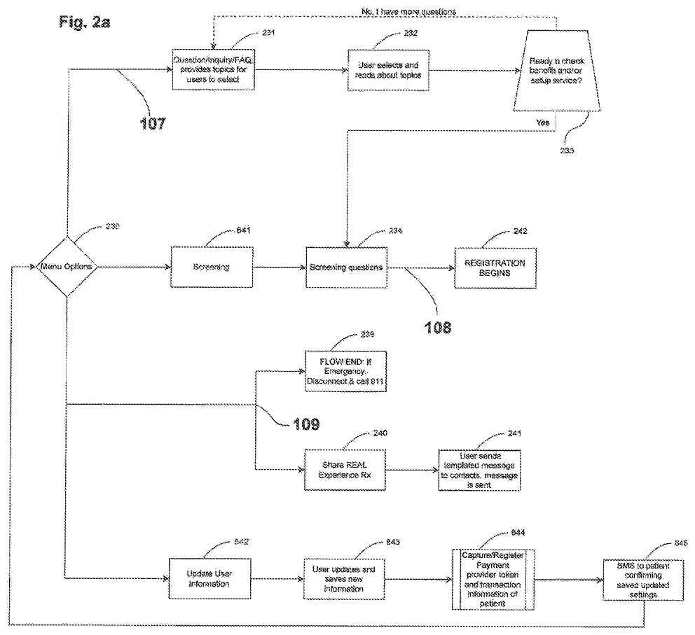

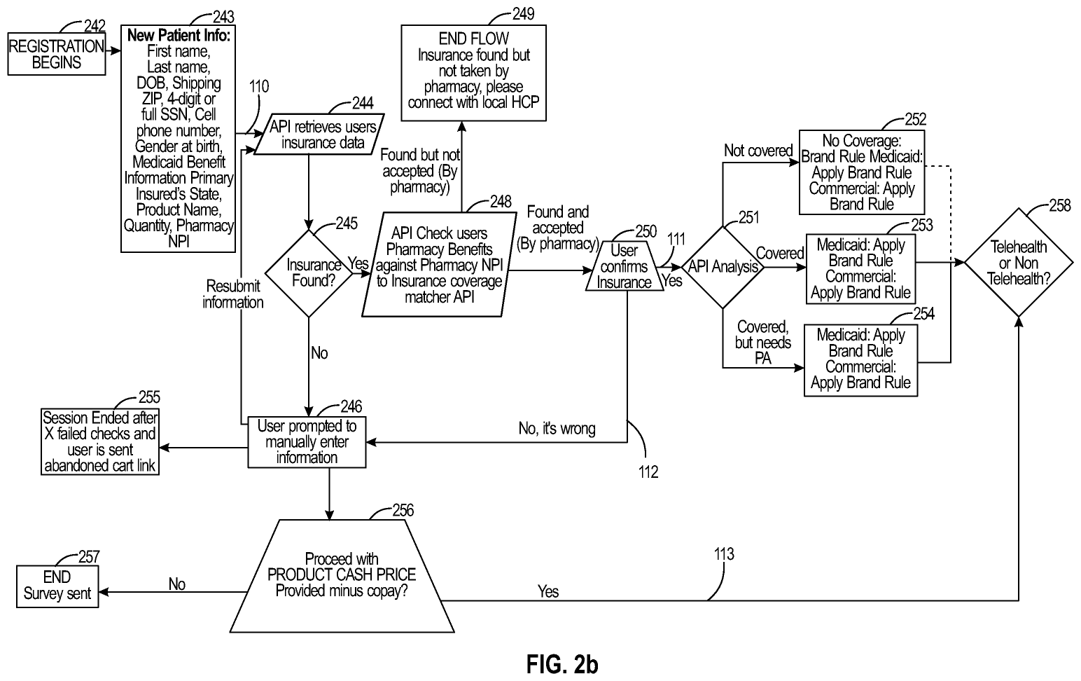

The system, and preferably the automated call distributor portion of the system, then prompts the caller to select a service. Preferably, the service selection prompt is a prerecorded message that directs the caller to select a service from a menu of options. For example, the system may prompt the caller to select one number for clinical assistance, another number for prescription refills, a third number for account or billing information, a fourth number for referrals, etc. The prompt may also be layered, for example with one or more additional levels of prerecorded messages when the caller enters a response to a prompt. Optionally, in lieu of or in addition to the prerecorded message, the system may connect the caller with a human operator who accesses the system and enters the service selection into the system on behalf of the caller. In such a case, the system provides the operator with prompts to guide the caller's selections. As can be seen in FIG. 2 path marked 109, an optional “emergency” prompt may also be provided to allow the caller to bypass the automated call distributor and directly speak to a nurse or obtain standard emergency instructions (such as a button and/or instructions to call a local emergency service such as the “911” service).

In response to the caller's selection, the system can process the caller's service selection by connecting the caller to a nurse, a pharmacist, a customer service representative, or other operator depending on the caller's selection. Optionally, the prompt function may allow the caller to access a touch-tone menu which invites the caller to listen to prerecorded audiotext messages on a variety of health care and/or billing-related topics. The caller may request to speak with an operator for assistance with this touch-tone menu of prerecorded messages. If the caller accesses the system by computer, Internet, or another non-voice method, the prerecorded messages may be in the form of electronic document files which the caller can access and display at the caller's terminal. After a message is complete, or if the caller chooses to end a message before it is complete, the system returns the caller to the menu of prerecorded messages, or, optionally, to the service selection prompt.

Preferably after the operator connection or optionally before the service selection prompt or service selection processing the system validates that the caller is eligible to use the system. The eligibility validation function first prompts the caller to provide identification information. The caller may provide such information by speaking it to the operator (which may be a nurse, pharmacist, customer service representative, or other person) who subsequently enters the information into the system via a client or central computer by entering identification information such as an access code or account number on the telephone keypad; or, if the caller accesses the system via computer, by entering such identification information on a computer keyboard. If the identification information is an access code, the access code may consist of the caller's name, social security number, account number, member identification or other unique form of identification. The system may optionally include a voice recognition system which allows the caller to speak the access code into the telephone in lieu of entering the code via the keypad.

The system verifies the caller's eligibility by comparing the caller's identification information with information stored in a database of member profiles of eligible callers. Optionally, the service may first search the database using one access code, such as a member identification number, and then subsequently by the caller's name if the access code is not found in the database. If the system verifies that the caller is eligible to access the system, the system provides the client/operator with additional information from the member profile database about the caller, such as the caller's name and dependent name(s), address, city, state, zip code, telephone number, health benefit plan information, prescription drug history, self-reported health information, and recent contact history. The self-reported health information is information provided by the caller, either during the call or on a prior occasion, and may include data such as allergies, existing health conditions, and demographics. The recent contact history includes information entered by the client during previous calls by the same caller. The system provides the user with this member profile information very quickly, preferably in not more than a few seconds, more preferably in less than two seconds on average. The system displays the information on the client computer or central computer, depending on the location of the operator.

If the system determines that the caller is not eligible to use the system, the caller may be automatically or manually transferred to an operator (which, as noted above, may be a nurse, pharmacist, customer service representative, or other person) who can further assist the caller and/or help the caller establish eligibility. For example, when an operator uses the system to assist a caller, the operator may use a call transfer screen, which may appear after the operator selects the transfer prompt. If the caller has an emergency, the operator may optionally access the system using the emergency prompt and provide the caller with assistance as if the caller were an eligible caller, although in such circumstance the operator will not have the benefit of the caller's self-reported health information or recent contact history.

After the system validates the caller's eligibility, the caller explains the reason for the call and the operator (who, at this point, is typically a nurse, but who may also be a pharmacist, customer service representative, or other person, depending on the nature for the call) uses the network of computers or client computer to access information stored on the system to provide analysis and advice, or to transfer the caller to an appropriate operator, in response to the caller's inquiry. The system provides the operator with member profile information such as the caller's health benefit plan information, prescription drug history, self-reported health information, and recent contact history. A member's profile may include areas that lists the member's allergies, prescriptions, and preexisting health condition.

The system also provides the operator the ability to access databases that store clinical information such as clinical guidelines, rules, algorithms, operating protocols, and/or procedures to help the operator identify recommended forms of treatment, medications, or courses of action, and to thus counsel the caller accordingly; pharmaceutical information such as prescription drug side effects and complications that may be associated with particular drugs or combinations of drugs; and health benefit information such as insurance company rules, member information, and benefit plan resources. The clinical guidelines may cover a multitude of medical symptoms, conditions, procedures and topics, and they may include general information about effective and appropriate prescription and over-the-counter medications. Optionally, the system may restrict the operator's ability to access certain databases or portions thereof based on the operator's level of authorization.

The system may also allow the operator to order written materials or orders for future delivery to the caller, the caller's health care provider, or a pharmacist. For example, if the operator is a pharmacist, the operator may order a script which may be delivered to the caller, or to the caller's doctor, nurse, or pharmacy as described below. When generating a script, the operator may request, or the system may automatically provide, information relating to the drug prescribed from the pharmaceutical information database. A different operator may be able to generate or request clinical brochures or benefit manuals for delivery to the caller.

If, while analyzing the caller's request and providing advice, the operator determines that the caller must visit a doctor, the operator may request that the system generate a referral in accordance with health benefit plan rules and guidelines. The operator may, for example, access a database of participating providers and the rules associated with referring members to specific physicians based on the symptom or condition described.

During the course of and after the call, the operator may update the member profile (e.g., the caller's contact record) or create a new profile by entering information about the caller's inquiry and advice given, including information such as the caller's inquiry; any prescriptions ordered, refilled, or renewed; treatments suggested; and referrals provided. If the caller selected an audiotext topic, the system may automatically update the caller's record to identify the topics which the caller selected and the steps which the caller took to select the particular audiotext. A call summary similar to a patient's handwritten chart may be generated using data that is automatically compiled based on the results of the call.

At the end of the call, the system may notify the caller's health care provider (such as a doctor or pharmacist) of the call. This provider notification may include a package of information such as the caller's inquiry; any prescriptions ordered, refilled, or renewed; treatments or action items suggested; and referrals provided. The system may deliver this information automatically via facsimile, e-mail, or other delivery mechanism. Alternatively, the system may generate a call information report which the client may deliver to the provider via direct mail, telephone, or other manual delivery mechanism. The provider can then use this information when performing health care services on the caller's behalf. The provider may additionally or alternatively include the information in the provider's records for future reference.

The system may also automatically generate or allow the operator to generate a report of follow-up actions that identifies tasks which the system, operator, provider, or other person or item must perform after completion of the call. The follow-up actions may include tasks such as a reminder to call the member back after a certain period, a reminder to send the member certain information, or a reminder to perform research relating to the caller's request.

The system also prepares utilization reports that are tailored to the specific needs of the client. For example, the system may monitor the time of each call or the number of times an individual caller contacts the system. The system may also monitor system usage volumes over time segments including quarter hour, half hour, hourly day part, daily, weekly, monthly, and year-to-date. Another feature of the reporting function is that the system provides the ability to target members for follow up actions based on the information contained in the member profile database. If, for example, the client develops an informational pamphlet about a new drug or treatment that can benefit members who have experienced certain symptoms, the system can sort through the member profile database to identify members who have called with inquiries about such symptoms on recent calls. The system can also be used to identify members who could benefit from further use of the system, thus targeting such members for follow up with written or personally provided (e.g., telephonic) information. The system can also automatically generate reminders (e.g., prescription refill reminders and prescription renewal reminders) for an entire enrolled population or portion thereof so that the client can provide such reminders to the individual member via telephone, mail, or other delivery mechanism.

Additionally, the system includes a quality control function to ensure that client-specified standards of performance are being met. The function may include features such as routine auditing of procedures and processes, random monitoring of a select number of calls, and a comparison of call reports with an overall set of performance standards.

The operator can also direct the system to route the caller to an audiotext application which contains pre-recorded messages on frequently used health care topics. The caller will be able to select a topic by a touch tone prompted menu, or the operator may select the topic for the caller. The caller can then be transferred to the audiotext message service or message menu for access to the audiotext message. The caller will have the opportunity to opt out of the audiotext facility and return to a live operator for further assistance or to terminate the phone call.

During the course of the call and/or at the end of the call, the operator may update the member profile based on the inquiry made, and advice given during the call. If the caller used the audiotext message service, the system will automatically update the caller's member profile to indicate such usage. The operator may also ask the caller to provide an update of the caller's self-reported health information, such as data on allergies, existing health conditions, demographics that contribute to risk stratification, and other data applicable to helping the member with health care information needs. This information is stored in the member profile database during or at the end of the call.

During and/or at the end of the call, the system will also use the caller's member profile, along with clinical information, pharmaceutical information, and health benefit information to generate alerts and messages for the operator to provide to the caller. These alerts and messages may relate to items such as appropriate prescription drug use, medications the caller should avoid or use in moderation or speak to a physician before using, suggested forms of treatment based on the caller's symptoms, prescription refill reminders, prescription renewal reminders, and other information. At the end of the call, the system may generate several types of reports and notices. For example, the system may have the capability to package information collected during the call, combined with specific pharmacy information, for delivery to the caller's physician, health plan, or other health care provider via facsimile, e-mail, direct mail, or other delivery mechanism. This information may include a summary of the items discussed during the call and the steps the caller has agreed with the operator to carry out. Such information may be used to assist the provider when performing health care services on the caller's behalf, or it may simply be used as reference information or become part of the caller's health information folder maintained by the provider. At the other end of the spectrum, the system may generate reports based on system usage to provide information such as number of calls per period of time, average length of call, referrals generated per call, and other information.

As mentioned above, users who are reached via a plurality of methods may be greeted by a plurality of options with the main option being a conversational AI agent. Once the users have confirmed the service and HIPAA agreement and select their preferred language, they are considered to have completed the initial onboarding process and may be directed to main menu as shown in FIG. 1 point 230, where they will proceed to screening questions conducted by AI agent.

### Screening Questions

FIG. 2a is a flowchart that is a continuation of FIG. 1. and the path marked 106. As shown in point 230 users are directed to the main menu once they complete their initial registration. In this step, the AI agent asks whether the visitor is a new or existing user. Alternatively, the platform may be equipped to recognize the user from previous logins or a plurality of methods and direct the main menu options shown the user accordingly.

At this point, the AI agent may also ask the user if they are experiencing symptoms that may indicate an emergency, such as suicidal thoughts or symptoms of a heart attack, and encourage them to contact the appropriate authorities. It may provide a button with which to dial 911 through the user's phone as can be seen in path marked 109. In that case, they are directed to point 239 in which they will be connected to emergency line and their flow on the platform ends. In some embodiments, the program may also offer the user an option to share the program with their network as shown in point 240. In that instance, user sends a templated message prepared by the platform that is customizable to contact name and brand of drugs will be sent out as shown in point 241.

In the case of a new user, there are two potential paths. First, the path marked 107 in FIG. 2 asks the user product inquiry content, then provides topics for users to select as shown in point 231. The user can then select and read about those topics as seen in point 232, and the program asks them if they are ready to get started with benefit verification and set up service as shown in point 233. If they aren't, it sends them back to the list of topics to select to point 231. If they are ready, it sends them forward to the path marked 108 in FIG. 2 and asks screening questions as shown in point 234.

The AI agent may also ask questions to match users to other partner treatments or medications, or about their medical condition to help connect them with the appropriate telehealth specialist (psychiatric, cardiologist). The AI agent may also check patient's previous record for past prescriptions and HCPs in order to assess the best possible scenario for the patient as seen in FIG. 1.

The AI agent can also ask questions to match users to other partner treatments or medications, or about their medical condition to help connect them with the appropriate telehealth specialist (psychiatrist, cardiologist, etc.). Given that certain telehealth providers (e.g. Betterment psychologists/counselors) may be necessary or helpful to the patient, but not able to write prescriptions, though it is not the focus of this platform, it may be possible for the program to refer the patient to such a service (for a fee to the service, which could be in a form of partnership or agreement) in addition to sending them to a prescription-writing medical professional. It also may be possible for the company to provide some of these services themselves through a feature such as a network of contracted doctors.

The AI agent may also ask questions and collect HIPAA compliant medical information from the patient, such as general health history and records of recent treatments by physicians, nurses, dentists, and other practitioners, and there may be an option for the customer to request their history from their doctor or for the program to transition the patient to purely telehealth services if they request.

Once the patient is transferred to the main menu the platform may engage with the patient with a series of questions in order to customize its platform features and services in a more suitable fashion for the patient as shown in point 234. Patients answers to screening questions will determine how the rest of the experience on the platform will be modified and a real-time insurance benefits check will be performed as shown on the path marked 108.

The platform may also contain a virtual environment for patients of same illnesses to connect to each other after they complete the registration and reach the main menu as shown in point 230. It has been proven numerous times that humans find comfort in communicating with other people that share and feel similar agony. Particularly in the field of healthcare, there may be a distrust between professionals and patients of communities that have been historically underprivileged. The platform intends to create an omnichannel platform that facilitates a patient's healthcare needs from beginning to the end while empowering them with ability to manage their process. In the platform, patients can elect to meet their HCP through a variety of choices, patients can obtain easier access to healthcare products/services in contrast to traditional methods before the invention of this platform, as well as comparing their benefits of insurance and copay options. Therefore, it is only fitting that a virtual environment is created for patients to engage in anonymity through creation of digital avatars of their own choice and interacting on the platform through a variety of methods which may be: text based messaging, video based communication, as well as chat rooms that may be synchronous or asynchronous depending on the situation. Additionally, the platform main menu may contain answers to common general inquiries, FAQ on most common complaints by patients, educational videos that may contain quick solutions for common problems, therapeutic and meditational videos that address general well-being of patients.

An example to the above-mentioned feature can be the experience of a new patient that is suffering from migraine. Once they arrive on the platform and complete registration as shown in point 230, they will be able to access top questions that are asked by other patients that are in the platform and suffer from same or similar complaints. The questions on this platform will be moderated and answered by platform moderators in order to provide additional value to patients. They will also be able to watch educational videos that are prepared by either internally or by a set of external stakeholders that are proficient in their area of specialty. Educational videos would serve the purpose of increasing familiarity with the platform while adding value to patients in a rapid fashion. If the patients want to communicate with other patients, they would have the option to do so with people suffering with same or similar complaints and the platform may offer them an advanced virtual environment to interact, communicate and build a sense of community.

In the initial questioning, if the user answers that they are an existing customer, they may also be sent to paths 129 (refill Rx), 136 (transfer care) or path 147 (transfer script). The AI agent asks the existing customer whether they need a refill, and if they say yes, if they have any refills on file. If they say no to this question, they will be notified if a new prescription is needed, and if commercial declined coverage they are notified of action removing refills and the need for a new prescription. If the client says yes when asked if they need refills, the program then confirms that their shipping address is the same. If it is, the program looks up benefit and checks if it is the same. If their address has changed, the program looks up a new pharmacy NPI. If benefits are the same benefits and original pharmacy, they have the same benefits but new address, or don't have the same benefits, the process continues as in path marked 110. A medical benefit verification service such as Myndshft could be used to verify medical benefits. Additionally, patients may be asked who their primary care provider is so that they can be informed when the patient is on a new diagnostic or therapeutic or refills an existing one, and this information could be conveyed to the doctor after the healthcare product ships. To prevent the patient's doctor from interfering in the prescription fulfilment, the patient would be given the option to have their doctor notified upon fulfillment/shipment.

As can be seen in path marked 108 in FIG. 2, the AI agent may also ask questions such as date of last menstruation, as many women are not aware they are pregnant early on. It may also ask questions that may preclude the use of the diagnostic and/or therapeutic, such as asking a user if they have had a procedure resulting in infertility (e.g. hysterectomy, bilateral ovarian removal) before asking more questions relating to birth control. It could also optionally ask about other symptoms related to infectious diseases (such as an STD) and refer the user to appropriate resources including their doctor.

Some embodiments may provide a feature that suggests or requires parental consent if the patient is underage. This could happen in a variety of places in the program, either at the outset as a gateway asking age and other information or after data collection. The AI agent could also provide disclaimer information as well as data from the FDA product sheet and/or consumer medicine information (CMI) leaflet or other information about the product which may include contra-indications, interactions, dosage, and other relevant information.

The AI agent can also inquire about the patient's interest in additional products, such as smoking cessation aids and weight loss products and programs.

The AI agent may also ask questions and collect HIPAA compliant medical information from the patient, such as general health history and records of recent treatments by physicians, nurses, dentists, and other practitioners, and there may be an option for the customer to request their history from their doctor or for the program to transition the patient to purely telehealth services if they request.

Once the patient is transferred to the main menu the platform may engage with the patient with a series of questions in order to customize its platform features and services in a more suitable fashion for the patient. Patients answers to screening questions will determine how the rest of the experience on the platform will be modified and a real-time insurance benefits check will be performed upon their arrival to registration screen as shown in point 242.

In some embodiments, the patient may also be offered an option to alter their payment and billing information upon arriving on the main menu. If the patient arrives on the platform to change their payment information on file they can do so as seen in point 642. The platform updates and saves their new information as seen in point 643. After that, system registers payment provider token and transaction information of the patient in 644 and confirms the alteration by sending an SMS in point 645.

In some embodiments, the patient intake AI agent or phone software may be designed as a web-based program that each spoke pharmacy location may log into from their own spoke Rx server. Collected patient intake data may be used to create a patient profile in which all of a patient's prescriptions may be linked to one file. Prescription data collected by patient intake AI agent or phone software may be forwarded to the synchronization engine to be synchronized. The term “synchronization” may be used to define a process in which the hub Rx server (e.g., a hub pharmacy technician) contacts the patient's insurance plan to request the insurance plan authorize all existing prescriptions in the patient's file based on an objectively determined adherence assessment and approve a synchronized prescription set for subsequent adjudication by a spoke pharmacy. In the alternative, it is to be understood that the hub and/or spoke pharmacy may obtain all new scripts of the patient's medications no adjudication is needed.

In some embodiments, as part of the patient intake AI agent or phone software, an adherence assessment module may be implemented to classify a patient's present adherence level pertaining to their ability to take all of their prescribed medications on the recommended administration schedule and/or to identify a patient's adherence risk. The adherence assessment module may determine a score based on a number of factors used to determine the patient's need for an adherence-based packaging solution. The adherence score may be used as the basis to request an insurance plan to clear all previous prescriptions in a patient's file and allow for a synchronization of new prescriptions pursuant to the MMAA program. A patient's adherence need may be determined from the answers to the questions using a variety of determined acceptable adherence standards. The adherence standards may change based on the risk comfort level or needs of the patient, provider, pharmacy benefit manager and/or insurance plan. Answers to certain questions may automatically indicate the patient is a good candidate without any scoring tool being used. In addition, the patient's lifestyle or activities of daily living may qualify them as an adherence program candidate.

In some embodiments, the synchronization engine may provide a scheduled time period for a spoke pharmacy technician to adjudicate the patient's prescriptions. Adjudication may be necessary to ensure coordination with the synchronization step in which the insurance plan has approved and replaced the patient's existing prescriptions with “synchronized” new prescriptions. The insurance provider of health plan may need to approve of the date for the script to be filled. A set production schedule may coordinate these time periods between the hub pharmacy contacting the insurance plan and a spoke pharmacy adjudicating the prescriptions. It is to be understood, based on system preferences, that the spoke pharmacy may contact the insurance plan and that no adjudication may be necessary or that the hub pharmacy may perform adjudication for the spoke pharmacy.

The synchronization engine may also calculate a synchronization date based on a hub pharmacy production schedule. Following the adjudication process, the spoke pharmacy may send the patient's prescriptions to the hub pharmacy in an electronic format consistent with that used for typical central fill facilities. These prescriptions may be flagged to designate fulfillment to be completed at the hub, mail order, spoke or central fill pharmacy.

### Benefits and Coverage Verification

FIG. 2b is a flowchart that is a continuation of the path marked 108 and is where registration begins with benefits verification for a new customer. The path marked 110 is where benefits verification continues where path 108 left off. Registration begins as shown in point 242, and the program collects patient info such as first and last name, date of birth, zip-code, 4-digit or full social security number, Medicaid benefit information, gender, drug name, quantity, and pharmacy as shown in point 243. API then looks up the client's insurance as shown in point 244. If they are unable to locate the user, the user is prompted to manually enter information twice. This can be seen in point 244. Once information is manually entered, API checks and shows pharmacy benefits against pharmacy NPI to insurance matcher API as shown in point 248. If the API is still unable to locate the user, the user is prompted to path marked 112 and manually enter their information as shown in point 246. As a result, users can be offered to proceed with cash minus copay option as shown in point 256. Alternatively, they may quit after their insurance information is not found or when they see the cash option for the drug they would like to obtain as shown in point 255. In this instance, they are reached after a certain time with a survey focusing on the price of the drug to collect their feedback as shown in point 257.

Once pharmacy benefits are shown and confirmed in point 250, users are directed to path marked 111, API analysis commences in point 251. If the prescription is not covered, brand rule is applied for Medicaid and commercial benefit in point 253. If the prescription is covered, brand rule is applied for Medicaid and commercial benefit in point 253. If the prescription is covered but needs PA, brand rule is applied for Medicaid and commercial benefit in point 254.

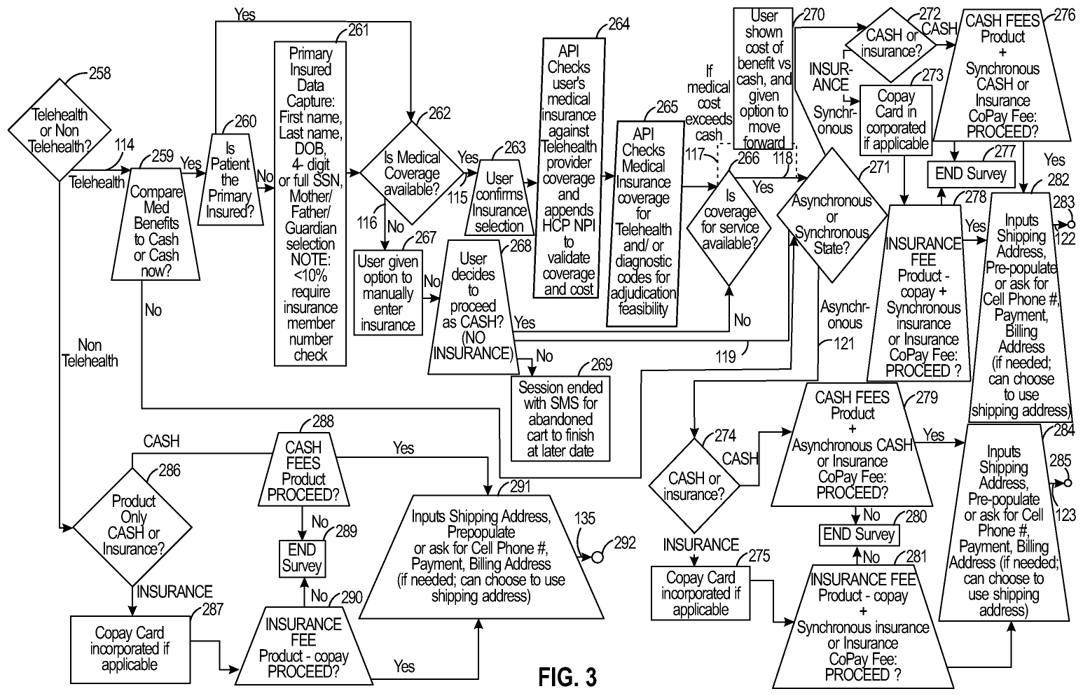

Continuing from FIG. 3 path 111, if the patient would like to proceed with telehealth option as shown in 258, the platform may be equipped to compare medical benefits to cash or cash now as can be seen in path marked 114, point 259. The platform is intended to be an omnichannel healthcare management platform that caters to users from all backgrounds. With that being said and considering how many Americans are insured through their family members and dependents, it is important for the platform to have flexibility to obtain insurance information from a user or a profile and apply the benefits to another user or profile as it intends to. In this situation, the platform then asks if patient is the primary insured on file as shown in point 260. If not, API collects user information such as first and last name, date of birth, and HCP NPI number and sometimes insurance member number along with guardian information if they are the primary insured in point 261. It then checks the user's available insurance in point 262, then checks their medical benefits against telehealth provider coverage and appends HCP NPI to validate coverage in point 264 as shown in path marked 115. If there is no medical coverage available for telehealth service, the user is directed to path 116 in FIG. 3. If the patient can not provide insurance information that covers the medical benefits required by telehealth HCP in point 267, they are shown a cash with no insurance option in point 268. If the user does not elect to proceed with cash option in point 269, their session is considered as drop off at checkout and the platform may be equipped to follow up with the patient with SMS for an abandoned cart to finish at a later date. If the patient elects to proceed with cash option, they are directed to path 119 in FIG. 3.

If the user's insurance has medical coverage in point 262, they are directed to path 115 in FIG. 3. Once the user confirms insurance information in point 263, the API checks their medical benefits against telehealth provider coverage and appends HCP NPI to validate coverage in point 264. API then checks medical insurance coverage for telehealth and diagnostic codes for adjudication feasibility in point 265. If coverage for telehealth service is available in point 266, the user is directed to path marked 118. If coverage for service is not available the user is directed back to path marked 116 to see cash now, no insurance option. If medical cost exceeds cash in point 266, the user is directed back to path marked 117. In this path, user is then shown cost of benefit vs cash in point 270 and given both options to proceed as they deem fit.

Paths marked 118 and 119 leads to point 271 where the process will differ depending on the state the user is located and the laws associated with telehealth in that state. If the state allows telehealth to occur synchronously, the user is directed to path marked 120 and if it has to occur asynchronously, the user is directed to path marked 121.

For users who live in synchronous telehealth states, they will first be asked to pay for telehealth with either cash or insurance in point 272.

If they elect to pay by cash after being directed to path marked 120, they are shown cash fees for products in addition to synchronous cash or insurance co pay fee as shown in point 261. If they accept, they will be directed to point 276 to input billing information, shipping information and payment information. If they do not accept, they will be considered as abandoned the cart and will be sent a survey to collect feedback from the client as shown in point 277.

If the user elects to pay by insurance after being directed to path marked 120, they are shown product minus copay price in addition to synchronous insurance or insurance copay fee in point 273. If they accept, they will be directed to point 278 to input billing information, shipping information and payment information. If they do not accept, they will be considered as abandoned the cart and will be sent a survey to collect feedback from the client as shown in point 277 which will later be used as part of the comprehensive data analysis the platform performs on customers and their preferences.

If the user elected non-telehealth option after point 258, they are directed to path 134, where they are asked if they want to pay for the drug they would like to access by cash or insurance in point 286.

If they elect to pay by cash after being directed to path marked 134 and point 286, they are shown cash fees for products at point 288. If they accept, they are directed to point 291, where the platform proceeds to ask billing information, shipping information and payment information. If they do not accept, they will be considered as abandoned the cart and will be sent a survey to collect feedback from the client as shown in point 289.

If they elect to pay by insurance after being directed to path marked 134 and point 258, the platform incorporates copay card if applicable as shown in point 287. Platform then shows the user insurance fees associated with the drug in point 290. If they accept, they are directed to point 291, where the platform proceeds to ask billing, shipping and payment information. If they do not accept, they will be considered as abandoned the cart and will be sent a survey to collect feedback from the client as shown in point 289 which will later feed into their profile and their preferences can be analyzed together with the rest of the information that has been collected during their sign up, screening questions which includes prominent details regarding their health, prescription and healthcare history.

An important novel feature of the inventive prescription management system is the ability to associate a specific patient condition with each drug prescribed. By capturing detailed information on every prescription, the system automatically builds a novel patient medical record having new uses in evaluating individual patient treatment and in enabling powerful new, multi-center outcome studies for evaluating therapies in various populations of patients.

By deploying the inventive system regionally, nationally or in some other population area, and employing the preferred methods for retrieving patient data from remote sources, as described herein, a complete patient record of all activity within a region can be built. Preferably this is a virtual patient record dynamically assembled only from original source data, which, as described above, is maintained in component form at multiple distributed source databases, is retrieved therefrom across a data-retrieval network from which the source databases can be accessed and is compiled or assembled into a single virtual or transient record that appears to the user as an integral system data resource.

Patient histories generated by the inventive system can show not only the drugs prescribed, but also the conditions for which they were prescribed, allergies, demographics, insurance coverage, treating health care providers, and so on. Known medical management systems do not provide listings associating each prescribed drug with a patient condition or problem, as reported to, or diagnosed by their physician.

Careful review of a patient's record for relationships between amelioration of problems and prescription of particular drugs can provide important information about the efficacy of a drug for a particular problem in a given patient. Review of a physician's prescribing record, detailing the various drugs selected to treat the different conditions exhibited by the patients encountered in the physician's daily practice, can reveal valuable information about the physician's prescribing practices and the degree to which they follow formulary guidelines.

This information is clearly of value to the individual physician and can, if desired, be enhanced by including in the problem record a condition severity rating, enabling declines (or increases) in severity to be reported. The resultant patient prescription history, replete with dated information as to patient problems, what drugs were prescribed to treat those problems, what forms, routes of administration and dosages were used and, by implication from the timing and nature of subsequent problems, what the outcome of that prescription was, provides a very attractive treatment evaluation tool to a physician, and a powerful inducement to any professionally conscientious physician to use the prescription management system of the invention.

Implementing the platform on a wider scale, valuable new outcome studies and clinical trials are easily, or even automatically, performed. One of many problems in successfully implementing the herein described prescription management system on a large scale is one of funding the system. Medical cost structures, with their reimbursement systems leave little scope for expenditure on aids to overall practice improvements which may have to be squeezed out of tight overhead budgets. Accordingly, significant cost to the physician user, or user's medical facility will be a major deterrent to system adoption. Preferably the system is provided to prescribing users on a low-cost or no-cost basis with funding from outside sources.

Implementation of the platform is expected dramatically to reduce the overall cost of prescriptions and this saving has been estimated to be from 20 to 40 percent of total prescription costs. Savings will accrue initially to the drug benefit management companies who reimburse the direct costs of most prescriptions but can be expected eventually to be passed to corporations and consumers by way of lower drug benefit rates. Such savings realized on a national scale would amount to many billions of dollars and provide an avenue of reimbursement for system proprietors.

Outcome studies produced by the system may have substantial value to various parties, and their sale can support system costs, as may formulate compliance savings. For example, drug efficacy data is of value to pharmaceutical companies, as is early warning data from reliable specialists regarding adverse reactions. Subject to confidentiality and other relevant controls, such data can be automatically compiled and readily supplied by system management, requiring only approval, not active participation by involved physician prescribers. Equally, the system may facilitate clinical trials by identifying health care providers or prescribers who would be likely participants in trials, based upon their having frequently diagnosed relevant conditions, or specified relevant drugs, as shown by their historical prescribing profiles, or relevant patient histories. Suitable patient pools can be identified similarly.

Organizations participating in outcome studies, for example health maintenance organizations, insurance companies, hospitals, physician alliances and the like, and may pool their data but may not wish to reveal certain proprietary data. By employing data access control methods for accessing such organizational data, such as the methods described in detail herein for controlling access to patient's rights, the system of this invention can enable organizations to control what data they release.

### Non-Telehealth HCP Flow

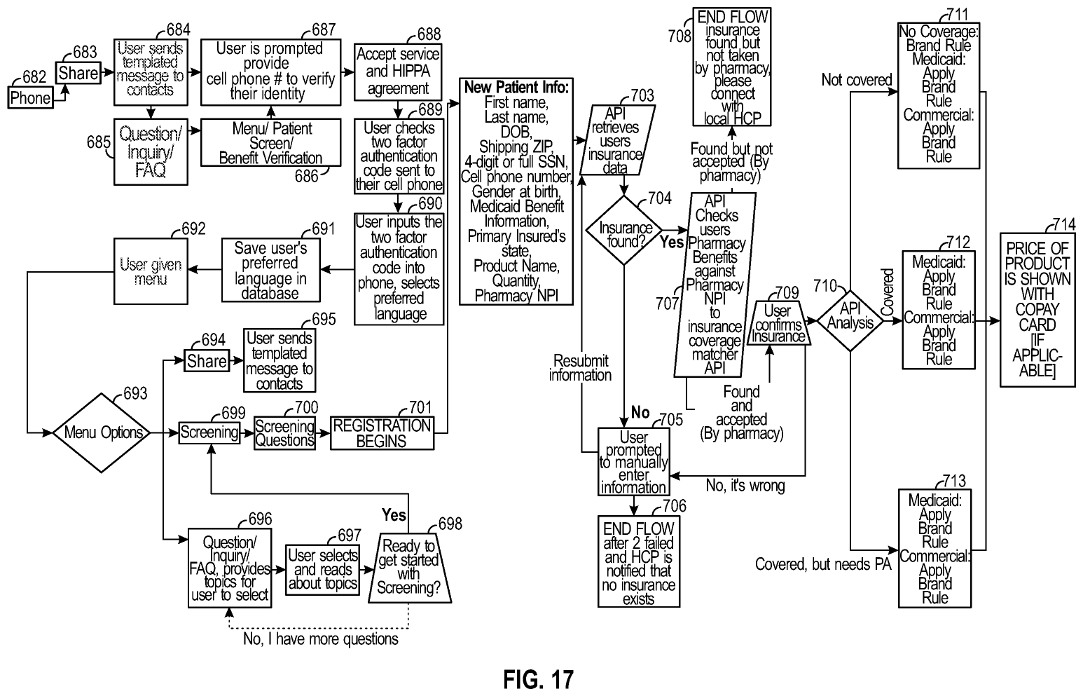

Alternatively, users may be onboarded through non-telehealth HCP partnerships for a specific brand of drug as seen in FIG. 17. The diagram in FIG. 17 is related to the process a user goes through to complete their sign up for a specific brand of drug that is provided or recommended by that HCP without the need of telehealth.

In some embodiments, the platform may identify if a patient is a new user or existing user and offer separate paths in accordance with their status. The platform may also be equipped to recognize the patient by matching its inbound traffic information to past login data from its main database and recognize the patient to streamline a portion of the process. The platform may also be equipped to contain a plurality of databases to perform identity matching in order to streamline the customization process of the menu and options offered to each patient arriving on the platform organically. This is shown in FIG. 1 point 202.

As mentioned above, the platform may be equipped with an extensive patient database that is able to recognize the patient by matching its inbound traffic information to past login data from its main database and recognize the patient to expedite certain steps that are required to advance and reach more features in the platform. This can be seen in module 634, wherein a user arriving on the platform is assigned a unique identifier and recorded in the database regardless of the method of their arrival.

As mentioned above, the platform may have a plurality of partner programs to onboard users. In one of these methods, the users of the platform can be onboarded through healthcare providers that are participants of the platform's program as seen in point 635. Healthcare providers that are treating the patients can elect to prescribe their patients electronically through the platform as seen in point 636. This can be a soft introduction of the platform for the patient in an organic fashion.

Once the HCP electronically prescribes the patient, the pharmacy that the patient is currently using receives their Rx as seen in point 637. After that, API sends new brand Rx back to core platform as seen in point 638 and core platform is notified accordingly regarding a potential patient arriving to the platform.

If the user is being onboarded by a partner HCP, the user needs to provide only their phone number in the initial stage as seen in point 682, as the platform does not intend to capture their contacts or location at that stage. Once the user's phone number is captured, they are offered the option to share with their contacts as seen in point 683. User may then send templated messages to their contacts to invite them to the platform as seen in point 684. Users may elect to share or not share the platform at their will. In either case, users are directed to point 685, where they can access FAQ and have their questions answered. If the user has continued interest, they are directed to provide their cell phone number to verify their identity as seen in point 687. From that point, they are directed to accepting service and HIPAA agreement as shown in point 688. Then, user is prompted to check two factor authentication code sent to their cell phone in point 689. User needs to input the code to proceed as shown in 690. Then, user selects their preferred language and user's preferred language is saved in database as seen in point 691.

Once the service and HIPAA agreement is accepted and preferred language is selected, the user will directed to a menu of options as seen in point 693. This menu is similar to point 230 but modified for HCP flow patients. Patients can ask more questions and learn about the platform or specific brand of drugs as seen in point 696 or they can begin their screening process facilitated by the AI agent.

The AI agent may also ask questions to match users to other partner treatments or medications, or about their medical condition to help connect them with the appropriate telehealth specialist (psychiatric, cardiologist). The AI agent may also check patient's previous record for past prescriptions and HCPs in order to assess the best possible scenario for the patient as seen in FIG. 17.

The AI agent can also ask questions to match users to other partner treatments or medications, or about their medical condition to help connect them with the appropriate telehealth specialist (psychiatrist, cardiologist, etc.). Given that certain telehealth providers (e.g. Betterment psychologists/counselors) may be necessary or helpful to the patient, but not write prescriptions, though it is not the focus of this platform it may be possible for the program to refer the patient to such a service (for a fee to the service, which could be in a form of partnership or agreement) in addition to sending them to a prescription-writing medical professional. It also may be possible for the company to provide some of these services themselves through a feature such as a network of contracted doctors.

The AI agent may also ask questions and collect HIPAA compliant medical information from the patient, such as general health history and records of recent treatments by physicians, nurses, dentists, and other practitioners, and there may be an option for the customer to request their history from their doctor or for the program to transition the patient to purely services if they request.

Once the patient is transferred to the main menu the platform may engage with the patient with a series of questions in order to customize its platform features and services in a more suitable fashion for the patient as shown in point 700. Patients answers to screening questions will determine how the rest of the experience on the platform will be modified and a real-time insurance benefits check will be performed.

Once the patient is transferred to the main menu the platform may engage with the patient with a series of questions in order to customize its platform features and services in a more suitable fashion for the patient. Patients answers to screening questions will determine how the rest of the experience on the platform will be modified and a real-time insurance benefits check will be performed upon their arrival to registration screen as shown in point 701.

The point marked 702 is where benefits verification continues where path 108 left off. Registration begins and the program collects patient info such as first and last name, date of birth, zip-code, 4-digit or full social security number, Medicaid benefit information, gender, drug name, quantity, and pharmacy as shown in point 702. API then looks up the client's insurance as shown in point 703. If they are unable to locate the user, the user is prompted to manually enter information twice. This can be seen in point 705. Once information is manually entered, API checks and shows pharmacy benefits against pharmacy NPI to insurance matcher API as shown in point 707. If the API is still unable to locate the user, the user is prompted to manually enter their information as shown in point 705. As a result of 2 failed checks, the HCP is notified that no insurance exits as seen in point 706 and the flow ends for that user. Alternatively, the insurance may be found by API but not accepted by the pharmacy and the user is prompted to connect with local HCP as seen in point 708.

Once pharmacy benefits are shown and confirmed in point 709, API analysis commences in point 710. If the prescription is not covered, brand rule is applied for Medicaid and commercial benefit in point 711. If the prescription is covered, brand rule is applied for Medicaid and commercial benefit in point 712. If the prescription is covered but needs PA, brand rule is applied for Medicaid and commercial benefit in point 713. Lastly, in accordance with user's coverage information, price of product is shown with copay card available at that point and circumstance as shown in point 714.

### Payment Capture and Appointment Setting

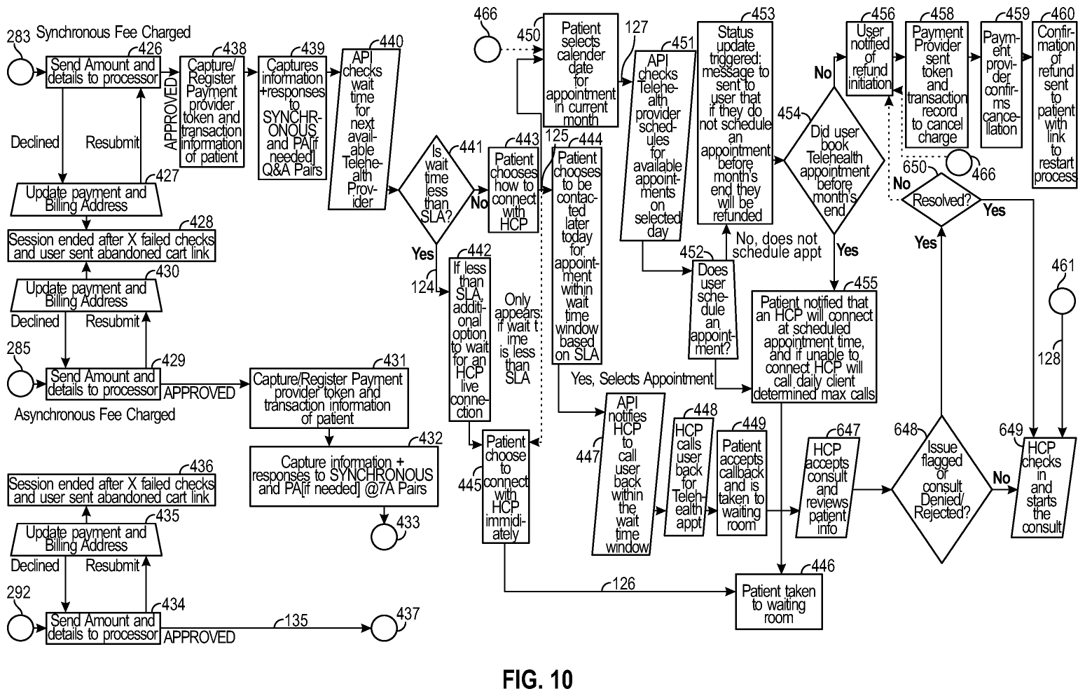

FIG. 10 that starts with paths marked 122, 123 and 135 is a flowchart that is a continuation of FIG. 3 and paths marked 122, 123, 135. It represents the process for new customers where payment operations are handled for both telehealth and non-telehealth options and appointment setting is managed for telehealth customers that live in both synchronous and asynchronous states.

Starting from point 283 on path marked 122 for synchronous telehealth users, payment amount and details are sent to the processor as shown in point 426 in FIG. 10. If the payment is declined, the user is taken to point 427 where they are asked to update payment and billing details. After 2 failed attempts session ends as shown in point 428 and the user is sent an abandoned cart link.

If the payment is accepted on path marked 122, the user is directed to point 438, where the platform registers payment provider token and transaction information of patient to be saved in their profile. It also captures responses Q&A for PA if needed. This can be seen in point 439.

To set up an appointment for the patient, the platform will be equipped with certain API features that can track the availability of healthcare providers within certain timeframe and capabilities to integrate the platform's appointment scheduler wizard and prompt notifications to both healthcare providers and patients to facilitate flexible and soonest appointments. It is particularly important at this stage for the platform to offer an appointment time within a reasonable time frame considering the hurdles a user must go through to get to this stage.

At the continuation of path marked 122, the platform checks wait time for next available telehealth provider in point 440. The platform checks if the wait time for next appointment is within the service level agreement in point 441. If the wait time is more than the SLA, user is directed to path marked 124, where they will be offered an option to wait for a live connection to healthcare provider in point 442. If the wait time is not less than SLA, the user is directed to path 125, where they will choose how to connect with the healthcare provider at point 443.

One option after reaching path marked 125, the user can select a calendar date for appointment in current month as shown in point 450 on the path marked 127. After API checks telehealth provider scheduled for available appointments on selected day by the user as shown in point 451, user is prompted to schedule an appointment in one of the available time slots as shown in point 452.

If the user does not schedule the appointment as shown in point 453, the platform follows up with the user via SMS to notify their status and informs that they will be refunded if they do not schedule an appointment before the end of the current month.

If at the end of that month, the user did not book an appointment they are notified of refund initiation as shown in point 456. The platform proceeds to send transaction record and token information to payment provider to cancel charge as shown in point 458. Once the payment provider confirms cancellation in point 459, patients are notified the confirmation of refund with a link to restart the process. This can be seen in point 460.

If the user does book an appointment within the end of the month as shown in point 455, the platform will notify the patient that an HCP will connect at a scheduled appointment time, and if unable to connect HCP will call daily per client determined max calls as saved in their user profile.

Another option after reaching path marked 125, the user can choose to be contacted later that day for appointment within wait time window based on service level agreement as shown in point 444. If the user chooses this option, the platform will notify healthcare provider to call user back within the day and HCP will user back for telehealth appointment as shown in point 447. The user then accepts the callback and is taken to waiting room as shown in point 449. After the user reaches the waiting room, HCP has to accept the consultation and review patient info to initiate the consultation as seen in point 647. Healthcare provider may reject the consult or flag an issue regarding patient file. If the issue is not resolved, user process flow takes them to point 456, where they are notified of refund initiation. If the consult opportunity is not denied by HCP or the issue gets resolved as seen in 650, HCP may check in and start the consultation as seen in point 649 which leads to path marked 128.

The last option after reaching path marked 125 is for the patient to choose to connect with HCP immediately, which is only available if wait time is less than service level agreement as shown in point 445. If the patient chooses this option they will be taken to waiting room in point 446 and will be directed to path marked 128.

Continuing from point 285 on path marked 123 for asynchronous telehealth users, payment amount and details are sent to the processor. If the payment is declined, the user is taken to point 430 where they are asked to update payment and billing details. After 2 failed attempts session ends as shown in point 428 and the user is sent an abandoned cart link.

If the payment is accepted on path marked 123, the user is directed to point 432, where the platform registers payment provider token and transaction information of patient to be saved in their profile. It also captures responses Q&A for PA if needed.

Continuing from point 292 on path marked 135 for non-telehealth users, payment amount and details are sent to the processor in point 434. If the payment is declined, the user is taken to point 435 where they are asked to update payment and billing details. After 2 failed attempts session ends as shown in point 436 and the user is sent an abandoned cart link.

In instances where the user needs traditional medical care, such as an EKG or operation, the telehealth providers could then connect the individual with a local provider they find through the service. As mentioned above, if the user needs or requests a non-prescription writing professional such as a psychologist or chiropractor, the service may be able to recommend one to them in addition to a prescription-writing professional for a fee to the professional.

The platform would implement an algorithm to search for physicians/practices/institutions who accept the user's insurance plan. The system could accept multiple plan information from the patient (discounts) as well as provide input to allow multiple insurance options, private insurance plans as well as health reimbursement arrangement (HRA), as some individuals may have a number of options for payment. The platform may offer a payment plan feature for uninsured patients.

The system ensures the continuity of information of the user profile (e.g. contact information, optional information about primary care provider, insurance information, EHR number if available). This data is made available either directly, through an API, or encrypted or using a proxy identification number for the prospective or singular insurance provider as well as the Telehealth provider(s) both to solicit and determine the ‘match’ between the user and the provider based on financial/reimbursement factors as well as provision of this information for billing and follow-up.

In the event of multiple insurance/reimbursement options, the system may provide the amount of co-pay or other payment parameters so that the user can select the method of payment and/or insurance that is optimal. It may also allow for provision or use of an existent rating system with regard to the Telehealth provider organizations or individual providers so as to provide this information (as an option) to the user to assist in the selection of the telehealth provider, and/or may implement a novel system to rate the interaction and quality of the telehealth consultation.

Some embodiments may use ‘web-scraping’ technology and/or licensing of healthcare rating platform data to provide ratings or information to the user to assist in the selection of a telehealth provider. This rating data could be licensed to third-party databases.

The platform would integrate and ensure the continuity of licensure information of telehealth organization and their specific providers, legal and professional judgements against healthcare providers, volume of care provision data, sentiment analysis of social media pertaining to providers to inform both the organization providing this solution so as to eliminate or modulate the options to end-users based on this information as well as to inform the user of information that is collected.

The platform will also monitor insurance reimbursement and notify the user if reimbursement has not been received as shown in and could also monitor and notify the user of changes in their telehealth or prescription coverage. s

The resubmission systems and methods of the present invention enables a user to reverse and/or resubmit transactions when a price increase has been indicated by a manufacturer and the claim was paid using an old price value in the reimbursement calculation. In an exemplary embodiment of the invention, the resubmission system provides a pharmacy the option of resubmitting a reimbursement claim once the insurance processor has updated its internal price to reflect the manufacturers updated price. Thus, the pharmacy receives the most recently updated price set by the manufacturer for the particular drug in the reimbursement claim.

The resubmission systems and methods of the present invention may improve the productivity of resources required to monitor, correct, and resubmit claims for updated pricing as well as improve the cash flow and profit margins of pharmacies by ensuring the most-up-to-date pricing of transactions. The resubmission systems and methods of the present invention may be utilized by retail pharmacies (chains, regional pharmacies, independent pharmacies, etc.), mass merchandisers pharmacies, various food and drug industry segments pharmacies, mail order entities, LTC entities, as well as others. Such entities may be referred throughout this description as “users.”

For the purposes of providing an exemplary embodiment of the invention only, the systems and methods described below will be in reference to manufacturer established Average Wholesale Price (“AWP”) values, as that is the current form of drug pricing (e.g., manufacturer(s) set price) used by payer systems to price pharmacy reimbursement claims. In alternative embodiments of the present invention, the claim submission system and methods discussed below, may be modified to operate the same functions and processes based on monitoring pricing elements similar to AWP that may be used in the future to price pharmacy reimbursement claims in addition to or in place of the AWP values. For example, the claim submission system and methods discussed below, may be modified to operate the same functions and processes based on monitoring Wholesale Acquisition Cost (“WAC”), which is also set by the manufacturer(s), Maximum Allowable Cost (“MAC”), which may vary from payer to payer or other pricing schemes similar to the use of an AWP.

Other examples may include if a government agency or third party entity were to periodically update the pricing of drugs for reimbursement of prescription fulfillment claims, rather than manufacturers establishing an AWP value associated with a particular drug, or if a manufacturer (or group of manufacturers) changed their pricing schemes from being AWP based to some other value and/or calculation based scheme, then the claim submission system and methods of the invention may be modified to identify such updates in drug pricing and determine when payers have updated their internal pricing to reflect such updates in drug prices in order to maximize reimbursements of claims submitted from pharmacies to those payers through the claim reversal and/or resubmission methods described below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Prescription claim transactions are electronic records or messages intended to facilitate the communication of prescription information. For example, prescription claim transactions are intended to communicate prescription claim data between pharmacies (i.e., providers) and payers. Although prescription claim transactions will be discussed hereinafter, it should be understood that the various systems and method of the invention may be practiced in connection with other types of prescription transactions or independently of prescription transactions (e.g., raw prescription data). The content and format of a prescription claim may vary depending on which standard or protocol is used. In general, however, prescription claim transactions will identify the intended payer recipient, the drug product to be dispensed or previously dispensed, e.g., by National Drug Code number (“NDC”), the quantity to be dispensed as well as the days supply, whether the prescription claim relates to a new prescription or a refill prescription, and billing-related information.

Prescription claim transactions may be transmitted from the pharmacy POS device to the host server in batch, real-time or near real-time. Pharmacy POS devices can connect to the host server through a variety of methods, including dial-up, frame relay or leased-line. The entire system is preferably supported by redundant software, communications links, and uninterruptible power supplies, thereby ensuring that all connections will provide reliable, continuous operation. The system also preferably ensures that all of provider-submitted claims transactions are routed quickly, accurately, and consistently. The claim processing system substantially reducing the costs of submitting claims and speeding up providers' payment cycles.

In certain embodiments, the host server may serve as a clearinghouse for multiple payer systems. As noted above, payer systems may include systems operated by insurance companies, financial institutions and other financial service providers. In its capacity as a clearinghouse, the host server is operable to parse prescription claim transactions and forward them to the appropriate payer system for processing. Approval, authorization or rejection messages may be returned to the host server from the payer systems and such messages may be forwarded by the host server to the pharmacy POS device.

In serving as a clearinghouse, the host server may also be configured for performing pre-editing and post-editing of prescription claim transactions. Pre-editing and post-editing refers to real-time or near real-time validation and management of prescription claim data in order to maximize prescription claim reimbursement and minimize claim submission errors. Pre-editing and post-editing may generate messaging alerts and/or retrospective reports supporting “usual and customary” price comparisons, average wholesale price (“AWP”) edits, dispense as written (“DAW”), brand appropriateness, and numerous other screening processes for facilitating rapid and accurate validation of prescription claims.

In accordance with the present invention, the host server may be configured for performing certain claim screening, reporting, and editing processes for the detection and correction of AWP reimbursement values in a claim reimbursement transaction, whether it be an original submission, reversal or the resubmission of a claim. A pharmacy seeking the appropriate reimbursement uses the AWP module to monitor both the current AWP price established by the manufacturer and the reimbursement values paid by the insurance processors. Therefore, the AWP module may comprise computer-executable instructions for performing various processes for reviewing, storing and possibly editing reimbursement claims, as well as managing related messaging and reporting functions regarding the AWP values used during the adjudication of a claim by a payer system. The host server intercepts claims adjudicated by the payer system, and the AWP module parses and examines the claim's contents. If instructed to do so by the user operating the pharmacy POS device, the AWP module then determines if the claim contains the appropriate AWP value. This process will be discussed in further detail below. The AWP module forwards the claim to its intended payer.

However, where a claim fails to meet payer-provided claim criteria, the AWP module can transmit a claim reject message to the pharmacy POS device, so that the pharmacy can correct the claim error and retransmit the claim. Reject messages may indicate that a prescription claim has been rejected, provide a pharmacist with information about the claim error, and may encourage the pharmacist to correct the prescription claim.

The claim criteria may also dictate actions that should be taken, such as messages transmitted to a pharmacy concerning the claim reimbursement value. The claim criteria can also instruct the module that the claim should be compared against databases of objective information, such as drug lists or current AWP values provided by manufacturers or other sources, or against historical data, such as historical consumer claim information, stored in one or more databases associated with the host server. The submitted claim reimbursement may be corrected by the AWP module and forwarded to the intended payer system in an attempt to maximize the reimbursed value of the submitted claim. Finally, the AWP screening and editing processes according to the present invention may also be designed to capture certain prescription claim data (e.g., AWP pricing information) for subsequent analysis and reporting related to claim errors transmitted from pharmacy POS devices.

The host server may include or be in communication with one or more database. The database may store, for example, data relating to pharmacies, payers, state prescription laws, prescription drugs, formularies, and consumers, such as typical doses filled by consumers, typical drugs prescribed by doctors, most common daily dose values, common daily dose values, likelihood indicators and other data used in the various claim screening and editing processes described herein after. The database may also store reports and other data relating to the results of the claim screening and edit processes. The database may of course also store any other data used or generated by the host server or AWP module, such as data used in other pre-editing and post-editing methods and reports generated thereby. Although a single database is referred to herein for simplicity, those skilled in the art will appreciate that multiple physical and/or logical databases may be used to store the above mentioned data. For security, the host server may have a dedicated connection to the database, as shown. However, the host server may also communicate with the database via a network.

The network may comprise any telecommunication and/or data network, whether public or private, such as a local area network, a wide area network, an intranet, an internet and/or any combination thereof and may be wired and/or wireless. Due to network connectivity, various methodologies as described herein may be practiced in the context of distributed computing environments. Although the exemplary pharmacy POS device is in communication with the host server via one intervening network, it is to be understood that any other network configuration is possible. For example, the pharmacy POS device may be connected to a pharmacy's local or wide area network, which may include other devices, such as gateways and routers, for interfacing with another public or private network. Instead of or in addition to a network, dedicated communication links may be used to connect the various devices of the present invention.

Using the claim processing system, providers can transmit in real-time provider-submitted claims to an appropriate payer and return a claim approval or rejection within seconds. Thus, the claim processing system can streamline provider claim processing operations and increase productivity for both providers and benefit plans. To enable the provider to input claims for electronic transmission to the claim processing system and payer, the pharmacy POS device may comprise software that receives claim data entered by a user through a graphical user interface (GUI).

According to one aspect of the invention, no claim processing software resides on the POS device, other than an Internet browser, because the GUI and one or more interfaces for inputting claim data are stored by the claim processing system and remotely accessible by the POS device via an Internet connection, satellite or cellular network, LAN, WAN, or the like. Using the GUI information such as a patient's name, birth date, address, telephone number and other identifying information is entered with claim-specific information, such as drug prescription or medical service or procedure. The identity of the pharmacy is also included in the claim data along with additional information known to those of ordinary skill in the art.

According to one aspect of the invention the claim data fields are defined by a particular payer such that the POS device should provide only the claim data requested by the payer to which the claim is transmitted. According to another aspect of the invention the claim data is defined by a pre-established standard or transaction format well known to those of skill in the art. Once the claim is entered, it is transmitted to the host server via any of the methods described above. The claim is then edited by the host server and/or forwarded by the host server to the appropriate payer system. Preferably, the claim processing system, and more particularly, the host server, is an all-payer solution allowing providers to use a single application to connect to key government and commercial payers across the country.

Next, the program checks if there has been a recent price change to a manufacturer set price such as an AWP price change (e.g., typically the change in the manufacturer set price is a price increase). The detection of the AWP price change (or “new” AWP) may occur in a variety of different ways. The system may receive updated AWP information on various drugs (or other items associated with a particular AWP) from manufacturers directly (as the manufacturers drive AWP price updates) or monitoring services. For example, the services of First Databank, Inc. may be utilized to monitor AWP price updates. The period of time considered to be a “recent” price change may be any set length of time, or may be as long as the AWP price change remains unrecognized by one or more payers.

For all reimbursement claims, where there is an AWP price change detected from the manufacturer or a monitoring service, etc., the next step is invoked to store the reimbursement claim information in a transaction table located in one or more databases associated with the AWP module. If no AWP price change is detected, then storing the submitted claim information is not necessary (though may be done for reporting or system monitoring purposes) and the AWP monitoring process may be exited.

Once an updated AWP value has been detected, the next step is invoked to monitor adjudicated claims, by a particular payer, and determine when the payer adjudicating submitted claims has updated their records to reflect the recent change in the AWP price established by the manufacturer. A series of calculations may be conducted to determine if a claim was paid using an old AWP value (rather than the AWP value updated by the manufacturer) and should be presented to the customer as a resubmission opportunity. In an exemplary embodiment of the invention, determining a change in an AWP value for a particular payer is done by reviewing the reimbursement values associated with recently adjudicated reimbursement claims submitted to that particular payer and comparing them to older reimbursement values adjudicated by the same payer, to determine when the payer (or payers) have updated its internal pricing values (e.g., internally stored AWP values) to reflect the new global price associated with the drug set by the manufacturer(s). This determination may be used to identify the specific date/time the “new” AWP set by the manufacturer has been recognized and/or implemented by that particular payer. Typically, a payer's reimbursement value is the AWP minus a percentage of the AWP (e.g., AWP−%, other factors and values may be included in a reimbursement calculation, such as a patient's co-pay, etc., but for purposes of simplicity such factors are not discussed herein, though appreciable by one of ordinary skill in the art). For example, if the AWP is $100 and the reimbursement of the claim was for $50. Then the payer reimburses for the AWP value minus 50%.

An exemplary calculation to determine when a particular payer has updated their internal AWP value used for adjudicating claims may be where a reimbursement claim for drug A is $50 and the AWP is $100 (e.g., the payer is only reimbursing $50 of the AWP established by the manufacturer). However, the manufacturer increases the AWP to $120-a 20% increase. The system then monitors claims for that same drug adjudicated by that same payer until the reimbursement value reflects approximately the same percentage increase associated with the “new” AWP set by the manufacturer(s). In other words, for this example, the adjudicated claims associated with the same drug are monitored until the reimbursement value is approximately $60 (a 20% increase over the previous reimbursement value of $50). At that time, the system determines that the payer has updated their internal AWP value to reflect the “new” AWP price set by the manufacturer.

Once the system detects that the payer's internal pricing has been updated, further calculation may be conducted to determine the actual percentage of change in the internal AWP price utilized by the payer for reimbursing claims (the new internal AWP price utilized by the payer may also be extracted from such a calculation). In alternative embodiments of the invention Other calculations and processes used to determine when a payer updates its internal AWP values used to adjudicate claims for reimbursements may also be implemented. In other embodiments the set time when a particular payer updates its AWP values used to adjudicate claims may be known. In such a case, the determination of when a payer's AWP values have been updated through the comparison of recently adjudicated claims to older previously submitted claims or various other calculations may not be necessary. Such information may also be useful when the manufacturer decreases the AWP associated with a particular drug and the payer may not have updated their internal AWP value yet.

When a new AWP has been detected as well as confirmed that the payer to which the claim was submitted is now honoring the new AWP, the customer may then be notified that the payer now honors the updated AWP value may be utilized for customer claim reversals, claim resubmissions, or future reimbursement claims. Opportunities for claim reversal/resubmission or a report notifying a customer of potential claim reversal or resubmission opportunities may be presented to a customer in a variety of ways selected by the customer (e.g., pharmacy).

A customer is provided with a report, which will enable the customer to perform the actual reversal and resubmission from their system. Such a report may be provided to a customer at a period time interval that may be established by the customer or whenever a customer requests such a report. The second form of presentment for claim reversal or resubmission is an online resubmission where the customer is provided with a web-enabled user interface to approve some or all transactions for reversal and resubmission back through the host server and AWP module.

Once it has been determined that the payer has updated the AWP pricing in their system and the customer elected the “report only” option (e.g., any reversal/resubmission of a reimbursement claim will occur at the customer level), a report will be generated and available to the customer via email link or user interface to a reporter system. Customers will be able to use the information listed in the report to determine if they wish to resubmit a transaction through their system. A report is generated to summarize a customer's reversal/resubmission opportunities according to one embodiment of the present invention. The customers will be able to use the following information to determine if they wish to resubmit a transaction through their system: Store ID (or National Association of Boards of Pharmacy “NABP” identification number), Rx number, fill date, AWP effective date, BIN, BIN Description, NDC, drug name, old AWP (per unit), new AWP (per unit), original ingredient cost paid (along with its percentage off of the new AWP and percentage off the old AWP), potential opportunity (e.g., monetary amount that may be received if a resubmission is successful), opportunity date (e.g., date the payer updated its internal AWP), etc. Other information such as quantity of prescription, Pharmacy Care Network “PCN” number, amount the patient paid (e.g., co-pay), or Group ID may also be included in the report.

In an exemplary embodiment of the invention, the file may be delivered by emailing a URL link to the AWP Report system, download reports from the user interface, FTP, or other means of electronic communication. In embodiments of the invention, these transaction files may be generated as the resubmission or reversal claims are being processed, at period intervals, or at the customer's request. The transaction files may be generated nightly for each customer who selected transactions for resubmission or reversal during the past 24 hours. If there were no resubmissions or reversals selected to be processed during the previous time interval, a transaction file does not need to be generated. Other time intervals (weekly, monthly, at the customer's request, etc.) for claim resubmission and/or reversal monitoring and transaction file generation may also be used.

The transaction file may include the date of service, the Rx Number (prescription number from a resubmission), Store ID (or NABP or National Council for Prescription Drug Programs, Inc. “NCPDP” provider ID number), the date/time stamp when the reversal or resubmitted claim was processed, status of the reversal (e.g., ‘A’ for “accepted,” though other indications may be provided in alternative embodiments), status of billing (e.g., ‘P’ for “paid” and ‘C’ for “captured,” though other indications may be provided in alternative embodiments), routing BIN, NDC number of the resubmission and/or reversal, the drug name (e.g., a text description of the NDC number from the FDB file may also be included), the original ingredient cost paid, the submitted AWP associated with the resubmitted transaction, the new ingredient cost paid from the adjudicated response, and the increase reimbursement value (e.g., the payer ingredient cost paid-the original ingredient cost paid). Additionally, rejection codes may be provided to indicate a rejection of a reversal and/or a resubmission as well as an indication of the reason for the rejection from the payer (e.g., included with the adjudicated response).

The transaction file may also be sorted or reorganized in ascending or descending order based on the various attributes presented on the screen. The amount of transactions displayed may also be varied depending on the date ranges selected. It displays features such as: a count of all reversals and/or resubmissions included in the file, the sum of the increased reimbursements, the total number of reversal and/or resubmission rejections, the percentage of rejections (e.g., total rejections divided by total claims), resubmission rejections originally paid, etc. Other information may be included in the transaction file, such as detailed descriptions of a reason for a rejection, percent of successful reimbursement resubmissions, running total on increased reimbursements for the customer; percentage increase in an increased reimbursement, or other data relating to a reversal or resubmission of a claim that the customer may find useful for monitoring, accounting (e.g., accounts receivable and/or cash flow), auditing, etc.

Accordingly, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of this application. Although specific terms are employed herein, they are used in a generic and descriptive sense only and not for purposes of limitation.

### Telehealth and Suggesting Pharmacies

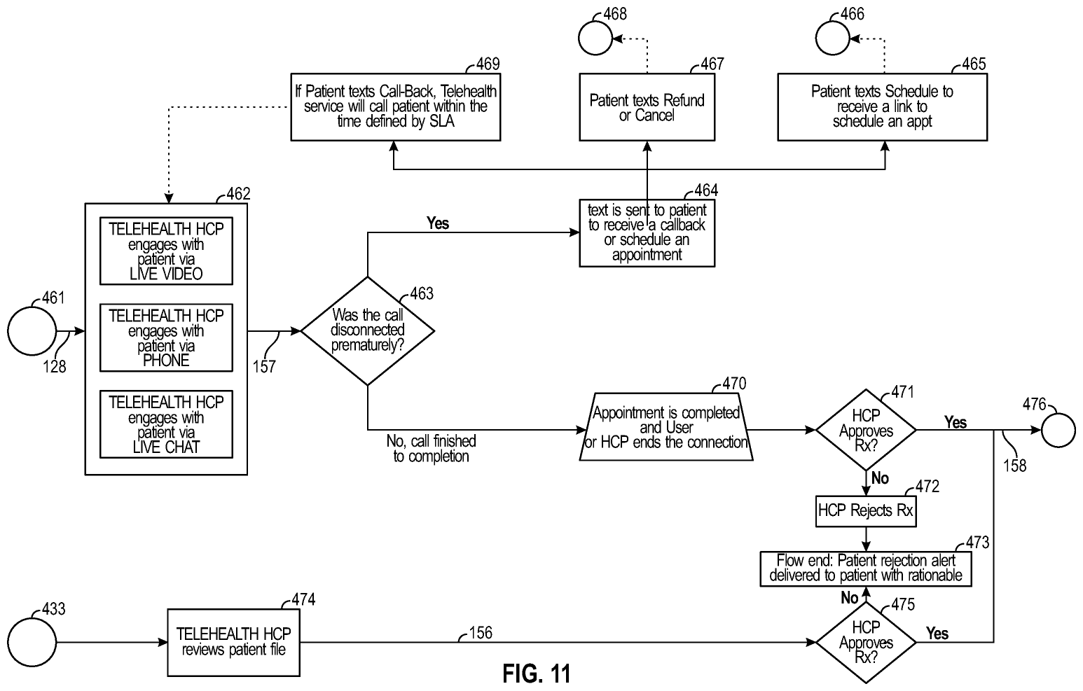

FIG. 11 is a flowchart that is a continuation of paths marked 123 and 128 regards how the process connects clients with synchronous and asynchronous telehealth appointments and generating the Rx the patient has requested.

Continuing from path marked 123, if approval is asynchronous for the patient's state, the patient is then asked whether or not they have a telehealth balance. If they do not, telehealth HCP reviews the patient's file as shown in point 474. If the patient has a telehealth balance, they are prompted to input their credit card and billing address (they can choose to use shipping), and then telehealth HCP reviews the patient file as shown in point 475 and the script is sent to an appropriate pharmacy in path marked 158. If the HCP does not approve Rx request as shown in 473, user is notified with rationale and they can start the process from the beginning if they still want the same Rx. The platform may be equipped to offer the user a different brand of drugs, or seek telehealth with another HCP. All platform recommendations are reached as a result of processing the user data from earlier steps.

Continuing from the path marked 128, if approval is not asynchronous, the patient is asked whether or not they have a telehealth balance. If not, they immediately given the option to select visit type as shown in point 462. If they do, they input their credit card and billing address for shipping, then can select their visit type option. Visit types include live video, live phone, or live chat, and the patient then engages with their telehealth provider in the said fashion. If the user disconnects prematurely during the telehealth visit as shown in point 463, they will be sent a text to receive a callback or schedule a new appointment option as shown in point 464.

The patient then can communicate by simply replying to the text they received. If they text “call-back” as shown in point 469, telehealth service call patient within the time defined by service level agreement. If they text “schedule” as shown in point 465, they will receive a link that will take them all the way back to FIG. 10 path marked 127 where they will be directed to appointment scheduler wizard. The patient may be unsatisfactory with the telehealth visit as another reason to their premature disconnection. In this instance patient can text back “refund” or “cancel” as shown in point 467 to initiate a refund where they will be taken all the way back to initial registration phase.

If the telehealth visit comes to a completion as shown in point 470, the next step is for healthcare provider to review Rx requested by the patient as shown in point 471. If it is accepted, the patient is directed to path 158 whereas their script will be sent to the appropriate pharmacy.

Alternatively, for both synchronous and asynchronous telehealth visits, healthcare provider may reject the Rx request after conducting a telehealth visit or reviewing patient file as shown in point 472. Then, user is notified with rationale and they can start the process from the beginning if they still want the same Rx as shown in point 473.

The platform may be equipped with A/V communication as well as streaming and chat functionalities to host telehealth visits under HIPAA compliant. That would require all communication to be fully encrypted and only accessible to authorized users.

The platform can also connect people with medical professionals who do not write prescriptions, such as counselors and psychologists. Their progress could be logged in the program and shared with their psychiatrist or other medical professionals they see. There could also be data that is voluntarily shared by other participants in terms of experiences, changes in quality of life through something such as a rating feature and/or an ability to have a linked support community. The program could also allow patients to bidirectionally share medical device, wearable data information, or other medical information before, during, and after the telemedicine session. The program could offer a scheduling feature integrated with more commonly available scheduling applications such as Google Calendar.

The program could suggest pharmacies to the patient based on need, location, and the availability of their medication. It could check pharmacy's online inventory to only suggest those which have the needed medication in stock, and could also check which pharmacies are certified to handle certain rare medical conditions if necessary. There also may be an option for the patient to request a virtual pharmacist consultation, and the program would only suggest pharmacies that offer that service. If a patient has a disability, such as difficulty walking or hearing, the program could suggest pharmacies that could offer them the best experience (ex. rated for excellent wheelchair accessibility, a pharmacist certified in ASL, etc.)

Users could be allowed to rate their pharmacy experience based on a number of different criteria (disability accessibility, speed, customer service, quality of information provided, ease and quality of interaction to obtain initial prescription as well as refills, etc.) which could then be used when recommending pharmacies to other users. Pharmacy information and fulfilment can be supplemented with on-line interactions through a standard Q&A portal that can have a combination of FAQs, live phone or telemedicine interaction, and/or the use of AI agents.

Afterwards, the merged prescription and patient information is electronically forwarded to an Optimal Workflow and Load Balancing unit wherein the unit examines the program's data to determine the optimal Therapeutic Pharmacy and pharmacist within that Therapeutic Pharmacy suitable for handling the prescription order. Thereafter, the order will be assigned to the Pharmacist and electronically appear on her computer task screen. If the program has noted any unresolved protocols, the Pharmacist may transmit the prescription order to an Integrated Contact Management unit (ICM) for resolution, wherein ICM will communicate with the program to gather additional patient 30 stratification and clinical score information the Pharmacist may need for display on the pharmacist's computer task screen. This additional data is may be used to assist the Pharmacist in resolving open protocols on that patient's order and allow the order to eventually be filled and dispensed.

Some embodiments may also feature a veterinary health option, since veterinary pharmaceuticals are often fulfilled by regular pharmacies and virtual veterinary services such as Telepaws are becoming more widely used.

Some embodiments may feature certain API capabilities to perform real time insurance and benefits verification for pets if the user would like to access veterinary health services that the platform may contain. Similar to users experience, the platform may offer telehealth appointment scheduling wizard after a successful verification of pet insurance or collection of payment by cash.

One important thing to note in this feature would be the verification of pet insurance is used for the pet that is receiving the treatment. The platform may be equipped to collect microchip information associated with the pet and verify that information against the insurance information of the pet. The platform may also be equipped to verify the pet by analyzing certain physical features and crosscheck with

Of commercial note is that the foregoing data may be aggregated for multiple users, for example by the host computing facility, for market research purposes. Also, an individual user's prescribing patterns may be reviewed by the user or by others. For example, drug benefits companies, can review the user's prescribing patterns for formulary compliance and respond by encouraging better compliance, where appropriate. Release of such data to third parties can be controlled to safeguard the privacy of the prescriber, or other health care provider, by prescriber-determined data access protocols specifying who, or what organization, department or group, may access what data, when they may access it and what they can do with it. For example, one physician may permit academic use for research studies and prohibit commercial use while another may permit either.

A range of optional features, for example the answering service and e-mail features mentioned above, or other communications features, may be made available from button bar providing the user with user-configurable means to customize the system to their personal needs and tastes.

Skeptical prescribers are encouraged to adopt the prescription management system of the invention, by its ability to bring to the point-of-care, in readily utilizable form, a battery of relevant drug-specification information and important patient-related information, much of which is not readily accessible at the point-of-care by conventional means.

With regard to diagnostic tests and procedures, for example radiology, the platform contemplates electronically bringing relevant information to the point of care to assist health care providers make informed decisions. Such diagnostic information may comprise recommendations for clarifying a tentative diagnosis, or choice of diagnoses, or may comprise diagnostic results that can be used to make more informed therapy decisions and, in particular, to make better therapeutic drug selections. Body system function tests, for example renal or liver function tests are clearly valuable to a drug selection process, since renal and liver condition are important in determining dosages of some medications. Other therapy-relevant diagnostic determinations can usefully be presented at the point of care, by means of the present invention, for example, drug-level determinations can enhance dosing decisions.

A useful, prescription management system-compatible patient encounter program can begin with a patient selection screen. The patient selection screen can be activated by any one of multiple programs which may, for example, be initiated via the system entry screen, but could be independent, free-standing programs or any other program for which the ability to create, update and modify a patient-specific record or a patient history is valuable.

Preferred embodiments of software procedures (or programs) associated with the novel patient record selection procedure can access multiple remote databases to retrieve patient records, for example, by using the host computer facility, and can also post new patient records, and updates, created locally by the physician-user, to the multiple remote databases in real time, or in batch mode.

Source data for a typical patient record may be distributed across multiple, geographically dispersed, electronically incompatible, remote databases maintained for example by drug benefit companies, insurers, laboratories, medical facilities, diagnostic testing facilities and health maintenance organizations, including government agencies (MEDICAID, MEDICARE, etc.) and health care providers themselves, that have serviced the patient in the past. Known automated patient record systems either ignore such remote data and work only with data created at the maintaining facility or vertically integrated health care organization, or create and maintain duplicates of the remote data.

Still more preferred embodiments of the invention provide substantial savings of resources, time and effort by using only source data for patient records, minimizing creation of multiple redundant local databases that require constant synchronization with remote sources if they are to remain accurate and up to date.

If desired, preliminary selection of groups of patients can be made by providing various patient lists, for example “Today's Patients”, “In-Patients”, “Out-Patients”, “Private Patients” and the like. Such patient lists are preferably system-maintained, on an ongoing basis, using the latest data available to the system and preferably enable the user to select a convenient group of patients that has a high probability of including the next patient or patients to be encountered, thereby speeding access and retrieval of a desired patient record. Where the user typically encounters patients in groups, for example one group in an out-patient clinic and another group in an in-patient clinic, such grouping of patient records into lists also facilitates organization by a host computer facility of display data into small batches that can more rapidly be communicated via limited capacity copper wires and modems and are of a size that can conveniently be held in RAM on a small, portable user device.

Problems or conditions and allergies are here displayed as a helpful notation for the prescriber and do not become prescription elements as a result of being selected for display in this part of the screen. However, selections made here are functional in that selected problems (conditions) will become defaults or preferred choices in a subsequent condition specification procedure and the system will review any drugs prescribed for relevance to allergies.

Prescription features bar comprises an Rx History button, an Rx Options button, an Updating indicator, an Rx Info button and a Renew Rx button. Prescription history zone displays those historical prescription details that may be relevant to a current prescription and has a Condition field, a Drug field, a Size field, a Dosing field, a generic flag, an Expires field, and a field in which the various characteristics of patient's previous prescriptions are listed. Prescribing zone comprises three active buttons, New Rx button, Send Rx button and Close button, below which extends a prescribing header bar which contains field identifiers for data entry of a full complement of prescription details.

Multiple lines of the selected patient's prescription history are listed in patient history zone in the middle of the screen for convenient review by the physician-user, and possible renewal, with scrolling or paging of extensive histories. Depending upon the patient's previous whereabouts and service providers, individual lines may come from multiple remote sources. Such histories are preferably compiled by the host computer facility in response to a call from the user device. To maintain data integrity, and as a legal safeguard, historical information is not editable but may be supplemented, for example by reporting the subsequent status of a problem as (still) active or inactive. Preferably, any such additions to the record are stamped with the identity of the reporting physician, providing valuable elements of a treatment decision-making audit trail.

The patient's drug-related allergies, or drug reactions, are brought up in possibly editable form (screen not shown) by activating an Allergies button and may be automatically system updated, if desired by adding newly reported drug reactions and allergies. Desired personal or drug records relevant to possible allergies of this patient may be summoned from the host computer facility, which may in turn call on the remote database data-retrieval network for records or record elements.

Rx History button, scrolls, drops down, or otherwise accesses any additional patient history lines beyond what will fit in prescription history zone and may introduce vertical or horizontal scroll bars, or both, enabling the user to display any desired section of a patient's prescription history in zone with the top line of the history highlighted. Any desired prior prescription line displayed in zone, can be highlighted by clicking or pressing on it.

The system controller is one or more network servers running software to keep track the doctors' issued electronic prescription, patients' prescription prompts, doctors' authorizations or declines on respective prescription prompts; and correctly track or process prescription redemptions and purchases made by patients.

The system operator utilizes a client terminal to access and configure the system's controller as is conventional with computer systems and network servers.

Patient can begin the process of online prescription ordering by login to the online platform. If the patient is not yet a registered patient member of the said platform, he/she will be required to do so. If the patient has already registered with the network, he/she will satisfy the login requirement and proceed to select the type of prescription needed. Once the prescription order is entered, the patient will be required to supply a doctor's email address, and the said doctor must be a registered member of the said prescription network. If the doctor of said patient's choice is not a registered physician member of the said prescription network, an email request to setup the membership is sent by the system controller to the doctor's email address.

Upon recipient of the email request, the doctor will provide the system controller with registration information related to his/her field of specialty and ability to practice medical science, such as the doctor's certification information. This information will then be verified by one of the authorities, such as the American Board of Medical Specialties (ABMS), an organization that maintains a database of physician board certification information on more than 700,000 specialty physicians representing 36 medical specialties and 88 subspecialties. Upon confirmation from said medical authorities, the doctor's status within the pharmacy network will be confirmed as registered doctor. When a doctor is a registered member of the pharmacy network, he/she can issue prescriptions for his/her patients who are also registered patient member of the said pharmacy network.

An email request for the above prescription will be sent to the respective doctor for approval, and the prescription order is put on hold. If such prescription order is not approved by the doctor within a set time period, the prescription order will be cancelled by the system controller. When a confirmation of approval is granted by the doctor, the patient will be notified by the system controller, and he/she can choose to either to redeem the prescription through an online payment or an in-person payment option. If electronic payment method is selected, the patient will select either pick-up or shipping as delivery preference. If the patient selects shipping as delivery preference, the patient's financial account will be charged of the amount of the prescription plus the applicable shipping costs, and a confirmation for prescription filled will be sent to the patient. If pick-up is selected, the patient's financial account will be charged of the amount of prescription, and the patient will be notified when the prescription is ready for pink-up. If in-person payment is selected, the patient will receive a notification upon prescription fill for pick-up.

Patients are not the only ones who can prompt a prescription order, registered doctors can do the same on the said pharmacy network. After seeing a patient, a doctor can issue an authorized electronic prescription over the said pharmacy network for the patient's convenience. The doctor must also first register with the said pharmacy network and be confirmed by the medical authorities. The doctor can login to the pharmacy network and enter all information related to the patient's prescription. If the patient is not a registered patient member of the said pharmacy network, an email request for registration will be sent to the patient by the system controller upon a doctor's prescription prompt. If the patient chooses not to register, the electronic prescription will be invalidated by the system controller after a set time period. If the patient submitted his/her registration information to the pharmacy network, he/she will then be able to redeem the above mentioned prescription over the said pharmacy network.

If the patient is already a registered patient member of the said pharmacy network, the doctor can simply enter the patient's email address, and a redemption notification of electronic prescription will be forwarded to the patient. If electronic payment method is selected, the patient will select either pick-up or shipping as delivery preference. If the patient selects shipping as delivery preference, the patient's financial account will be charged of the amount of the prescription plus the applicable shipping costs, and a confirmation for prescription filled will be sent to the patient. If pick-up is selected, the patient's financial account will be charged of the amount of prescription, and the patient will be notified when the prescription is ready for pink-up. If in-person payment is selected, the patient will receive a notification upon prescription fill for pick-up.

### Pharmacy Fulfilment, Refill, Auto-Refill

The present platform is directed generally toward prescription management systems and associated methods, including prescription management methods in computing environments that provide prescription fulfillment management, related care support services, patient opinion information collection, and the ability to interface a prescription management system with other related systems. Aspects of the invention are directed toward a method for managing prescription medication fulfillment that includes collecting prescription related data for each one of multiple patients. Each patient can be associated with one or more prescriptions. The prescription related data can include a patient identification and/or one or more drug names associated with the one or more prescriptions. The method can further include contacting at least one of the patients and providing information about fulfillment of the patient's one or more prescriptions. In certain embodiments, the method can further include providing one or more response options regarding the fulfillment of the patient's one or more prescriptions and receiving an input indicating a selection of at least one of the one or more response options. In selected embodiments, the method for managing prescription medication fulfillment can include a method in a computing environment. In other embodiments, the method can include providing information to at least one of the patients via phone.

Other aspects of the platform are directed toward a method for providing care support services related to prescription medication, wherein the method includes collecting prescription related data for each one of multiple patients. Each patient can be associated with one or more prescriptions. The prescription related data can include a patient identification and/or one or more drug names associated with the one or more prescriptions. The method can further include contacting at least one of the patients and providing a care support service to the patient related to the patient's one or more associated prescriptions. In certain embodiments, the method can include providing one or more response options related to the care support service and receiving an input indicating a selection of at least one of the one or more response options. In selected embodiments, the method for providing care support services related to prescription medication can include a method in a computing environment. In other embodiments, the method can include providing a care support service to the patient via phone.

Still other aspects of the invention are directed toward a method of collecting patient opinion information associated with a prescription medication, wherein the method includes collecting prescription related data for each one of multiple patients. Each patient can be associated with one or more prescriptions. The prescription related data can include a patient identification and/or one or more drug names associated with the one or more prescriptions. The method can further include contacting at least one of the patients and providing one or more response options to the patient regarding a request for patient opinion information. The method can still further include receiving an input from the patient indicating a selection of at least one of the one or more response options and providing an output based on the patients'selection of at least one of the one or more response options. In certain embodiments, the method of collecting patient opinion information includes a method in a computing environment.

Yet other aspects of the invention are directed toward a method for providing formatted prescription related data for use in a prescription management element that includes collecting raw prescription related data for each one of multiple patients. Each patient can be associated with one or more prescriptions. The prescription related data can include a patient identification and/or one or more drug names associated with the one or more prescriptions. The method can further include processing the raw prescription related data for each one of the multiple patients to produce formatted prescription related data. The method can still further include providing the formatted prescription related data for each one of the multiple patients to a prescription management element. In selected embodiments, the method can further include collecting drug related information. In certain embodiments, the method for providing formatted prescription related information includes a method in a computing environment.

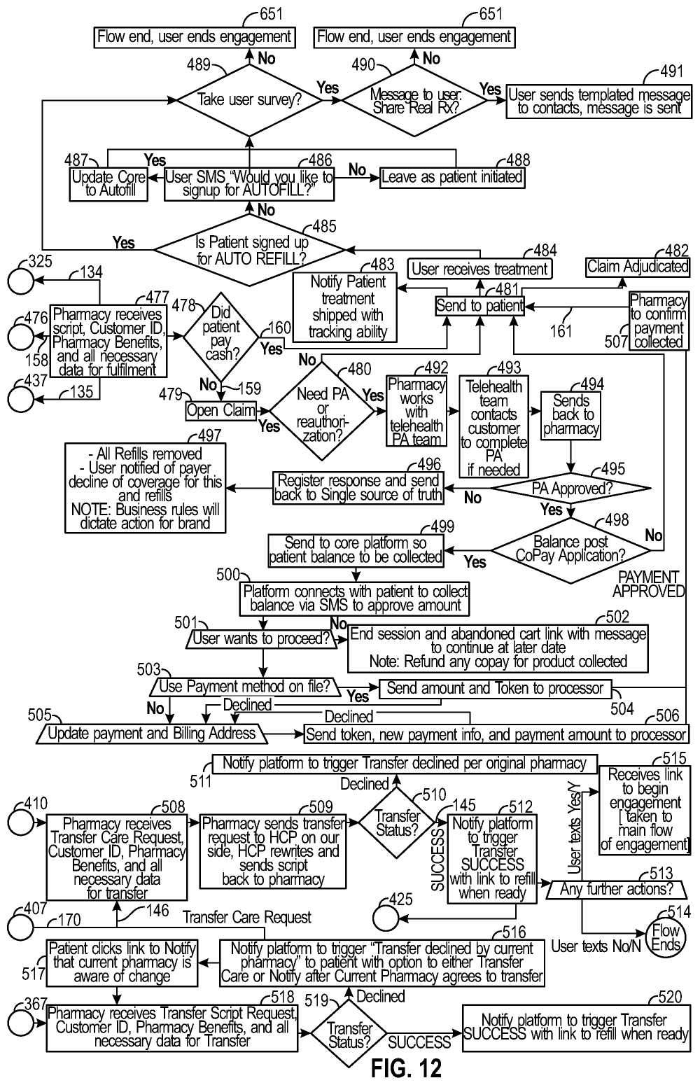

FIG. 12 is a flowchart that is a continuation of paths marked 134, 135 and 158 and related to pharmacy fulfillment provider and ultimate fulfillment of the script. Once the script is sent, the shipping vendor receives the script, customer ID, pharmacy benefits, credit card info, and all necessary data for fulfillment as shown in point 477. Then, the program must assess whether the script either needs PA or isn't covered by checking if the patient paid by cash as shown in point 478.

If the script needs PA or isn't covered by commercial insurance, the pharmacy will send the script to the telehealth PA team as shown in point 492, which then contacts the customer to complete PA and sends the script back to the pharmacy as shown in point 493. If PA is rejected, the response is registered and sent back to single source of truth as shown in point 496. Afterwards, all refills are removed and the user is notified of payer decline of coverage for this and any refills. If PA is not rejected (or possibly if it is), the pharmacy fills (or does not fill) the script based on brand business rules as shown in point 497.

If the script needs PA and is approved by PA as shown in point 498, the platform proceeds to check if there is any balance due post copay application. If there is balance to be collected, platform connects with patient to collect balance via SMS to approve amount as shown in point 500. User is then asked if they want to proceed with the payment as shown in point 501. If they decline, the flow ends as shown in point 502 and platform initiates refund any copay for product collected. If user accepts payment amount, they are asked if they would like to use payment method on file as shown in point 503. If they accept, the platform sends payment amount and token to payment processor and user is directed to point 507, where pharmacy will confirm the payment collection. If the user does not want to use the payment method on file, or if their payment method on file is declined user is directed to point 508, they are asked to update payment and billing address in point 505. Once the payment is approved the user is directed to point 507, where pharmacy will confirm the payment collection.

If the script does not need PA and is covered by insurance, the script is then sent to the patient as in path marked 160 and the user receives treatment as shown in point 484. The pharmacy or other provider can recognize the medication through either an electronic or physical prescription faxed, mailed, or otherwise sent to the pharmacy or other fulfilment services. Other possible methods of prescription fulfilment include services such as VSee, MeMD, and Kaleido Health which connect patients to prescriptions without the use of a pharmacy.

Once the user receives the drugs, the platform is equipped to notify patient that the treatment has shipped with tracking ability as shown in point 483 and claim will be adjudicated as in point 482.

Once the user receives the treatment as shown in point 484, they are directed to path 162, where they are offered to sign up for auto refill as shown in point 485. User will be sent a SMS to check if they want to sign up for auto refill as shown in point 486, and if they decline the platform ends the flow as shown in point 488.

Alternatively or in addition to the above, company may purchase or become a prescription fulfilment service itself so as to be able to coordinate prescription sending and pickup with local pharmacies or ship them directly to consumers themselves. This would give them more control over fulfilment costs, shipping speeds, pickup, and communication with patients about their prescriptions. The platform would also collect data and own such transaction data at each “touch point,” and eventually create a report for pharmaceutical sponsors which can show a variety of parameters including cost associated with fulfillment, where fulfillment fails (at initial information, telemedicine, script fulfillment, etc.) which would provide detailed feedback to all involved about how to improve the service and tell Real Chemistry which pharmacies perform better. Reports could also be issued on adherence and refill rates. Consumers could also be sent reports that show them how much money they saved and/or the positive effects they may be receiving from the medication (as per FDA prescription drug labeling). A unique aspect of this is the real-time check of all of the information, monitored by the systems equipped by the platform.

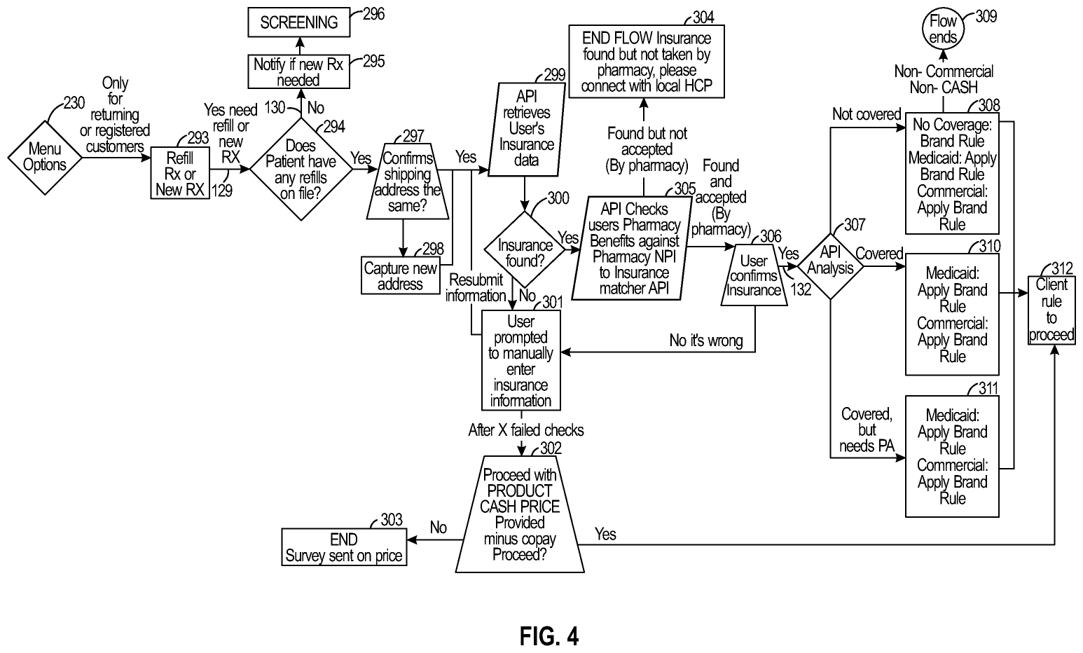

Continuing from FIG. 4, returning customers will have refill Rx or new Rx option shown in the path marked 129 once they access the main menu after point 230, so they do not have to go through the registration process all over again.

The platform then checks if the patient has any refills available on file as shown in point 294. If the user needs new Rx, they are directed to path marked 130 where they will be directed to screening questions and the registration process from scratch for a new Rx. If the user has refills on file as shown in point 297, they are asked confirm their shipping address on file. Once confirmed, they are directed to path 131. If the user needs to update their address as shown in point 298, they do before being directed to path 131. Since there is a new refill request, API retrieves user's insurance data as shown in point 299. The program proceeds to check if the insurance is still valid as shown in point 300. If the insurance is invalid, the platform asks the user to resubmit information and direct them back to path 131. If the insurance is valid, API checks users pharmacy benefits against pharmacy NPI to insurance matcher NPI as shown in point 305. If the user insurance is not accepted by the pharmacy they are directed to point 304 where the flow ends and the platform asks the user if they would like to connect with a local healthcare provider.

If the insurance is valid as seen in point 300 and accepted by the pharmacy as shown in point 305, user is asked to confirm insurance information as shown in point 306. Upon confirmation the user is directed to path 132 where API analysis commences as shown in point 307. If the prescription is not covered, brand rule is applied for Medicaid and commercial benefit in point 308. If the prescription is covered, brand rule is applied for Medicaid and commercial benefit in point 310. If the prescription is covered but needs PA, brand rule is applied for Medicaid and commercial benefit in point 311.

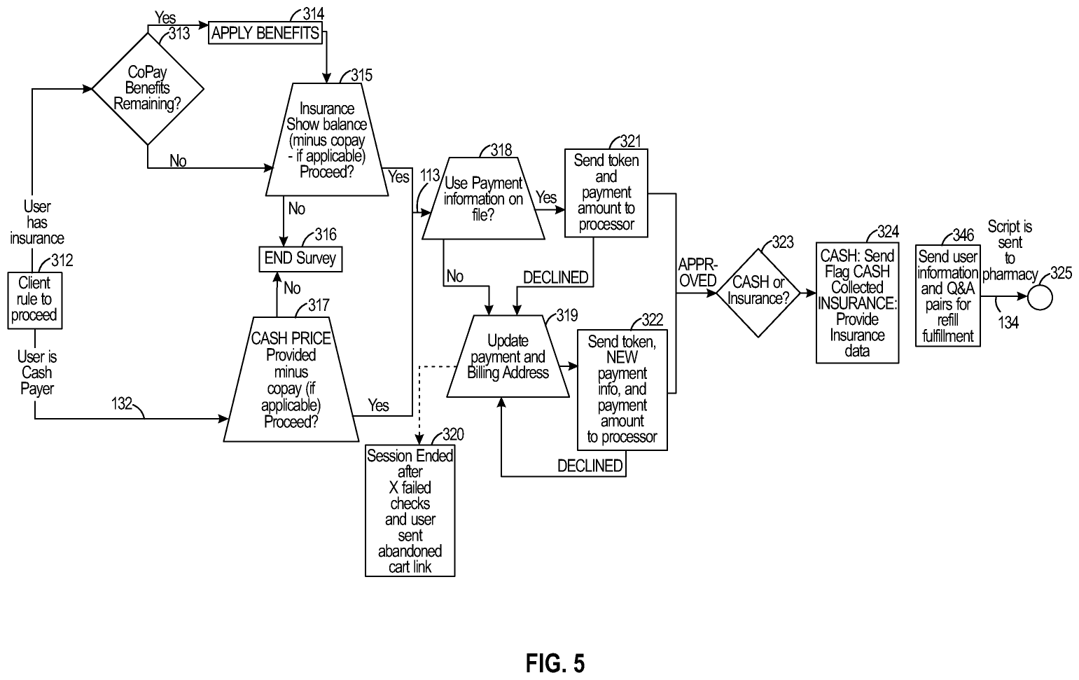

Upon API analysis, client has options as shown in point 312 in FIG. 5. If the user is cash payer, they are directed to path 132 and shown cash price of the refill Rx minus copay as shown in point 317. If they confirm they are directed to path 133 to complete payment. If they decline, the flow ends and user receives a survey focusing on the price of the drug as shown in point 316.

Upon API analysis, if the user wants to pay through insurance, the platform checks if they have any copay benefits remaining as shown in point 313. If there are benefits remaining, it is applied as shown in point 314. The platform then shows balance after applying benefits (if applicable) as shown in point 315. If they confirm they are directed to path 133 to complete payment. If they decline, the flow ends and user receives a survey focusing on the price of the drug as shown in point 316.

After reaching path 133, the platform asks the user if they want to use payment method on file as shown in point 318. If they confirm, the platform sends token and payment amount to processor as shown in point 321. If they do not want to use the payment method on file, platform asks the user to update payment and billing information as shown in point 319. If payment is not approved after 2 failed attempts, user is sent an abandoned cart link as shown in point 320.

If payment is approved, system commences a check if the payment was handled through cash payment or insurance in point 323. According to the payment method, system fulfills information communication with pharmacy in 324. User information and script are sent to pharmacy and user is contacted for refill fulfillment via one of the methods mentioned earlier as seen in point 646.

If payment is approved, user is directed to path 134 where their script is sent to the pharmacy to fulfill as shown in 325.

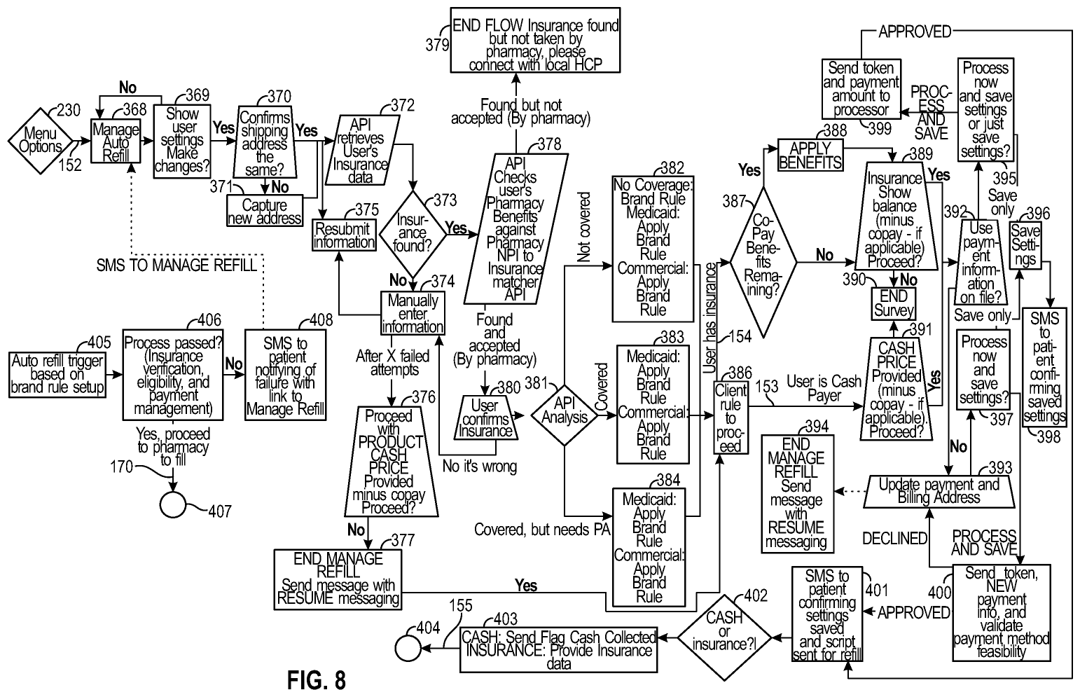

Continuing from FIG. 8, returning customers will have auto refill option shown in the path marked 1 once they access the main menu as a result of the path marked 106.

If the user chooses to fill their script at a physical pharmacy, platform could provide an e-script QR code via an app that the pharmacy partners could scan and fill without need for a paper prescription, decreasing the likelihood of forgeries. The app can store prescriptions, and the user can choose which pharmacy will receive their e-scripts.

A hard-copy prescription could be uploaded as a secure attachment and/or encrypted file, which would resemble the method that a check is uploaded for deposit in a banking application with optical character recognition and archival storage of the image. For controlled substances or other prescriptions requiring confirmation by a healthcare provider, one would enable communication with the HCP via a phone or a secured credential that would enable confirmation of the prescription and insuring its validity.

A pharmacist at the pharmacy accesses the pharmacy computer system and authenticates to the health information system software. The smart card is read and the medication is identified. Alternatively, the medication is identified from an “electronic prescription” in the form of a digitally signed e-mail. A container of the medication is procured and the bar code is scanned. The computer system identifies the medicine corresponding to the bar code and compares it to the medicine prescribed. If it is the correct medication the pharmacist dispenses the drug, and the pharmacy computer system updates the smart card to indicate that the prescription has been dispensed. The refill counter is decremented and the card is signed with the pharmacy's electronic signature.

Contemporaneously with updating the program, the pharmacy computer system sends electronic messages to the healthcare practitioner's computer system and to the central database indicating that the prescription has been fulfilled.

Another use of the program coupled with a central data base and local computer systems as described is for marketing and testing pharmaceutical drugs. Maintaining and tracking drug samples which pharmacies have provided to physicians and clinics to distribute on a trial basis is one example. Tracking these samples (for freshness and content) is burdensome to physicians, and drug manufacturers do not get important feed back on success rate, side effects, and etc. Pharmaceutical companies could issue special smart cards for sample medication, which would be converted into a prescription by a physician and given to the patient to use as an additional health care information system card.

The pharmacy would fulfill the prescription and be reimbursed for the cost of trial medications. The physicians' and pharmacy's computer systems would contain additional functionality to notify the pharmaceutical company in addition to each other when a prescription was issued and filled using one of the special smart cards. A patient enrolled in the healthcare information management system benefits in many 40 ways. Patients are enabled to take control of their healthcare records and can make them available selectively to practitioners and other providers, providing a patient with improved capabilities to obtain treatment and services from new practitioners and pharmacies and to immediately provide accurate 45 and current records to a new providers and to preserve the integrity of the patient's comprehensive health records.

The structure of the system, leads to unexpected benefits. One benefit is a closed loop method for preventing errors in dispensing prescription medications. The system provides software to aid in prescribing medications during the prescription process which can be based on the health history and other data which is available in digital form, transmission of the prescription via the smart cards reduces the chances of error in reading the prescription and allows for automatic verification that the correct medication is being dispensed by a computerized process of comparing the electronic prescription with identification scanned from the medicine bottle. Electronic confirmations are exchanged among the central database, a prescribing practitioner and the pharmacy confirming that a prescription is on the way and has indeed been fulfilled. Therefore all major points of error are automatically eliminated. The prescription then proceeds from drop-off to one or more data intake stages whereby a pharmacy obtains prescription and customer information, e.g., health insurance information. At one or more stages of processing according to prior art methods, and in particular at stages of drop-off and data intake, different types of complex problems can arise that can delay and/or interfere with or otherwise affect fulfillment of prescriptions. Prior art methods are not configured and/or implemented to discover such issues and problems associated with prescription transactions during early stages of processing, and often tend to ignore issues and problems entirely. In addition, prior art methods do not communicate the occurrence of such issues and problems to customers when such issues and problems arise during processing. In many cases, such lack of communication between pharmacy and its customers is due to little or no emphasis prior art method place on pharmacy-customer interfaces, e.g., opportunities for customer communication, such as at drop-off and pick-up service counters.

Problems associated with prescription transactions can interrupt the overall pharmacy workflow and often require pharmacy personnel to be removed from dedicated responsibilities to resolve such problems. For instance, at drop-off and data intake stages, an initial interview between a pharmacy and a customer or prescriber's/doctor's office, can fail to obtain critical information and/or can obtain incomplete information. For these reasons, first-time prescriptions are particularly vulnerable at the drop-off and data intake stages. In addition, prescriptions “called-in”, can provide inaccurate and/or incomplete information. A lack of or incomplete information can cause either a delay in or an inability to successfully process a prescription, which can result in a pharmacy not meeting customers' expectations, especially with respect to promised prescription pick-up times. Other issues and problems can occur, such as a lack of sufficient inventory and a lack of authorization to refill an existing prescription that can cause delay in or prevent successful processing of a prescription.

In addition, drop-off and data intake stages are susceptible to human error whereby pharmacy personnel manning a drop-off/data intake area, e.g., a service counter, a telephone, a fax machine, a telephone voice response system or a drive-thru window, can provide erroneous and/or incomplete information to customers. In particular, pharmacy personnel can arbitrarily assign a time within which a prescription will be filled and available for a customer to pick-up and can thereby provide the customer with an erroneous and/or over-promised time within which the prescription will be available.

Pharmacy personnel working within prior art methods typically do not have a consistent basis, guidelines, or other information for assigning a pick-up time and often estimate a pick-up time, for instance, without first checking a pharmacy's inventory of a particular drug or whether a prescription permits a refill. In addition, in other instances, pharmacy personnel can provide a customer with an estimated and/or arbitrarily assigned pick-up time before a pharmacy obtains and confirms necessary prescription and customer information and before a prescription has undergone insurance adjudication and a drug utilization review (DUR), as discussed below in further detail. Thus, a customer can drop-off a prescription and a pharmacy can quote an inaccurate pick-up time as a result of one or more problems that occur during processing.

Typically, the inaccuracy of an estimated pick-up time and/or any problems associated with processing a prescription do not become known to a pharmacy or a customer until the customer actually attempts to pick-up his/her prescription. At this point, resolution of any problems may be too late to permit the pharmacy to meet the customer's expectations with respect to pick-up time and service. In addition, any problems and efforts to resolve such problems typically cause prescription processing and workflow to become inefficient or inconsistent.

A “no refill” status must be resolved before the prescription can be further processed and filled. A number of steps are typically undertaken within prior art methods to resolve this issue including identifying the prescription to alert pharmacy personnel that a prescriber/doctor who provided the original prescription must be contacted. Thereafter, attempts are made to contact the prescriber/doctor. An initial attempt to contact the prescriber/doctor may not be successful and the prescription is identified as a “doctor call-back”, which requires periodically contacting the prescriber/doctor until a decision is obtained from the prescriber/doctor. In the event the prescriber/doctor denies the refill prescription, the prescription is identified as a “denied” prescription.

Without an established protocol and staff specifically assigned to handle “no refills”, such prescriptions can often end up languishing at the data intake stages, which can cause prescriptions to be filled late or not at all. A customer is often not aware of a “no-refill” or other status of his/her prescription before a pick-up time quoted by a pharmacy and does not learn of such a problem until he/she attempts to pick-up a fulfilled prescription from the pharmacy. Customer expectations, therefore, are not met and can result in significant customer dissatisfaction. In the event a prescriber/doctor approves the refill prescription, the prescription can then proceed to one or more stages of DUR check, insurance adjudication review and production. However, sufficient time may not be available to prepare the prescription for customer pick-up at a promised pick-up time that pharmacy personnel quoted earlier to a customer during drop-off.

In accordance with one embodiment of the present invention, pharmaceutical prescriptions may be received at a Prescription Receiving for a network of therapeutic 40 pharmacies, wherein individual therapeutic centers, i.e., therapeutic pharmacies, within the network are established based on patient stratifications and/or therapeutic conditions.

The prescription may be received by Prescription Receiving, wherein the prescription contains patient identification information, physician and prescriber information, as well as type of medication, and medication quantity and concentration, etc. Generally, the prescription may be received in electronic form, but if necessary, a hard-copy prescription may be scanned or converted to electronic form by conventional means and fed into the Prescription Receiving unit of the present invention. Prescription Receiving may resolve administrative protocols, e.g., patient enrollment and eligibility, prior to processing the prescription in the system of the present invention. Upon resolution of any administrative protocols and conversion into an electronic form, if necessary, the prescription may be fed into the system for filling and dispensing.

Bio-pattern recognition of personal user characteristics including, for example, handwriting, signatures, voice patterns and fingerprints is an attractive medium for accepting user inputs, but in the present state of development of the technology, suffers drawbacks which disfavor use of bio-pattern recognition in preferred embodiments of the invention. Future developments such as greater processing capabilities in small user-interface devices, and more accurate and efficient bio-pattern recognition techniques may change this picture and favor adoption of one or more forms of bio-pattern recognition.

Thus, handwriting recognition, is eschewed in preferred embodiments of the invention, at the present time, because writing is more tiresome to the user than pointing, pressing or clicking and adds complexity and processing overhead to the system. Additionally, handwriting recognition, although presently available in pioneer systems, adds uncertainties, may require significant user effort or adaptation and may threaten data accuracy or promote user error.

Signature recognition may be desirable, if permitted by regulatory agencies, for remote electronic authorization of fulfillment at the pharmacy especially for mail order prescription fulfillment and the pharmacy-prescriber link can, if desired, add additional levels of security by transmitting or exchanging supplemental electronic identifiers.

However, better security, in terms of ensuring that the filled prescription is released to the intended patient, or their agent, may be provided, by treating an electronic prescription transmission to a pharmacy as an advisory against which fulfillment may be initiated, while the prescription is released only in exchange for a manually signed hard (paper) copy. Signature recognition or transmission as an individual graphic element, insofar as it may be useful or required in the prescribing process, can accordingly be incorporated in systems according to the intention. Processing demands on the user's device can be minimized by confining the device's capabilities to recognition of the signatures of only those users authorized to use that particular device.

Adding higher performance hardware to support the processing needs of handwriting recognition may be impossible with available technology if a preferred light-weight, compact form factor is to be retained for the user's device. An aim of the invention is to provide a qualified prescribing professional with a valuable tool that imposes no significant burdens of weight or volume on the user, that demands little of their time and yet can respond rapidly, delivering valuable drug and patient information to the user from remotely located, disparate sources. In other words, an aim of the invention is to provide an intelligent, knowledgeable computerized prescription pad.

Some embodiments may be equipped to assign an individual artificially generated number (AGN) which is a unique person identifier that enables the organization to track a person's demographic, clinical and communication history as well as financial activity at the individual level. The individual AGN may be assigned in a background process when data is moved to the Information Warehouse. The program receives data from Patient Stratification and Clinical Scores, and analyzes the data to assign an AGN suitable for routing a prescription to a selected therapeutic pharmacy within the network of therapeutic pharmacies particularly established to provide specialized pharmaceutical care to a patient of a correlating wellness category.

The program stores and updates data from multiple sources and supports current postal addresses and e-mail addresses and telephone numbers for patients, as well as date of birth, deceased status, gender, demographic and geographic information, medical conditions, drug allergies, HIPAA privacy consent and authorizations. the program provides a data quality dashboard to help determine the integrity of the data, e.g., confirms accuracy of data, provides tracking analyses detecting potential inconsistencies in data patterns (system errors, incomplete, or irrelevant data), and improves identification and targeting opportunities. the program populates IW for decision support analyses and reporting. the program provides a wide variety of software applications with the core objective to increase data quality and content for clinical data used by DUR, Home Delivery Pharmacies, Customer Service, and Internet applications.

Patient Stratification is a unit within the system of the present inventions suitable for computer analyses of patient medical record and prescription claim information contained in the Information Warehouse to determine the potential for utilizing the method and system of the present invention, wherein the database contains sufficient information to perform analyses. If sufficient medical record and prescription claim information is available to perform a patient analysis, wherein the patient will be stratified into one or more wellness categories, e.g., well, acute, chronic, complex, etc.

Each wellness category may be further defined, for example, by the past medications prescribed to a patient, illnesses, and diseases states. Patients can be stratified into wellness categories, based upon disease states, into a plurality of wellness categories, wherein less serious diseases may be defined as well and acute, and more serious diseases may be defined as chronic and/or complex. While the disease states mentioned herein are examples of methods of classifying patients, other methods and categories will become apparent to those skilled in the art. Nevertheless, the individual therapeutic pharmacies of the network of therapeutic pharmacies of the invention will be segmented based upon the categorization utilized for patient stratification, wherein the individual pharmacies will be established to fill and dispense prescriptions for one or more categories of diseases. Patient stratification results may be available for transmittal to and storage in the program.

The server is administered by a system administrator using an administration module having an administration interface. As will be discussed in greater detail below, the administrator performs setup and ongoing maintenance of the server. As should be apparent the discussion herein, the server plays an important role in the system. However, computer systems at each of the participating parties are also important. The computer system includes a pharmacy management system. The pharmacy management system is coupled to a data base that stores information including customer address, phone number, physician, insurance provider information as well as a list of any medications currently being used by the customer and any known allergies or other medical conditions that the customer has. The pharmacy management system is a type of a fill and bill system and has the ability to interface all new and changed customer accounts, customer prescriptions, responses to customer requests, profile information, changes to the pharmacists, changes to web site content, etc. In a preferred embodiment, the pharmacy management system is designed to effectively interact with the server and the other components of the system. Alternatively, upgrades may be provided to allow existing pharmacy management software to interact with the system.

In operation, the pharmacy at which the customer is a patron registers with the server. The pharmacy contacts the administrator and an account is established. The pharmacy assists the administrator in developing a pharmacy specific web page that is accessible by customers. The web page may also be accessible from the pharmacy's own standalone web site. The pharmacy specific web page includes contact and operating information about the pharmacy and other pharmaceutical content. The pharmacy is equipped with the pharmacy management system or an upgrade to its existing management software to provide functionality equivalent to that provided by the computer system.

After the pharmacy is setup for participation in the pharmaceutical system, customers of the pharmacy register for participation in the system. As noted, each customer receives a username and a password for logging onto the web site and establishes a profile. The customer can maintain their account, request/order recommended products, order refills, check refill status, view profile information, and request information and view responses.

When customer opens the web site by connecting to the network using a browser. Next, as shown at step, Show Login Page, the login page of the web site is displayed. The customer can then choose to enter user specific content of the web site or to view general non-user content of the web site. The customer is presented an option to view content regarding the benefits of using the system. The customer is also presented an option to view the security/privacy policy for the system. The general content of the web site can include as much or as little information about prescription drugs and treatments and the pharmaceutical system as the administrator desires to provide the general public.

If the customer has registered with the system, he or she may enter his or her username and password, as shown at step. The username and password information is then validated at step. If the login is not valid, a web page is loaded that informs the customer that the data fields are invalid, as shown at step. The customer is then redirected to re-enter username and password information, as shown by path. Based on the customer's age and medical conditions that are stored in the profile, an appropriate interface is established (e.g., older customers are provided with larger lettering that is easier for them to read). This may include viewing a pharmacy specific web page that has an age appropriate font and background depending on what demographic the customer falls into (i.e., geriatric, adult, or child/young adult). The program may also provide customer interface in different languages, such as French, English, Spanish, etc., depending on the language spoken by the customer.

The customer can view various content and select several options. A page is loaded, and the customer is asked if they would like to modify any of the information currently listed in the account profile. If the customer does not wish to modify their account, the customer may move to another page, they are moved to another page. In a preferred embodiment, the web site reloads the main page. If the customer does wish to modify their account, they may make various changes. Examples of information that the customer can change include the email address they use to receive information from the pharmaceutical system and the password used to access the web site.

If the customer enters a proposed change to their account, they are asked if they would like to submit the change. If the customer does not wish to submit the change, the customer may move to other portions of the site. If the customer does submit the change, the validity of the change is checked, Validate Change. If the proposed change is invalid, an error message is generated, Show Error Message. After the error message is displayed, the customer may be redirected. If the proposed change is valid, the proposed change is saved, and the customer is informed that the change was successful with a thank you page. Once the customer has completed viewing the confirmation page, the customer is redirected.

The customer can select a refill request page. In one embodiment, only the prescriptions that are less than one year old are shown on the refill request page. The customer may be able to load the prescriptions that are older than one year old, but ideally the customer should have checkups with his or her physician where older prescriptions are evaluated and adjusted according to the progress of the prescribed regimen. The customer is allowed to select any of the prescriptions that are currently stored in the pharmaceutical system and request a refill. The customer enters a proposed date to pick up the refill from the pharmacy. If a prescription has expired (either by date or by number of refills) and the customer would like to continue receiving the prescription drug, the customer's physician is contacted for authorization. The physician can be contacted using fax, phone, or by contacting the representative computer system at the physician's office. If the customer would like an expired prescription renewed, this fact is indicated on the refill request. Once the customer has selected the prescriptions, they would like refilled and entered information in all of the required fields, a determination is made whether or not the request is valid. If the request is not valid, an error message is displayed, as shown at step

An example of an invalid request is a pickup date that is past a future expiration date of the selected prescription After the error message is displayed, the customer is redirected to step. If the request is valid, the request is saved in the database server. The customer's physician is contacted for authorization to continue the expired prescription. A web page is loaded that shows the customer what refills are refillable and on what date they will be ready for pickup, and what refills are waiting for approval from the physician.

Once the customer has finished reviewing the show refill request confirmation page, the customer can return to the main page for further action by the customer. All information regarding refills requested is sent to the respective pharmacy management system so the pharmacist can prepare the refill according to the customer's request.

The customer can select a status page that displays refills ordered. In one embodiment, only the refill requests that are less than one month old are shown. The customer may be able to load the refills that are older than one month old, but ideally the customer should pick up refills in a timely manner after requesting such refills. The information displayed on the status page is similar to the information provided. The information displayed allows the customer to check whether or not their physician authorized refills that required physician approval. If the physician authorizes the refill, the customer can pick up the refill on the date indicated on the refill status page.

If the physician does not authorize the refill the customer is informed of the denial through the status page and may contact the physician regarding the denial. The pharmaceutical system can automatically, or upon request by the customer, send reminders to the physician if no response is received within a set amount of time. Once the customer has finished reviewing the refill status page, the customer can return to the main page. All information regarding refills requested and later verified is sent to the respective pharmacy management system so the pharmacist can prepare the refill according to the customer's request.

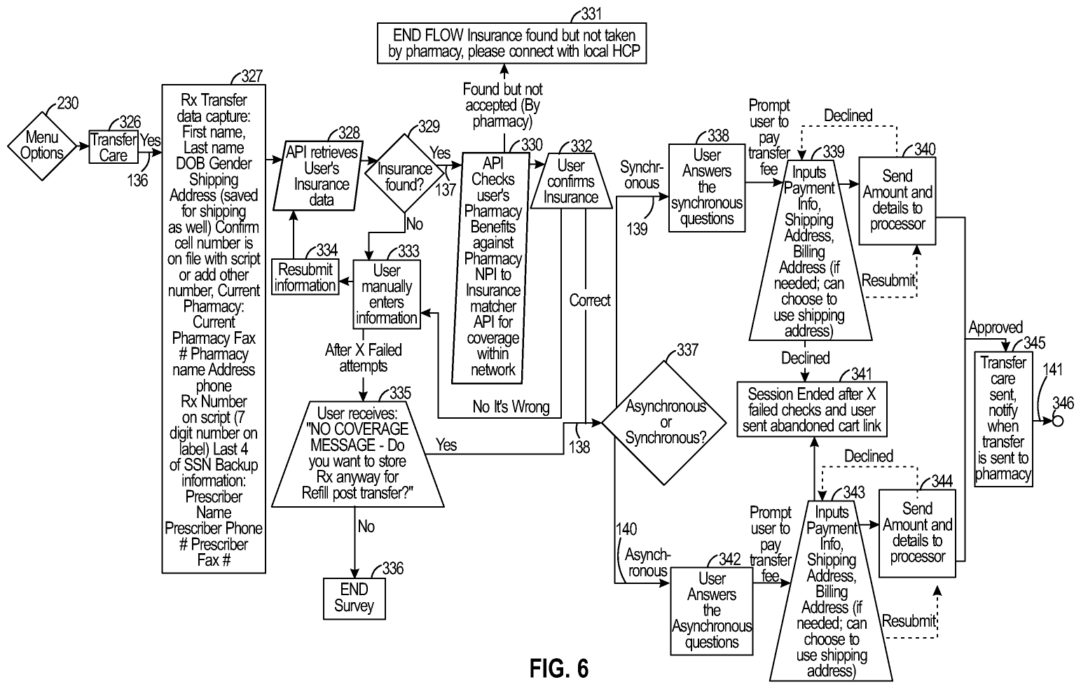

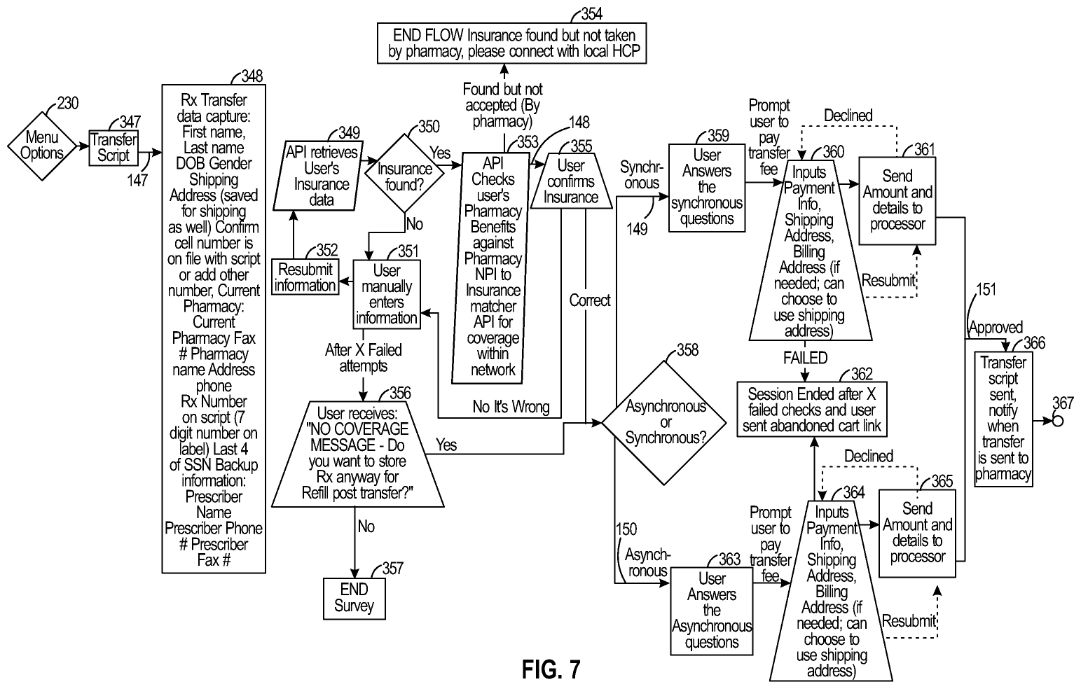

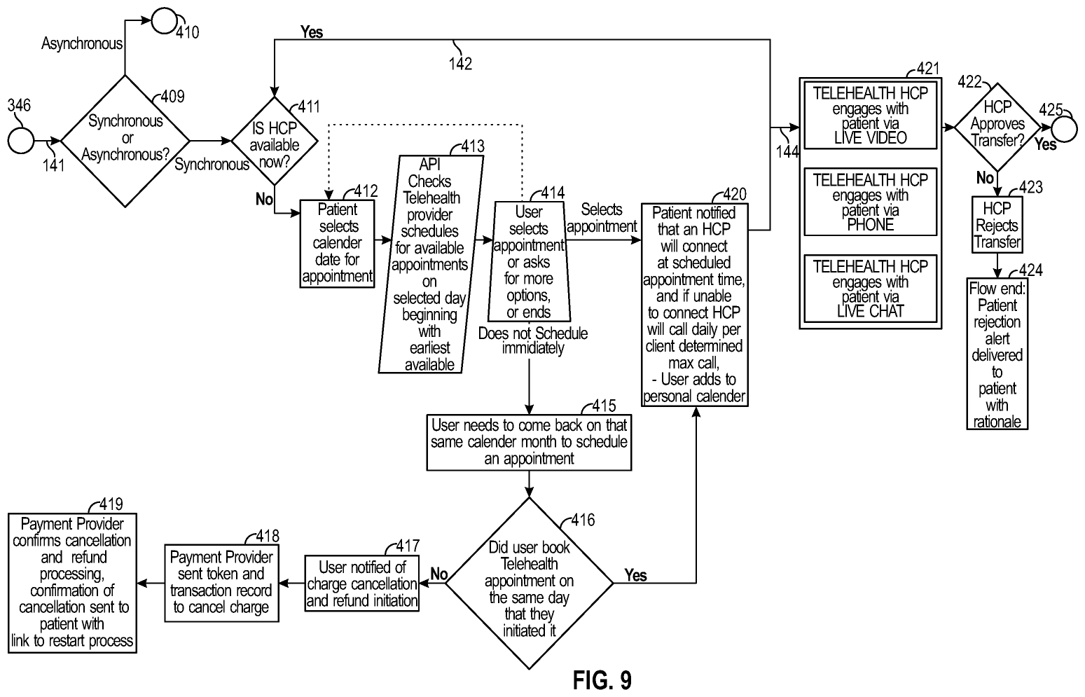

Turning now to FIG. 9, a flowchart that is a continuation of FIG. 6 describing the process of scheduling an appointment with a healthcare provider to transfer care from one healthcare provider to another is shown. The chart starts with the path marked 141 from the point 346, which has been reached once the transfer information has been approved and sent to the pharmacy. Continuing to point 409, the system decides whether the telemedicine will be synchronous or asynchronous. If the system decides that the telemedicine will be asynchronous, the process continues to point 410, which is connected to the same point in FIG. 12. If the system decides that the telemedicine will be synchronous, the system then determines whether a healthcare provider is available for an immediate appointment, shown in point 411. If the system determines that a healthcare provider is available for an immediate appointment, the process continues to point 421 through the path marked 142. If the system determines that a healthcare provider is not available for an immediate appointment, the process continues through the path marked 143 to point 412, where the patient may select a calendar date for a telehealth appointment. The date information is sent to point 413 where the API checks the schedules of the telehealth providers for the earliest available appointments. The user is then presented with the choice of either selecting the earliest available appointment, checking for more date options, or ending the scheduling process to continue at a later time, shown in point 414. If the user decides to check for more options, they are redirected back to point 412 to select another appointment date. If the user selects the presented appointment, they may continue to point 420. If the user decides not to schedule an appointment immediately and ends the process, they move to point 415, where it is shown that the user is required to come back to the scheduling process that same day in order to be able to schedule an appointment. The system then implements a timer that ends at the end of the day and the user may be notified of this fact.

Moving to point 415, the system then checks whether the user has booked a telehealth appointment that day. If they have booked an appointment, the user proceeds to point 420. However, if the timer has been reached and the user has not booked an appointment yet, the system moves to points 417 where the user is notified of the charge cancellation. In point 418, the payment provider is sent a payment token and transaction record in order to cancel the charge. This allows the system to move to point 419, where the payment provider confirms the charge cancellation and confirmation of the charge cancellation is sent to the user along with a link to restart the process. Moving back to point 420, once an appointment has been scheduled, the user is notified that a healthcare provider will connect with the user at the scheduled appointment time. If the connection is unable to be made, the provider will call the user daily until the specified maximum number of calls has been reached. If the connection is successful, the system can move through path 144 to point 421, where the telehealth provider engages with the patient via live video, phone, or live chat. Once the conversation has ended, the system will ask the healthcare provider whether they approve the transfer. If the provider approves the transfer, the system can move to point 425, continued in FIG. 12. If the provider does not approve the transfer, the system moves to point 423, where the healthcare provider explicitly rejects the care transfer. Moving to point 424, the user is notified of the transfer rejection and the rationale given for the rejection by the healthcare provider is delivered to the user for review.

The embodiment of the invention primarily relates to communication of customer/pharmacy data. Generally, the customer interacts with the pharmacist at the retail pharmacy to a greater extent than he or she interacts with the other parties. However, the pharmaceutical system can be configured to allow the customer to request information and view the responses with respect to other types of communication (i.e., customer/physician, customer/drug manufacturer, customer/fiscally responsible party, customer/governmental agency, etc.). The customer can request information and view responses from their pharmacist. A web page is loaded that allows the customer to request new information, view a response to past information requests, or delete old responses that are no longer needed.

The customer can delete responses. In one embodiment, the Communicate With Pharmacist Page is similar to an email system that includes a listing of all old, new, and outgoing messages. The customer may organize the responses stored in their account by eliminating old responses. Once the deletion and organization is completed, the customer may return to the page where they can communicate with a pharmacist.

The customer can select a response from the pharmacist to view. The response may be a new response that has not yet been viewed or an old response that has already been viewed. After the response is selected, the chosen response is displayed. Once the selected response is viewed, the customer can return to the communicate with pharmacist page.

The customer can request information from the pharmacist. This information may include information about a particular drug the customer discovered to be an alternative to his current prescription, information about a side effect the customer is experiencing, or other information. A page allows the customer to input the information they would like to request from the pharmacist. The customer enters a subject of the information requested, chooses the pharmacist they would like to answer their question (if a particular pharmacist is desired), and writes the message requesting information. The customer determines whether to submit the request. If the customer does not submit the request, the customer moves to another page. In a preferred embodiment, the web site reloads the main page of the site. If the customer submits the request, the request is validated. If the request is invalid, an error message is generated. If the request is valid, the request is saved in the database server. The customer is informed that the request was successfully saved. Once the customer has completed viewing the confirmation page, the customer is redirected and the account page is redisplayed. All requests for information are sent to the respective pharmacy so the pharmacist can prepare a response to the request for information.

The customer can view all conditions and allergies currently listed in their profile. In an alternative embodiment, the system may display all conditions and allergies currently listed in the system. This allows the customer to research conditions and allergies that they may have (based on symptoms they are experiencing), but have not yet been diagnosed. The customer then selects a specific diagnosis or allergy. Once the specific diagnosis or allergy is selected, available treatments are displayed. The customer then selects a specific prescription and once the customer has selected a specific prescription, a web page is loaded that displays information including directions, warnings, and common uses for the chosen prescription.

The customer can view all prescription listings currently in their profile. In one embodiment, only the prescriptions issued in the past one year are displayed. In an alternative embodiment, the system may display all current prescription listings in the system for the customer. This allows the customer to research prescriptions they learn about through various communication avenues, and thus determine if they would be effective in treating conditions and/or allergies they currently are experiencing.

The prescription management system shown in this embodiment of the invention has been designed for implementation on physically compact, portable, user-interface devices such as small portable personal computers, especially hand-held devices known as personal digital assistants. Those skilled in the art will understand that the system can readily be used on or adapted to other hardware platforms, for example, a physician's desktop computer and can be expressed in different software interfaces from that shown, especially ones that use different input devices such as keyboards, touch pads or touch screens and the like.

Pursuant to certain user-adaptive aspects of this invention, the screens automatically personalize themselves, with use, to adopt the patterns and habits of a regular user of a particular device platform for the system, offering the user their most frequently used information, drugs, conditions, patients or patient groups, and so on as first line choices. This adaptive characteristic is a valuable benefit endearing the system to experienced users who may become impatient with hierarchically accessed data.

The data lists, categories, groups, addresses or routes, can be organized in multiple hierarchies for rapid and flexible access to multiple large, remote databases, via multiple access routes to retrieve multiple related data elements and assemble them into a single data file, for example, a patient history file compiled from the data resources of a patient's historical health providers.

A desirable goal is to provide the physician-user with intelligent data lists that are, where possible, exhaustive and list, for example, all prescriptible drugs, all conditions, all formularies or all patients and present the physician with helpful first-line choices or defaults selected intelligently on the basis of historical data known to the system. Preferably, the selection means is fully system embodied, or automatic, operating transparently to the user and requiring a minimum of configurational or setup operations by the user.

An ability to compile what may be termed a “virtual” patient record from multiple remote databases of primary source information is a valuable novel feature of preferred aspects of this invention. Such a virtual patient record can be created in a chronologically current version by online interrogation of all possible primary sources of electronically recorded patient history elements, by retrieving those elements and assembling them into a complete record. Yet the record need neither be drawn from, nor committed to, permanent storage, obviating storage requirements for accumulations of patient records.

The record can be assembled dynamically, on an as-needed basis, consulted by an authorized system user, and then dissolved, without ever having been saved, giving the record a virtual character.

Record element retrieval and record assembly are conducted under the auspices of the host computer facility employing a novel patient data directory service providing routing information to each patient's record elements. For each patient, the patient data directory service lists all institutions, including independent physicians, hospitals, HMO's, insurance companies, and so on, known to have source historical records on that patient, against a unique patient identifier, such as described hereinbelow. Also listed are routing or address data enabling the host facility to access institutional databases to retrieve record elements. Access protocols detailing, for example, what data can be accessed, when it may be accessed, by whom or by what organization or department it may be accessed, can be kept in a patient-specified directory, or elsewhere.

Patients not listed in the directory service can be searched at the remote source databases and, optionally, at other, host computer facilities supporting the inventive system for other groups of users.

The complete, assembled patient history, or record, need never be stored, unless the patient requests or consents to such storage, and it serves some useful administrative or care-related function. Storage or archiving of a record that is potentially updatable from multiple uncoordinated locations has the drawback of dating it. To become current, the record must be refreshed from any database containing a new data element for that patient.

The current invention not only provides physician the fresh opportunity to issue electronic prescriptions, but also allows patients to make prescription prompt for approval by their physicians. Continue with the above example, assuming both patient A and his physician are registered members of pharmacy ZZ. Patient A enters the online pharmacy network ZZ and requests a prescription purchase for medication, patient will supply with pharmacy ZZ with his physician's email address so that patient A's request for approval will be sent to his physician. His physician then schedules an appointment for patient A if he sees necessary, or the physician can simply respond to the request based on his knowledge about patient A's medical history if medication is a regular medication for patient A. After seeing patient A or coming to determination that such medication is needed even without an appointment, the physician will enter the pharmacy ZZ's network to give an electronic approval for the prescription. Pharmacy ZZ, after receiving confirmation from the physician, will notify patient A that his request is approved and is ready for redemption. Patient A will use this approved electronic prescription to purchase medication over pharmacy ZZ. Using the current invention, physicians, in their discretion, can issue patients (on regular medications) electronic prescriptions even without in-person visits.

The beauty of the current invention can be further demonstrated during time when physicians are not on duty. For example, patient A regularly uses medication to ease his slight asthmatic condition during fluctuating whether temperatures. During the evening hours when his physician is not present, the only way for patient A to obtain medication is through a visit to the emergency room, which is totally unnecessary and time consuming. With the present invention, patient A can communicate with his physician even after working hours though emails. At his discretion, physician can issue an electronic prescription at a 24-hour local pharmacy OO's online network, and patient A can redeem the prescription for immediate purchase of medication to ease his symptoms, a process which could not possibly be accomplished without the current invention.

Besides the advantages described above, the present invention shines in its ability to reduce potential prescription abuses. Currently, prescription pads can be purchased over the Internet with no verification procedures in place. Pharmacies, at the time accepting the paper prescriptions, do not check the validity of the prescriptions either due to the impracticality and unfeasibility of pharmacist-to-physician verification for each and every prescription order. In essence, anyone could possibly order prescription pads online with an actual doctor's identity. While many methods are being introduced for fancier and more secure prescription pads, the reality is that most physicians remain loyal to their old prescription pads in order to maintain low cost operations. The current invention provides a realistic means to achieve the objective of reducing prescription abuse by eliminating the need for physical prescriptions and bridging communications between physicians and pharmacists by utilizing a direct network. Using the current invention, prescription abuse can be effectively suppressed since the only way for anyone to obtain prescription is to have a physician issuing an electronic prescription that will be delivered directly and untainted by the system controller to the pharmacy, and the only one who can redeem the prescription at the pharmacy is the actual patient since the system controller keeps track of every prescription issued and the patient it was issued over its network.

With the rising prescription costs, many people are looking for pharmacies with the most competitive pricing. However, given the time and the complexity one must devote to redeem prescriptions online today, competitive pricing offered by many online pharmacies are overpowered by the need for convenience and simplicity that are the traits of local pharmacies. Hence, the tradeoff between costs and convenience are vividly evident in the pharmacy industry. With the current invention, patients will surpass the usual substitution between costs and convenience. Because the current invention is designed to modernize prescription issuing and redemption process, patients benefiting from this invention could enjoy both low cost medications online and have their online medication processed most efficiently ever. The current invention will produce and accelerate competitiveness in the pharmacy industry. When online pharmacies benefit from the current invention, local pharmacies will be compelled to implement changes such as lower prices on prescription pharmaceuticals in order to stay competitive in a fast paced environment.

Every day, thousands of Americans crosses borders into Mexico and Canada for cheap medications, but many border pharmacies lack the reputation and safety measures for their in stock medications. The challenge is how to enhance safety measures for patients crossing borders so that their lives are well protected. So far, there is no regulation in place or agreements between U.S. and foreign governments to properly regulate the pharmacies along the U.S. borders, nor is there any control over the quality or safety of the pharmaceuticals produced and sold along the borders. The essential problem is that the American government has literally no control over foreign pharmaceutical sellers. However, the government could pass effective legislations to ensure patient's safety over U.S. based pharmaceutical distributors.

Furthermore, direct government intervention was mostly costly and unproductive. With the current invention, electronic prescriptions are issued by verified physicians and processed at an unprecedented speed. Hence, instead of crossing borders, patients can order discounted medications with U.S. based pharmaceutical importing companies without delay. If the legislative body can precisely patrol and deploy penalties for importing companies that failed in the aspect of ensuring patient safety, these pharmaceutical importing companies themselves will exercise caution and diligence over the medications sold over its network in order to avoid penalties. Hence, another key application of the current invention is to promote purchasing of pharmaceuticals in domestic land to ensure an adequate level of safety precautions.

In summary, the present platform reduces the likelihood of prescription abuse, improves operational efficiency for pharmacies, elevates convenience level while reducing costs for patients, accelerates competitiveness in the pharmacy industry, enhances safety measures for patients, and simultaneously provides a viable approach for regulating pharmaceutical importing distributors instead of foreign distributors.

It should be understood that while various embodiments of the invention have been described, those skilled in art could make various changes in form, detail, and design without departing from the principle, spirit, and scope of the invention described herein. Applicant's invention is limited only by the scope of the appended claims.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

In some embodiments, the prescription related data can be collected by a medical services facility, such as a pharmacy or doctor's office, when a patient submits a prescription for fulfillment. In certain embodiments, prescription related data collected by the medical services facility can be subsequently entered into and collected by the prescription management system. In other embodiments, prescription related information can also include other types of information and/or be obtained via other methods. For example, various types of prescription related data can include information about various medications obtained from a drug information database and/or historical patient information obtained from an insurance database.

The fulfillment process can further include contacting at least one patient, authenticating the identity of the at least one patient and providing information to the at least one patient about fulfillment of the patient's one or more prescriptions. For example, in certain embodiments providing information to the patient(s) can include providing information about a time to refill one or more prescriptions, a delay in filling one or more prescriptions, a recall of one or more prescriptions, a generic substitution of one or more prescriptions, a generic substitution option regarding one or more prescriptions, the status of the fulfillment of one or more prescriptions, and/or a notice regarding a last refill on one or more prescriptions. In other embodiments, providing information can include an offer to enroll patient(s) in an automatic refill program that automatically refills the patient(s) one or more prescriptions when the patient(s) is expected to run out of medication. In other embodiments, providing information can include providing notice that a filled prescription is ready for pickup, or that the filled prescription will be ready for pickup during a selected period of time. Additionally, in certain embodiments providing information can include providing a patient with the option to have a filled prescription delivered.

In some embodiments, the fulfillment process can include providing the patient(s) with one or more response options regarding the fulfillment of one or more prescriptions and receiving an input indicating a selection of at least one of the one or more response options. In still other embodiments, the fulfillment process 200 can include performing an action based on the input received. For example, in certain embodiments the input indicating a selection of one or more response options can be reported or sent to a pharmacy, pharmacist, pharmacy staff member, and/or other medical service provider (e.g., a doctor, doctor's office, or doctor's staff). In still other embodiments, the input indicating a selection of one or more response options can be stored for future use (e.g., to send a reminder to a pharmacist or pharmacy staff member that it is time to refill a prescription based on an automatic refill selection). In various embodiments, some, all, or none of the process portions discussed above can be performed in a computing environment.

In some embodiments, the main message can “thank” the patient for placing a new prescription order with the pharmacy, offer the patient the option to enroll in the automatic refill service, and provide options regarding care support services and/or patient opinion information (both discussed below in further detail). For example, in certain embodiments the main message can offer the patient the option to enroll in the automatic refill service along with the option to be immediately connected with a pharmacist for a consultation regarding the prescription and/or the option to complete a survey related to the prescription. The survey can query the patient for information related to the prescription.

In some embodiments, the informational message to can include other types of information. For example, the informational message can include notification that it is time to fill a prescription, that fulfillment of a prescription has been delayed, a status of a prescription (e.g., information that the pharmacy has contacted the patient's physician about a generic substitution but the physician has not yet responded), a separate independent notice that there are no refills available on a selected prescription (e.g., because the authorized number of refills has been reached and/or a selected time period has expired), and/or information regarding the potential substitution of various generic drugs.

As discussed above, the prescription management system can include a computing system and some, all, or none of the prescription management process can be performed in a computing environment. Those skilled in the art will understand that in other embodiments other methods of interfacing with the patient can be used. For example, in other embodiments the prescription management system can use voice recognition, email, fax, websites, and/or instant messaging to interface with patients.

The process can further include providing information that requests patient opinion information or data associated with a prescription medication from the at least one patient. For example, in certain embodiments requesting patient opinion information can include a request for feedback about a pharmacy, a service provided by a pharmacy, a medical service related to one or more prescriptions, and/or a patient's decision to have a prescription filled or not filled. In various embodiments, the request for patient opinion information can include one or more response options presented to the patient.

The process can also include receiving the patient opinion information from the at least one of the patient. For example, receiving the patient opinion information can include receiving an input indicating a selection of one or more response options presented to the patient. The process can further include processing the patient opinion information. For example, the patient opinion information received from one or more patients can be summarized and/or analyzed to provide a more meaningful format or output. In one embodiment, the reasons that patients do not have prescriptions refilled at a selected pharmacy can be tabulated to show the various reasons and the number of patients corresponding to each reason. In still other embodiments, the process can include providing an output based on the patient opinion information. For example, the various patient inputs and/or the processed data based on patient input can be provided to a corresponding pharmacy that has filled a related prescription.

As discussed above, the prescription management system can include a computing system and some, all, or none of the information collection process discussed above. Those skilled in the art will understand that in other embodiments other methods of interfacing with the patient can be used. For example, in other embodiments the prescription management system can use voice recognition, email, fax, websites, and/or instant messaging to interface with patients.

Each patient can be associated with one or more prescriptions and prescription related data can include at least one of the patient's identification and one or more drug names associated with the one or more prescriptions. The process can further include authenticating an identity of at least one patient. In certain embodiments, the process of collecting prescription related data, the process of contacting at least one patient, and the process of the authenticating an identity of the at least one patient can be similar to the corresponding processes. (e.g., concerns about drug side effects, concerns about prescription costs, and/or concerns about the relationship of the drug to a specific illness). Based on the patient's response to the survey, the pharmacist can call the patient to discuss specific issues.

This feature can be especially useful for serving new therapy patients. Additionally, if the patient declines to have the prescription automatically refilled, the patient can be provided additional survey questions regarding the reasons for declining this option. In yet other embodiments, the prescription management system can provide still other information. The spoke pharmacy technician may receive the shipping tote and scan in all medications from the master shipping manifest. The spoke pharmacist may enter their signature of receipt into the spoke pharmacy system. This scan may release the prescription for customer pick up from the spoke pharmacy's system and send an electronic receipt back to the hub pharmacy.

The spoke pharmacy technician may place finished packages in a designated “will call” area. A spoke pharmacy AYR (automated voice response) may call the patient to inform them that their medications are available for pick up. Alternatively, the spoke pharmacy and patient may arrange for delivery of the customized prescription packaging. The patient may arrive at the pharmacy to pick up their customized package of medications and the spoke pharmacist may discuss the medications, show the patient how their medications are packaged, how to open the containers, and discuss the information available via the associated bar code or other databases, websites, sources. The spoke pharmacist may also perform an MTM/CMR, including explaining and discussing the importance of medication adherence and how it is supported and enabled by the MMAA customized packaging. At the time the medications are dispensed, the spoke pharmacist may collect payment of the monthly MMAA fee and co-pays from the patient. Payment may also be made before the customized medication package is prepared.

The spoke pharmacy, central fill facility or call center may confirm the patient's next multiple prescription order via automated phone call or an on-line reminder tool. The spoke pharmacy AYR may ask the patient if they have any new prescriptions or changes to the existing medications and if so the call may be routed to the spoke pharmacy, the healthcare provider, the hub pharmacy as needed to discuss the changes in prescriptions. The spoke pharmacist may review any new prescriptions or changes and may consult with the prescribing physician as necessary to determine when to initiate the new routine (synchronizing the new or changed prescription). Any changes may be sent to the hub pharmacy for the next fill cycle.

### Sample Management and Distribution

Sampling has been challenging due to traditional distribution from doctors' offices. With a virtual or telemedicine solution, the care provider can give information about samples and these samples can be mailed to the patient, couriered or dispensed using a computerized lock-box or other technological containment with biometric and/or individual code use. Real Chemistry could keep a database of samples and promotional coupons, which it would make available to participating telehealth providers. This database would effectively be a virtual sample cabinet, complete with which medications are used for which conditions, side effects, drug interaction information, and what coupons are available. If a pharmaceutical company has partnered with Real Chemistry, this could include exclusive coupons.

Throughout a series of stages through which a drug passes during its lifetime, starting with its launch, continuing with its maturation in the marketplace, and concluding with the end of its patent life cycle, a brand manager is assigned by the pharma to manage the drug sample distribution to prescribers. The brand manager begins a drug sample distribution program by first identifying a group of prescriptible brands based on brand rules. The brand manager selects these prescribers by excluding or including each prescriber based on criteria defined by the brand manager (e.g., medical practice specialty, therapeutic class to which drug samples belong, prescribing volume and behavior). Prescribers can also be selected via their Drug Enforcement Agency (DEA) number or individually by the brand manager. The DEA number is a unique global identifier that identifies a particular prescriber who prescribes drugs in the United States.

After the brand manager has selected a group of prescribers, the brand manager produces a set of brand rules which define the availability of drug samples to each of the prescribers. The set of brand rules may cause one prescriber's drug sample availability and characteristics to be different from those of another prescriber. Thus, for each prescriber there is a virtual drug sample cabinet tailored specifically for that prescriber. Preferably, the group of prescribers is divided into segments. The brand rules provide personalization and customization for each segment. Many other personalization capabilities to tailor the distribution of drug samples to prescribers are possible, such as various delivery methods; various drug strengths; trademark and local presentation of drug samples; customized drug disclaimers; specific product, package, and brand Web sites; and facilitating the scheduling of prescriber interactions with sales representatives or medical science liaisons.

The set of brand rules are used to focus the drug sample fulfillment platform to distribute drug samples to prescribers. The drug sample fulfillment platform is preferably a Web-based platform that enables registered health care professionals, pharma sales representatives, and other authorized users to order drug samples and obtain related drug information via the Internet. The drug sample fulfillment platform is also preferably electronically linked to one or more prescriber-oriented online portals (such as Web MD), an e-Detailing service (such as Lathian's MyDrugRep.com), or to a prescriber's practice management software running on a computer system in the prescriber's office.

The drug sample fulfillment platform is tailored based on the brand rules established by the brand manager for each drug and prescriber segment. Using the drug sample fulfillment platform, the brand manager can select which prescribers are authorized to use the drug sample fulfillment platform and the services provided thereon, the forms of drug samples they can access, and the drug sample quantity and delivery method. The drug sample fulfillment platform can be configured to allow a prescriber to request a physical sample drop shipment. Requests for such physical samples are electronically communicated (including facsimile communications) to the brand manager's designated fulfillment vendors that pick, pack, and ship physical samples to the requesting prescriber's office. Using this method, prescribers no longer need to rely on sales representatives to deliver physical samples. As an alternative to physical samples, the prescribers use the drug sample fulfillment platform to obtain pre-printed vouchers. These vouchers, when accompanied by a prescription, can be redeemed at a pharmacy by patients for free trial medication. The drug sample fulfillment platform can be configured to allow prescribers to request a drop shipment of pre-printed drug vouchers. If the brand rules allow, prescribers may print on demand coupons from the drug sample fulfillment platform. These on-line, on-demand print coupons are printed real-time in the prescriber's office. The prescriber signs the printed coupon as a prescription or attaches the voucher to a prescription for the patients to redeem at the pharmacy to obtain free drug sample medication.

They ensure that the drug samples distributed to patients are fresh, with their efficacy not diminished by expiration. This system is a networked computing environment that has pieces of hardware and software applications. The prescriber, the sales representative, and the patient interact with the resources of the networked computing environment via personal computers (not shown). A number of Web browsers run on personal computers. These Web browsers are software that let the prescriber, the sales representative, and the patient view HTML documents and access files and software related to those documents on the drug sample fulfillment platform. Web browsers include a number of tools for navigation. These buttons are positions on navigation bars allowing easy access to Web pages by the prescriber, the sales representative, and the patient.

The prescriber, depending on the brand rules specified by the brand manager, can access a combination of three sample forms including physical samples, preprinted vouchers, and print coupons. The physical samples are drug samples that are pre-packaged by the pharma and shipped by a single brand manager-designated fulfillment vendor. The prescriber can also order pre-printed vouchers, which are pre-printed pads of coupons. These coupons are picked, packed, and shipped to the prescriber via the fulfillment vendors (which may or may not be the same vendor which distributes physical samples). The print coupons are those coupons that prescriber prints in his office. The prescriber can then sign the coupon and give the signed coupon to the patient. To obtain either physical samples or pre-printed vouchers, the prescriber prints an order form from the drug sample Web site via the request database, signs the order form, and faxes it to one or more fulfillment vendors

The pharma can specify a fulfillment vendor (whose fax number is printed on the order form) to which the prescriber faxes the signed order form to obtain physical samples and/or of pre-printed vouchers as applicable. The order form is first presented electronically to the prescriber for the prescriber to specify different drug samples that he is interested in. The order form is also personalized to a particular prescriber and a particular fulfillment vendor in accordance with brand rules. The drug sample fulfillment platform is designed to work with any contracted prescriber-oriented Web portal which the prescriber may use and any fulfillment vendor that the pharma wishes to work with via an application specific messaging protocol. The prescriber may order drug samples that may have to be fulfilled by two fulfillment vendors. The drug sample Web site manages such a situation by printing one order form to be faxed to a particular fulfillment vendor and another order form to be faxed to a second fulfillment vendor. The drug sample fulfillment platform removes the complexity of ordering drug samples for the prescriber while reducing or eliminating mistakes (e.g., errors due to unreadable handwriting). Even if the signed order form is somehow misplaced or lost, the prescriber can print it out again (via the history reprint function) from the drug sample Web site and fax the signed order form to the fulfillment vendors to obtain the desired drug samples. Upon receiving physical samples, pre-printed vouchers, or print coupons, the prescriber can provide a combination of those sample forms to the patient to redeem for free medications at the pharmacy. When the patient comes to the pharmacy to redeem sample forms for drug samples, the pharmacy forwards the claim to a claims processor. The claims processor decides whether to approve the claim. If the claim is approved, the pharmacy provides the desired drug samples to the patient free of charge.

The request database stores for each prescriber identification and the quantity of drug samples that were ordered. The drugs and quantity ordered is compared with the allocation limits for a particular prescriber. This can be presented to the prescriber via the drug sample Web site so that the prescriber knows how many more drug samples the prescriber can order. These pieces of information, among others, are stored by the request database The information in the database can be correlated when the patient takes a pre-printed voucher or a print coupon and redeems it at the pharmacy. These pieces of information can be analyzed and explained to the pharma via one or more reports. For example, suppose a print coupon was redeemed on a particular date by the patient. The reports can indicate when the coupon was redeemed by the patient. Moreover, the reports can show whether there is a correlation between a drug sample fulfillment distribution program as specified by the brand rules and the prescribing trend of the prescriber.

### Script Updates

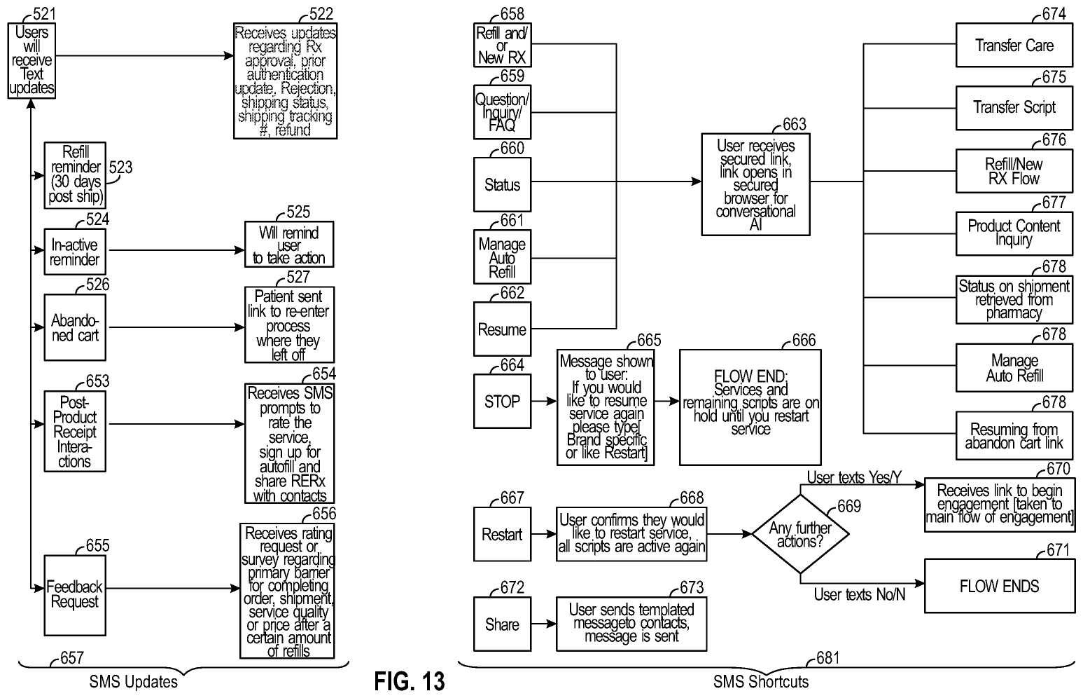

FIG. 13 is a flowchart that is a continuation of FIG. 12 and is for script updates to be sent to the client. The user can choose to receive either text or email updates. If the user chooses to receive text updates, the user receives updates regarding prescription approval, prior authorization, rejection, shipping status in the case of home delivery, and shipping tracking number. They can also receive refill reminders and inactive reminders which remind the user to take action. If the user requests for the texts to stop, if they have remaining scripts they are given the option to choose to send scripts to the pharmacy before canceling. If they say no, contact ends and they receive a message thanking them and that they won't receive anymore. They can also receive abandoned cart text updates, where they are sent a link to re-enter the process where they left off. Alternatively, there may be a mobile app where the customer can request refills through the program and this app could send push notifications on their cell phone.

Turning now to FIG. 13, a flowchart describing the text communication with the users to provide updates after registration is shown. Referring to point 521, users can receive text updates, which can contain the information in point 522, such as prescription approval, prior authorization updates, rejection, shipping status of prescriptions, and the shipping tracking numbers of the prescription shipments. Referring to point 523, the user may receive automatic refill reminders at designated refill times, such as a common 30 day recurrence. Referring to point 524, it is possible that the user becomes inactive in the middle of their use of the healthcare management system. If that is so, the user can be texted a reminder to take action, shown in point 252. Referring to point 526, if the user abandons their cart at any time during their active use of the purchasing system, the process continues to point 527 where the patient may be sent a secure link via text so that they may continue their use of the purchasing system where they left off. If the user completes their transaction as seen in point 655, the user may receive SMS prompt to rate the service they received and be offered the option to sign up for autofill and share the platform with their contacts as seen in point 654. Once the user becomes a regular user of the system as seen in point 655, they may receive a request to provide feedback as shown in 656. The feedback request may entail rating or surveying regarding primary barrier for completing order, shipment, service quality or price after a certain number of refills.

If the user chooses to receive email updates, they will receive updates regarding prescription approval, prior authorization, rejection, shipping status in the case of home delivery, and shipping tracking number. They can also receive refill reminders and inactive reminders which remind the user to take action. They can also receive abandoned cart text updates, where they are sent a link to re-enter the process where they left off If they request for emails to stop, they are sent a link where they are asked if they would like to have remaining scripts sent to the pharmacy before canceling. If they say no, communication ends and they receive a note thanking them and that they will not receive anymore. If they say they want their prescriptions sent to the pharmacy, they then are prompted to choose the location of the pharmacy and the last prescription will be sent and they will no longer receive updates.

The platform may offer the users to be completely in charge of the notifications they receive, as mentioned above. The platform may also offer the users to be able to manage their process by shortcut SMS commands. An extensive list of shortcut commands available are shown in FIG. 13 module 681. To briefly discuss the commands available to users; Refill or new Rx as seen in point 658, Question, Inquiry, FAQ as seen in point 659, Status as seen in point 660, Manage Auto Refill in point 661, Resume in 662 commands will take the user to point 663 where they are directed to a secure link to engage with conversational AI agent. From that point, the system may direct the user to the request they initially prompted the system via SMS. These options include; Transfer Care in point 674, Transfer Script in point 675, Refill/New Rx Flow in 676, Product Content Inquiry in point 677, Status on Shipment (retrieved from pharmacy) in point 678, Manage Auto Refill in point 670 and Resuming from abandon cart link in point 680. The information that the platform delivers to the user upon SMS request may be delivered in different formats. The options presented above can be delivered to the user as a continuation of an SMS chat. These options can also be delivered to the user through the platform interface as a continuation of the link they received upon SMS prompt. The users may also elect to receive the updates they requested by email or phone call or physical mail. In essence, the platform intends to power the users regarding the notification delivery method and their access to platform features.

The users may also send STOP SMS as seen in point 664 to stop their services from the platform. In that case, they will be shown their options to reactivate their subscriptions as seen in point 665. In that case, the user's flow ends and their services are on hold until they restart again as seen in point 666. The users may also restart their services using the platform SMS option as seen in point 667. Once the user confirms they would like to restart service in 668, their scripts get re-activated. As a continuation, the platform may further ask if there is any further action to be taken in 669. If user think there is more actions as seen in point 670, they will be taken to main flow engagement, point 230.

These updates may be manual updates sent by the pharmacist or they could be automated based on the pharmacy or fulfilment service's internal computer records. When the prescription is received, a program could recognize that it has registered on their computer and automatically send out the appropriate update to the patient. When the pharmacist or other professional dispenses the drug and scans its bar code, the program could compare the bar code to the prescription prescribed and send an update to the patient that their medication has been dispensed. There is also the possibility for platform software to be integrated with the pharmacy or other service's existing computer systems, or to replace the existing system. It could also be a web-based program.

The pharmacist views and responds to customer questions, reviews quiz results, views refill requests, maintains customer accounts, maintains customer profiles, and receives updated recommended product defaults.

When a customer submits a question to the pharmacist, the pharmacist reviews the information requested and prepares an appropriate response. If the pharmacist believes the customer is experiencing some undesirable side effects or some other adverse reaction that requires immediate attention, they may contact the customer directly and request that they visit their physician. The pharmacist may determine that some questions that are repeatedly asked are better dealt with by providing all customers the opportunity to review answers to frequently asked questions using the web site.

The pharmacist reviews quiz results to determine if the educational content is effective in educating the customer. If numerous customers reviewing a particular educational module are getting the content questions incorrect, the pharmacist may wish to update the educational content or use other avenues of educating the customer with respect to the drug or treatment. The pharmacist may also review quiz results to determine if the customer has actually reviewed the material that was recommended to them.

The pharmacist views refill requests and prepare the refills for pickup according to the date entered by the customer. The pharmacy management system can include a scheduler that informs the pharmacist when a particular refill request needs to be filled so the refills are always ready for pickup as indicated. If authorization by the customer's physician is required before further action is taken, the pharmacist can note that and wait for the appropriate authorization. If the authorization is not received as the time nears for pickup, the pharmacist can use the pharmaceutical system to inform the physician of such required response.

The pharmacist maintains customer accounts and profiles adding new customers to the system, deleting old customers from the system, and updating any information that has changed for current customers. The pharmacist verifies all information when the customer comes to the pharmacy to pick up a refill to make sure that the customer still has the same insurance provider, physician, address, phone number, etc. The customer can update this information using the web site, but the pharmacist double checks the information before delivering the prescribed drugs or treatments. If other information changes for the customer, such as a new allergy, an adverse reaction, or a change in medical status (e.g., new disability detected), that information is input into the system.

The pharmacist receives updated recommended product defaults. Recommended products may be based on discounts the drug manufacturer is offering or may be based on other factors such as coverage of the product by the insurance provided. The pharmacist may also recommend products to customers those other customers with similar conditions or allergies used successfully. The pharmacist updates the recommended products the customer can view using the web site so the list is as up-to-date as possible. When the pharmacist utilizes the pharmaceutical system, the pharmacist is relieved of some managerial duties that occupy a large amount of time, thereby freeing the pharmacist to practice more pharmacological science. The pharmacist has more time to study new and existing drugs and treatments, and the pharmaceutical system increases the speed at which the pharmacist can review such information. In the end, the customer experiences better service from the pharmacist and, thereby, maintains a healthier lifestyle.

As noted, the pharmacy management system communicates with the server via the network to the database and the flow of information from the database to the pharmacy management database. As shown, the flow of information between the database to the database includes collecting updated data from the pharmacy management database including changes to the customer's profile, account information, prescriptions, responses, pharmacy, and physician and loading the updated information into the database. The flow of information from the database to the pharmacy management database includes collected updated data from the database including refills, quiz results, e-mail address, password, requests, and loading the updated information into the pharmacy management database. In one embodiment, the flow of information between the database and the pharmacy management database utilizes an XML, or other file layout.

### Outcome Monitoring

The platform could implement a prescription monitoring and scheduling feature where a patient or doctor can create a medication schedule, set reminders, and the patient can record when medications are taken. It can occur with an app or the use of voice systems (like Alexa) as well as email, phone, or other interactive communication between the patient and the system and/or the HCP. This data can be sent to their health care provider to see if they are in compliance, as well as predict when refills are needed. The program could sent the refill request to the patient's pharmacy or remind the patient to make another appointment with their doctor.

There could also be a symptom logging feature where a patient can log the state of their condition daily, and this log can be shared with their doctor as well as recording potential side effects as well as positive outcomes. There could also be used to provide independent cognitive or physical assessments that can be used as parts of clinical studies or simply monitoring different parameters/therapeutic progress. Monitoring can combine objective measures as well as subjective notices from the physician/allied care providers.

Patient histories generated by the inventive system can show not only the drugs prescribed, but also the conditions for which they were prescribed, allergies, demographics, insurance coverage, treating health care providers, and so on. Known medical management systems do not provide listings associating each prescribed drug with a patient condition or problem, as reported to, or diagnosed by their physician.

Careful review of a patient's record for relationships between amelioration of problems and prescription of particular drugs can provide important information about the efficacy of a drug for a particular problem in a given patient. Review of a physician's prescribing record, detailing the various drugs selected to treat the different conditions exhibited by the patients encountered in the physician's daily practice, can reveal valuable information about the physician's prescribing practices and the degree to which they follow formulary guidelines.

This information is clearly of value to the individual physician and can, if desired, be enhanced by including in the problem record a condition severity rating, enabling declines (or increases) in severity to be reported. The resultant patient prescription history, replete with dated information as to patient problems, what drugs were prescribed to treat those problems, what forms, routes of administration and dosages were used and, by implication from the timing and nature of subsequent problems, what the outcome of that prescription was, provides a very attractive treatment evaluation tool to a physician, and a powerful inducement to any professionally conscientious physician to use the prescription management system of the invention.

Implementing the invention on a wider scale, valuable new outcome studies and clinical trials are easily, or even automatically, performed. One of many problems in successfully implementing the herein described prescription management system on a large scale is one of funding the system. Medical cost structures, with their reimbursement systems leave little scope for expenditure on aids to overall practice improvements which may have to be squeezed out of tight overhead budgets. Accordingly, significant cost to the physician user, or user's medical facility will be a major deterrent to system adoption. Preferably the system is provided to prescribing users on a low-cost or no-cost basis with funding from outside sources.

Implementation of the invention is expected dramatically to reduce the overall cost of prescriptions and this saving has been estimated to be from 20 to 40 percent of total prescription costs. Savings will accrue initially to the drug benefit management companies who reimburse the direct costs of most prescriptions, but can be expected eventually to be passed to corporations and consumers by way of lower drug benefit rates. Such savings realized on a national scale would amount to many billions of dollars and provide an avenue of reimbursement for system proprietors. In the early 1990's, the cost of prescription drug benefits is one of the fastest rising components of all health care costs.

Outcome studies produced by the system may have substantial value to various parties, and their sale can support system costs, as may formulary compliance savings. For example, drug efficacy data is of value to pharmaceutical companies, as is early warning data from reliable specialists regarding adverse reactions. Subject to confidentiality and other relevant controls, such data can be automatically compiled and readily supplied by system management, requiring only approval, not active participation by involved physician prescribers. Equally, the system may facilitate clinical trials by identifying health care providers or prescribers who would be likely participants in trials, based upon their having frequently diagnosed relevant conditions, or specified relevant drugs, as shown by their historical prescribing profiles, or relevant patient histories. Suitable patient pools can be identified similarly.

Organizations participating in outcome studies, for example health maintenance organizations, insurance companies, hospitals, physician alliances and the like, and may pool their data but may not wish to reveal certain proprietary data. By employing data access control methods for accessing such organizational data, such as the methods described in detail herein for controlling access to patients' rights, the system of this invention can enable organizations to control what data they release.

To implement such clinical trials, additional information required for collection can be obtained by flagging selected prescribers' profiles to trigger additional on-screen routines so that whenever a trial-related drug or condition is selected by the prescriber, they will be asked to supply necessary additional information. For example, whenever a prescriber participates in a trial relating to treatments for gastritis, the system can request information as to whether certain tests were performed, and what were the results of those tests. Thus, the test drug might be appropriate for, or be in trials relating to, gastritis testing positive to H. pylori, whereas a different drug would be indicated for H. pylori-negative gastritis.

The platform can also provide, preferably from source databases, complete prescription drug disclosure requirements as set forth by the FDA, including full cautionary information, for example as is now set forth in the Physicians' Desk Reference (Medical Economics) knowledge of which by the prescriber may be necessary to avoid malpractice liability, and dissemination of which may limit a drug manufacturer's liability. Efficient promulgation of drug disclosure information to system users is tantamount to publication, yet can be more current than any printed document, and may be accepted as an alternative to hard copy publication or supersede it.

In addition, the system provides a valuable means for government agencies and others to communicate important messages, such as drug warnings and alerts, quickly and directly to physician users. Electronic mail accessed via Mail button 16 can be used for this purpose, and may include priority flags triggering screen alerts, but a much more powerful route for communicating warnings relating to particular drugs is to associate the alert with system information on the drug so that when a user calls up the drug in question, they receive the warning or alert, or other special message for patients reporting new problems after having been prescribed the new drug in question, refer such new problems to the physician user to qualify them for medical relevance and then statistically compare a collection of similar reports with data on a pool of similarly treated patients for significance.

Continuous post-market introduction monitoring of a drug in relation to the treatment of conditions is possible, and an end-to-end solution to the problem of managing unanticipated problems arising with new drugs can be provided: the system provides a vehicle data collecting relevant data; parameters and a means for analysis of that data; and a means for disseminating alerts and advisories regarding newly discovered problems. The same vehicle is used for all three steps.

With such a system enhancement, one specialist pioneering a new drug for a particular condition may provide an early warning of adverse reactions not identified in clinical trials in a manner not heretofore obtainable, because of the difficulty of, coordinating prescription and diagnostic data.

Quickly and conveniently presented at the point of care, as an integral part of the prescribing process, in the manner achieved by the system of the invention, this information can be of immense value to a physician when treating a patient, widening the physicians' choices beyond their own field of knowledge (by suggesting new drug information) and helping the physicians optimize the prescribing process.

Another advantage of the invention is that each physician user inherently and easily supplies critical enabling data for outcome studies as part of the prescribing process. No extra effort is required by the physician to make the data available for studies. One potential difficulty in making such studies is the existence of legal barriers to aggregating patient data into studies without specific patient permission. While this might be obtained on a piecemeal basis or by the prescribing physician, a much better solution is provided by centrally maintaining patient directed patient-record-access specifications, as described above. The system can then include only those records of patients agreeable to becoming study participants in such outcome studies.

The historical drug-prescribed and condition treated records obtainable by using the invention can provide a basis for condition-based treatment guidelines developed by drug formularies. This novel data provides a new vehicle for outcome research for managed care, leading to new approaches to cost-effective prescription treatments.

Compilation of an extensive or national database of (patient-anonymous) records providing a statistical historical listing of drugs prescribed versus associated conditions for which they were prescribed would be in the public interest and of considerable value, so long as patient-confidentiality were maintained. Widespread adoption of the present invention can help achieve this desirable goal. It is relevant to note that FDA regulations only permit a drug to be promoted for approved, specific therapeutic purposes but physicians are professionally free to prescribe an approved drug for any condition for which they believe the drug to be effective or useful so that, failing specific point-of-care diagnostic information, no assumptions can be made as to

In the extreme case of withdrawal of a drug from the market, that fact can immediately be communicated to system users. Thus a drug can be withdrawn from the market the same day by making a system entry preventing completion of a prescription for the withdrawn drug. Alternatively, a warning can be posted directly to the prescription. Current users of the medication can be identified from prescription history records, referencing not only drugs prescribed, but also prescription expiration dates. Both the patient and their doctor can be notified immediately. In this case, electronic mail is a preferred route for notifying the physician.

Relative cost-to-benefit data can also readily be prepared in outcome studies when individual drug costs are factored into the data, and such cost/benefit data can, in some circumstances have very substantial dollar value to drug benefits management companies whose objectives are to maximize the quality of care while minimizing the cost of that care.

Pharmaceutical and managed care companies can gain marketing benefits from use of the system to introduce new drugs or new uses of old drugs to physicians, in a relevant manner, at a moment of peak interest.

Other benefits can be derived from outcome studies using the novel drug-prescribed and condition-treated data records provided by the prescription management system of the invention. For example, the appearance of a new patient problem may be insignificant when associated with prior prescription of a particular drug for one patient, but may gain significance when repeated for a number of patients.

Optional system enhancements may enable post-introduction market surveillance of new drugs to be conducted for adverse outcomes to the treatment of a specified condition or conditions. For example the system may monitor treatment objectives of any particular prescription. Accordingly, prior to the present invention, statistical prescribing data have generally lacked knowledge of why a physician prescribed a particular drug, and such data is, in most cases, not useful for outcome studies and cannot be related back to other patient-specific variables present in the patient's medical record.

Ensuring that a patient complies with the terms of a prescribed treatment, neither neglecting nor overindulging in a prescribed drug therapy, is a serious problem in health care management. It is difficult to ensure that out-patients actually ingest the prescribed amounts of medication at the prescribed intervals. Many mistakes and abuses occur. The problem is exacerbated when a patient is prescribed a confusing multiplicity of drugs that may have to be ingested in different amounts at different times of the day. The present invention enables, and includes, unique solutions to this problem that greatly facilitate a patient's ability to comply with a simple or complex regimen of dosages, without costly skilled supervision. In addition, many types of intentional abuse can be monitored and possibly prevented.

One approach to enhancing patient compliance, according to the invention, employs a novel dose-scheduling drug package that is readily adaptable to accommodating and scheduling single or multiple prescription dosages to help a patient take the right dose of the right drug at the right time, and will be described in detail hereinbelow.

Another approach is, to some extent, inherent in features of the prescription management system described herein. Where multiple physicians accessed by a patient utilize the system described herein, with common online access to, and assembly of, a patient's prescription history record whereby that record provides a current record of new prescriptions, then a common abuse can be controlled wherein a patient presents a problem or condition to more than one physician to obtain multiple prescriptions with a view to indulging in abusive ingestion or illicit resale. This problem is especially prevalent with analgesics. Where a physician, or perhaps pharmacist, if the patient's prescription history is available to the pharmacist, sees a similar current prior prescription has been issued, they can refuse to duplicate it.

Clearly, regulatory authorities wishing to control such abuses can further that goal by encouraging widespread, or universal, deployment of the prescription management system of the invention. Where the system also provides, for example in the patient's history record, notification from a pharmacy, or from a drug benefit plan linked to the pharmacy, of fulfillment of a prescription, and that information is available to the prescriber, for example from the patients' history record, another common abuse wherein a patient pleads loss of a prescription to obtain a duplicate, can also be prevented.

Bringing fulfillment information from the pharmacy to the point of care via the patient's record or other convenient reporting medium, with or without the intermediary of a drug benefit company linked as a remote source database, can provide not only a valuable prescription abuse monitoring parameter but can also be used to enhance compliance with the prescribed treatment, especially if coupled with an alerting system.

For example, the system may alert a prescriber that the intended expiration date of a critical prescription has passed without the prescription having been filled. The prescriber thus becomes aware that the patient has gone off the medication and can take steps to contact the patient and alert them to the dangers or problems that may arise. Alternatively, routine alerts can be passed to administrative personnel associated with the prescribing health care provider, notifying them of any unfilled prescription after a prespecified period of say two weeks or a month, or prescription expiration, or a shorter period for more critical medications.

The prescription orders and the prescription data may be used to determine a combined dosing regimen that has the instructions for taking the individual medications. Where there is a conflict between the two sets of dosing instructions, the customization engine may alert the user, such that the user may contact the physician and confirm the proper dosing instructions. In the alternative, the customization engine may automatically contact the prescribing physician via email, text, fax, automated call, IM etc. and alert him/her to the conflicting prescribing data and solicit his/her correction in that manner. Where there are no prescribing instructions, the dosing instructions are set to a default setting. This default setting may be morning, night, afternoon, or any other chosen period suitable for the patient's schedule or system preferences.

The dosing schedule is combined with personalized patient information to create a schedule that determines which medications, based on the patient activities of daily living, need to go in which medical container(s) of the customized medication package. Only qualifying medications or medications that can be packaged into the medical containers by the robotic packaging machine will be placed into the customized medication package. Extended packaged or reminder instructions may be placed on the outside of the package to remind the patient to take any non-qualifying medication. Qualifying medications are medications that the robotic machine is instructed and capable of packaging into the customized medication package, whether it be by using a drop try or by standard operation of the robotic machine. Non-qualifying medications may include inhalers, liquid medication, patches, topicals, sublinguals, troches, powders, atomizers, infusions, injections, sprays, drops, capsules, suppositories, or medications that should not be combined or will not work with the robotic machine. What else comprises of this system is

Personalized patient information may be their specific symptoms to the drugs, schedules (personal or professional or medical), and/or conflicts between medications. The customization engine may also be configured to execute a medication dosing assignment module or schedule module that determines how various medications may be placed into individual medication containers. A prescription order data set that includes multiple prescriptions for various medications may arrive from a spoke pharmacy for filling. The dosing assignment module may parse the prescription data for each prescription to determine any specific physician assigned dosing instructions in the SIG (prescriber instructions). If the physician/prescriber has assigned specific dosing times in the SIG, then those dosing instructions are incorporated into a schedule. If not, the remaining prescription data will flow to a dosing assignment program implemented by the dosing assignment module. Each medication's Product Identification Code (PIC) may be used to match codes indicated in a proprietary file developed from one or more internal database(s) and/or an external source such as the aforementioned First Data Bank, Medi-Span, Drug Manufacture Guidelines, Red Book, Gold Standard, American Geriatric Guidelines, OBRA Guidelines and/or any other similar sources. If a match for the PIC is found for a given prescription, that dosing instruction may be utilized for that prescription. If not, all remaining prescriptions may be provided a default dosing assignment.

The dosing assignment module may then determine whether a medication from a prescription can be comingled and identify these medications as requiring a separate medication container according to that medication's GPI. The non co-mingled medications may then be packaged in separate medication containers with the first default assignment and labeled as “1 of total (e.g., “1 of 3”, “2 of 3”, and “3 of 3”) for a dosing period. In the alternative, a medication in the robot machine inventory may be identified as being comingled or not co-mingled. Co-mingling may be an assignment done at the robotic packaging machine.

Color coding may be used on the multi-med application label(s) to indicate time of day to take drugs contained in the multi-med package. Additionally other symbols could be used to indicate the time of day to take the medication in the package. Furthermore, vials, blister packs and other such medication containers that may or may not be a part of a multi-med package could use color coding, icons, symbols or particular wording to indicate the time of day to take the drugs, the particular patient in a multi-person household, the type of drug contained in the package, and/or the strength of the drugs.

The first default assignment may be labeled the “Morning/AM” period, based on an assumption that patients will likely take their medications before starting their daily activities. The customization engine may determine the number of medications that have been assigned to the “Morning/AM” pouch. The dosing assignment process may cap the number of medications for any given administration time at any number chosen by the program users. For example, up to four pills per administration time, up to two pills per administration time, up to 6 pills per administration time, or other such chosen number. This number may be assigned based on patient preference, patient abilities to swallow medication, patient age, doctors/prescribers preference, filling pharmacies preference, medication container size, medication available strength, SIG, care giver preference, pharmacist preference, federal rules and regulations and/or other such reason.

If the “Morning/AM” pouch has not been filled by the pre-determined number of medications, the next prescription in the file may be assigned to this medication container. The next prescription in the file may then be assigned to the current medication container until that medication container reaches its maximum limit of four medications or whatever the chosen maximum number is. If there are additional medications to be assigned, the customization engine may repeat the same process for a second dosing period, such as an afternoon container, mid-morning container, evening container etc. There may be multiple dosing periods throughout the day. For some patients two dosing periods are sufficient, for others up to four, for others up to 8, and so on.

The system may have a set number of dosing periods arranged in a prioritized filling order such as-morning dosing period always filled to maximum first, followed by evening dosing period, followed by afternoon dosing period, and so on, or the system may allow for customization of dosing period prioritization based on patient, prescriber, pharmacist, activities of daily living, insurance provider, care giver or another such persons or reasons preference. If there are still additional medications to be assigned, then the customization engine may repeat the same process for a third dosing period. The dosing assignment process repeats until all prescriptions in the file have been assigned to a specific dosing period.

The schedule may be programmed to assume that all prescriptions taken less frequently than daily will have a calendar date for administration listed in the SIG. The schedule module may further be programmed to assume that all medications to be taken at multiple administration times within a 24 hour period start with the “Morning/AM” assignment. The customization engine may also be programmed to assume that prescriptions with alternating medication strengths will have the calendar date of administration of the first dose in the SIG. Any deviation from these assumptions or a lack of data for these cases may be rejected back to the spoke pharmacy to contact the prescribing physician for clarification or to generate an automated communication to the prescribing physician's office for clarification. A hub pharmacy technician may access the customization engine via MMAA website to review any pertinent physician notes and match the patient's prescriptions to the medications currently available in the canisters contained within the drug packaging robot. The customization engine prepares one or more set(s) of instructions for the customized medication package. This set of instructions may be a digital set of instructions that can be programmed into a phone or device or emailed to a patient and/or pharmacist and/or doctor or it may be a one-page HOA patient label, an adherence calendar, packaging instructions, packaging labels, inventory reports, and/or delivery reports. The set of instructions may contain the patient's schedule, drug information, pill count, pharmacy information, prescriber information or other such information.

The drug package design module may assign the appropriate dosing instructions to the individual medication containers within the customized package as well as one or more of other patient specific and/or container specific information, including but not limited to patient name, day of the week, date to be taken, time to be taken, drug name(s), drug code, drug strength, number of tablets of each drug in the individual container, Rx number, product identifier code, expiration date of the product, manufacturer, manufacturer lot number, name address and/or phone number of the pharmacy packaging and/or dispensing, medication indication (indication for which the medication is prescribed), prescriber's name, description of the medication and/or imprint, package certification number, and/or the number of containers to be taken per dosing period. Based on manufacturing preferences, the dosing instructions and or other specific patient information may be contained within the set of instructions created separately and/or printed directly on the customized package itself. It is to be understood that icons may be used instead of wording. Once completed, the hub pharmacy technician may place the customized packaging and documentation into a hub checking stage.

A customization engine identifies the available canisters in inventory through its inventory canister management module and may print or display a Special Tablet System (STS) report from the customization engine for a store level batch. If desired, the customization engine may delay running a patient's customized package if there is a medication requiring the special tablet system. Medications that may require the special tablet system may be one or more of the following: half tablets, cyto-toxic medications, medications without an available canister, medications that are friable or have heat sensitive coatings, or any medication that requires special handling. Any medications that are not available in the robot canisters may be filled utilizing the STS process. When the STS report is being run, the inventory canister management module is also checking the drug inventory within the robot filler.

The inventory canister module may track inventory coming into the pharmacy from multiple places, assign origin information to the inventory and customize the canister(s) in the robotic filler to receive the inventory under one or more of the following identification codes, including but not limited to: customers name, patient's name, drug name, providers name, prescribers name, insurance providers name, drug number, drug PIC, etc. The identification code may be used to assist the robot filler in determining which of the canisters to use when filling an order. The customization engine will facilitate filling and refilling of the canister through the use of identification codes, which may be associated with a barcode. The manufacturers medication may be associated with particular information including but not limited to drug name, image, strength, expiration date, lot number, pill size, drug location, drug linkage, pharmacy information, provider information, technician handling etc.

All this information may be stored within the inventory management module to assist the hub pharmacy in tracking the medication used to fulfill scripts. The hub quality assurance (QA) technician may retrieve each medication strip pack from the robot and place it in a QA inspection area. The hub quality assurance technician may scan their ID as well as the individual strip pack they are checking to create a record in the customization engine program in the name of the QA technician conducting the check. The hub quality assurance technician may visually check each pouch for crushed or broken tablets, miss-drops, print quality issues, defective pouches, and the required number of tablets per HOA. Any defective pouches may be de-blistered and the patient order may be repackaged to correct the defect (repeat filling process).

Once the batch check is completed, the hub quality assurance technician may scan their ID and electronically sign the manifest, and then stage the pouches for the hub pharmacist to review. If there is an error or an issue with a package, the customization engine may create a label for that specific package that contains the printed information that was on the original package or adjusted information for the corrected package. The technician can then place the label onto the corrected package. In the alternative, an error message may be placed on the package with corrected instructions—don't take the extra pill. The re-print or adjusted instructions may be inputted by a pharmacist, prescriber, robot machine operator, technician and or any other qualified person.

The customization engine may use a drug package modification system to allow the pharmacist to access a batch that has been run, make a manual correction within the package run, print reports to show correction and/or labels to show correction, and review any packaging errors and corrections. The user may identify the batch by using one or more of the following: including but not limited to, patient name, batch number, bar code, patient code, drug name, prescriber name, spoke pharmacy identifier, technician etc.

The corrected information is added to the patient's customized package report and the new order merged with the existing order. Instructions and/or labels may print automatically or may display automatically. The pharmacist will then be able to make and easy manual correcting within the container and reseal the package. This system allows for package correction without needing to run the entire script again, which decreases time and waste. In addition, should a recall issue, this process allows for manual correction with reduced pack-aging errors as the recalled drug may be pulled and the remaining drug left unaffected in the packages.

### Medical Identity Engine

Those entering the medical field arrive with a personal identity that has been formed since birth. As they proceed through the educational continuum, they successively develop the identity of a medical student, a resident, and a physician in the US. Each individual's journey from layperson to skilled professional is unique and is affected by who they are at the beginning and who they wish to become.

Identity formation is a dynamic process. Multiple factors within and outside the educational system affect the formation of a medical professional's professional identity. Each learner reacts to different factors in her or his own fashion and their perception of new information is highly influenced by their beliefs and perspectives on life and matters that may not be even related to medicine. An individual's vocation is a stabilizing and integrative force in their identity. Therefore, it is safe to assume a professional (medical) identity formation must be psychologically aligned with the process through which human beings develop a personal identity. Their sex, race, personal characteristics, culture, life experiences, socioeconomic status, education represent major influences in their life and surely are effective factors that may shed light into the way they perform their profession. This may be a complex phenomenon like their stance on certain medical issues, as well as more mundane actions such as the drugs they prescribe to, dosage amount and frequency, their interactions with their patients etc.

In our complex medical environment, in which technological, political, legal and changing market forces can all influence the practice of medicine, the platform may gain advantage by owning a proprietary database that could collect information on every medical professional in the field and utilize the input data to create a knowledge map that records their past to predict their future behaviors to ensure full transparency to the users of the platform as well as achieve medical goals such as honesty with patients, patient confidentiality, maintain appropriate relations with patients, improve quality of care etc. The knowledge may be utilized to analyze professionals in the medical field to score them on certain metrics and provide full transparency to the users of the platform.

The platform may contain multiple electronic databases stored in order to collect, analyze and organize medical records of every stakeholder within the medical industry. To own a large and clean database that collects information from potential patients and other healthcare industry stakeholders is crucial in order to achieve an end-to-end omnichannel healthcare management platform.

The platform may be equipped with a certain healthcare information management database that comprises of healthcare professionals, pharmacies, patients, healthcare institutions and other related stakeholders in order to ensure optimality in the tasks that the platform intends to achieve.

A preferred feature of the platform and the healthcare information management database is a knowledge map which provide an interface to identify medical professionals across the world which understand their behavior by performing analysis across multiple databases such as payments received, tweets tweeted, articles published, diagnoses executed and any other behavioral, financial, social data that the platform may have stored or scraped from the web by a dynamic algorithm.

The biggest hurdle in achieving a comprehensive knowledge map of healthcare professionals is the sheer size, complexity of the entire database and irrelevancy of certain data points in the entire database. United States alone has around 5-6 million medical professionals, and the number would only increase when other countries are considered.

The platform is therefore almost obliged to come up with a smarter method to match data points scattered across multiple large databases into a smaller and cleaner dataset in which each healthcare professional is assigned to a unique identifier and the information associated with them across several databases are accurately collected and matched to them in a smaller and cleaner dataset. In example, a medical professional who has a presence in payments database is matched with their associated presence in publications database, if it exists.

Given that there is no unique identifier that the platform can utilize across multiple datasets, it must compare all the presences of each medical professional in multiple datasets and conclude if there is a match on a pre-determined standard. This would either take inordinate number of processing and storage power and is not economically feasible.

Since the datasets do not contain equal number of attributes for each medical professional and most of the data compilation do not occur in a clean format, there needs to be a flexible system which compares disparate attributes.

Calculating unique medical presences across various healthcare datasets is only possible by comparing and identifying similar presence across multiple datasets. In order to compare multiple datasets, the algorithm must perform identity comparison in one dataset with another. This would mean m*n comparisons, where m and n are total number of records present in respective datasets.

The challenge with m*n comparisons is it does not fare well when it comes to scale. Some of the medical datasets embedded in the platform contains millions of presences, that would lead to trillions of comparisons, and would force the system to run out of either memory or computation processing time.

Another solution that is adapted by most in the industry is to identify only 1 or 2 attributes and use a traditional index-based comparison. The problem with this approach is that no attribute in such large database can work as a unique identifier. It is more than likely that each attribute such as last name, city they live in, institution they work for will not perform as a unique key. In this approach, the algorithm will more than likely end up with duplicates or incorrect matches and poses an extra risk when there is no readily available metric present to state the confidence with which the algorithm is making the match.

In order to meet and solve above challenges, the platform is enriched by a proprietary algorithm that enables data comparisons across massive datasets with limited computing resources and within 4-5 hours. The goal of the algorithm is to match and compute unique medical identities by combining various medical datasets and performing comparisons in a quicker iterative process that enables flexible data comparisons across disparate datasets. In an ideal scenario, reducing the size of either M or N is essential to reduce to overall number of M*N comparisons and hence bring down the complexity of the computation to be performed.

In order to facilitate above challenges, a proprietary algorithm has been developed and embedded in the platform to compose a medical identity engine. The algorithm can be defined as a variation of locality sensitive hashing with Jaccard's Minhash algorithm. This is a hashing algorithm which identifies similar candidates in their local neighborhood. It is an iterative process in which probable match candidates in the entire database are selected to reduce the number of m*n comparisons. Presences that do not have any successful matches are labeled as orphans and move them into alternate matching categories. Orphan candidates from one dataset would be matched with orphans from other datasets considering all permutations. This is achieved by using Jaccard's similarity as a similarity metric with a comparison threshold. This technique is particularly advantageous in large scale clustering operations.

The nearest neighbor problem is defined as follows: given a collection of n points, build a data structure which, given any query point, reports the data point that is closest to the query. A particularly interesting and well-studied instance is where the data points live in a d-dimensional space under some (e.g., Euclidean) distance function. This problem is of major importance in several areas; some examples are data compression, databases and data mining, information retrieval, image and video databases, machine learning, pattern recognition, statistics and data analysis. Typically, the features of each object of interest (document, image, etc.) are represented as a point in d and the distance metric is used to measure the similarity of objects. The basic problem then is to perform indexing or similarity searching for query objects. The number of features (i.e., the dimensionality) ranges anywhere from tens to millions. For example, one can represent a 1000×1000 image as a vector in a 1,000,000-dimensional space, one dimension per pixel. There are several efficient algorithms known for the case when the dimension d is low (e.g., up to 10 or 20). The first such data structure, called kd-trees was introduced in 1975 by Jon Bentle, and remains one of the most popular data structures used for searching in multidimensional spaces. Many other multidimensional data structures are known. However, despite decades of intensive effort, the current solutions suffer from either space or query time that is exponential in d. In fact, for large enough d, in theory or in practice, they often provide little improvement over a linear time algorithm that compares a query to each point from the database.

This phenomenon is often called “the curse of dimensionality.” In recent years, several researchers have proposed methods for overcoming the running time bottleneck by using approximation. In this formulation, the algorithm is allowed to return a point whose distance from the query is at most c times the distance from the query to its nearest points; c>1 is called the approximation factor. The appeal of this approach is that, in many cases, an approximate nearest neighbor is almost as good as the exact one. In particular, if the distance measure accurately captures the notion of user quality, then small differences in the distance should not matter. Moreover, an efficient approximation algorithm can be used to solve the exact nearest neighbor problem by enumerating all approximate nearest neighbors and choosing the closest point.

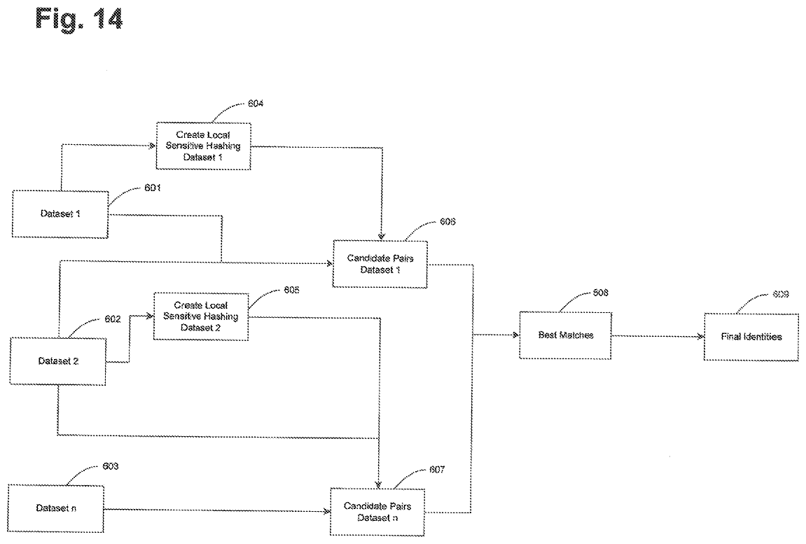

Now turning to FIG. 14, it can be seen from point 601, 602 and 603 the first step of forming medical identity engine is gathering medical datasets that the platform intends to combine to acquire a unique list of identities as the input set into the identity matching engine. These datasets can be varied if they have similar medical presences.

In the next step as shown in 604 and 605, local sensitive hashing datasets are created in order to break the multidimensional plane of datapoints into smaller planes in which it is computationally easier to perform comparisons. These locality sensitive hashing objects are created by applying Minhash with Jaccards similarity as a threshold factor.

We later use the original dataset and query it against the LSH of the dataset identified as a match candidate pairs for every single presence in the source dataset. This will result in a large number of probable candidate datasets, where number of datapoints in each set is going to be significantly smaller than the entire database. This can be seen in point 606 and 607.

In the next step, all possible matches are compared for a single presence and pick up the best match by applying a comprehensive similarity function and a minimum threshold line. If no satisfying match is identified, a unique identifier with that data point is deemed as an orphan and the identity engine process is repeated with other identified orphans as shown in point 608.

Final step of the process is to gather all the identified matched from various combinations of input datasets and create final list of unique medical identities to bolster the general knowledge of the platform on medical professionals. This can be seen in point 609.

The proprietary algorithm aided the platform in identifying around 8 million unique identities with a 70 percent average confidence across all medical datasets that it contains. It also identified 150K common presences in more than 3 input databases.

### Structural Elements

Exemplary embodiments are intended to cover all software or computer programs capable of performing the various heretofore-disclosed determinations, calculations, etc., for the disclosed purposes. For example, exemplary embodiments are intended to cover all software or computer programs capable of enabling processors to implement the disclosed processes. In other words, exemplary embodiments are intended to cover all systems and processes that configure a document operating system to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

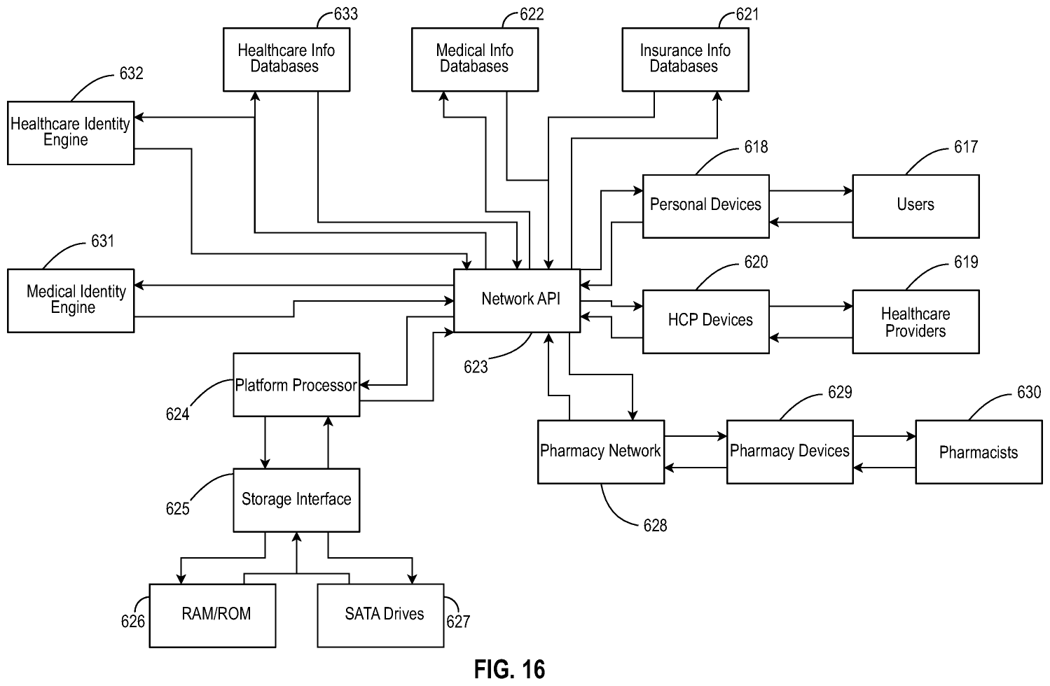

Continuing from FIG. 16 the flow of information between the users of the platform, stakeholders of the industry and the method of completing transaction related to healthcare management platform by communicating, analyzing and verifying information is shown.

A healthcare information management system comprises of main database systems as shown in point 621, insurance information databases and point 622, medical information databases. These databases are accessible via remote computer systems; a plurality of remote computer systems located at healthcare practitioners as shown in point 620, pharmacies as shown in point 629, patient members as shown in point 618, and other parties such as insurance providers.

The central database systems comprises a network server for communicating with the various remote computer systems as shown in point 623. Communication to the network may be over the Internet, other networks, telephone, or other suitable means. The central database systems further comprise a central database and database server for storing and retrieving information about medical patients, medical practitioners, pharmacies and insurance providers as shown in 621 and 622. In particular, the database contains health histories of the medical patients and records of treatment by medical practitioners including records of medical prescriptions issued by medical practitioners and fulfillment of medical prescriptions by pharmacies. This is shown in point 631 and covered in detail in the earlier section as it pertains to the medical identity engine. Medical identity engine is a collection of all the publicly available information on physicians and licensed healthcare practitioners, mainly the drugs they prescribed to in order to bring transparency to the users of the platform and become more competent in future predictions that are related to healthcare physicians.

The network server is operated by software which allows communication with the remote computer systems and transfers information to and from the database server for maintenance of the database and for providing patient specific information to medical practitioners, pharmacies, medical patients, insurance providers, and other authorized parties. The central database system further comprises an application server which provides software which assists medical practitioners in prescribing medications and assists pharmacies in confirming the suitability of a medication for the patient.

The health care information management system further includes a plurality of computer systems at pharmacies as shown in 629 and 630. These systems comprise the same components as a healthcare practitioner's system, though with somewhat different software, and a scanner for reading a code from a medicine container. The code is preferably a universal bar code which identifies the drug contents according to a predefined standard. The software operating the pharmacy computer system enables it to read a prescription from a patient's smart card. The software also allow the pharmacy computer system to recognize digitally signed “electronic prescriptions” received as e-mail for a patient without a smart card.

The drug is then secured and an identifying code is scanned from the container. The software enables the computer system to compare the prescribed drug with the scanned result and verifies that the prescription is correct. If verified, the prescription is filled and the smart card is updated to indicate that the prescription has been filled. If more than one refill was prescribed, the refills remaining are decremented, and the card is electronically signed by the pharmacy. The software is programmed such that the pharmacy computer automatically sends electronic messages to the prescribing medical practitioner and the central database confirming that the prescription has been fulfilled when the smart card is updated. Electronic messages are also sent to the practitioner and to the central database system when the pharmacist indicates that an electronic prescription, received by e-mail, has been filled.

The health care information management system further includes a plurality of optional patient computer systems as shown in 617 and 618. Patient systems comprise a computer, smart card reader, and preferably a biometric measurement device and an Internet connection. The patient system comprises software to allow a patient to input health history, personal data, emergency contacts, health practitioners, pharmacies, insurance providers, and others. The software allows a patient to read but not modify records of treatment or prescriptions. The data available to the customer can be selectively shared and used by all of the parties as desired. This selective sharing of data between parties is represented by the circular arrow configuration around the customer. The networking systems and methods of the invention ultimately provide the customer with access to each of the parties, and in turn, provide each of the parties with at least limited access to the customer and the customer's information. As such, the network becomes personalized and extremely useful to the customer for making pharmaceutical decisions.

In some embodiments, platform user security may be provided by password protection operating hierarchically on one or more levels, to provide varying degrees of access according to the user's level of authorization, as desired. Additional password or numeric code control may protect sensitive system-accessed information, for example, patient records, or parts thereof, or physician-user data, including personal lists and prescribing profiles.

Patient record access codes can, in selected instances, be patient provided, or granted by intelligent security control cards, having been furnished to the patient by a system administrator, or agent, prior to the physician encounter. Physician or other user access to a patient's record, or to sensitive details thereof, can thereby be restricted to a need-to-know basis. Access by third parties to physician-related data can be similarly protected.

In some embodiments, provision for override of such security features should be available, for example for an emergency room doctor, and is allowed on a special case exception basis, is auditable, and traceable to the overriding user. Password-controlled access to many computer networks is often workstation dependent with each workstation using a unique password to access the network. Although user passwords may also be employed, these are often workstation-dependent, for example, being incorporated in the workstation's login scripts. In contrast thereto the present invention prefers that user access to the host computer facility be device-independent so that a given user can access the system via any of numerous devices, provided they have the right password or passwords. By this means, users are not dependent upon a single device that may be lost or misplaced.

A still more preferred feature is to have user passwords which link each user with an individual profile or style sheet on the host computer facility representing the user's patterns of preferences so that the user-customization features of the system, which will be described more fully hereinafter, are readily available to the user independently of the particular interface device that happens to be employed for accessing the system.

These and other device-independent features can permit the prescription management system to be fully operative without committing useful data to storage on the user device. This is a valuable security feature. In the event of theft or attempts at unauthorized use, even by skilled third parties, a user device will be worthless as a means to access sensitive data on the system or to use the system illegally.

Optionally, lost or stolen devices can be deactivated by the application or by system software, after user notification, by erasing or otherwise rendering device-resident application procedures inoperable, without loss of device-resident data. Use of a virtual patient record, as described herein, which need not be stored locally, is a valuable safeguard against unauthorized access of confidential data on lost, stolen or “borrowed” user devices.

Currently contemplated preferred embodiments further control the processing and storage demands placed on the user's device by intelligently delegating data-processing and storage activities to a linked remote, host computer facility, as referenced above, to the extent warranted by the capabilities of the user device. Thus, for example, a comprehensive drug database may be stored and maintained on such a host computer facility with selected data, for a particular drug list or an individual drug's formulation characteristics, being forwarded to the user's device on an as-needed basis, then being eliminated from the user device when no longer required. Other activities may advantageously be performed locally on the device, such as dynamic assembly of records from elements retrieved across the network from remote storage, and storage of the user's personal or most frequently referenced data and data lists, where the device's capabilities permit.

Advantageously, a user profile can also be stored on the host computer facility so that if the user device is lost, broken or stolen, a new device can be automatically reconfigured across the network linking the user to the host facility, so that the application behaves the same.

Preferably such a host computer facility also provides customized services to each user device, performing “user-adaptive” functions for that device, as described herein, to adapt it to its authorized user or user's prescribing behavior and improve the level of assistance provided to the user. Employing such off-loading techniques, permanent storage capabilities of the device can be minimized in favor of faster RAM storage capabilities as shown in point 626.

The screens are designed to be non-intimidating to computer-inexperienced professionals and to present familiar information and terminology to them while avoiding specialist computer jargon. Individually, they are easy-to-use for novices yet rapid enough for experienced users. Collectively, they provide an appealing system interface which can flexibly integrate into a physician's personal workflow.

In addition, the screens are laid out in the manner of appealing logical forms that echo familiar data formats encountered by a physician in their day-to-day work. An important objective is to make the screens self-explanatory within the professional's normal terms of reference so as to avoid any need for access to help, although of course, HELP buttons can be provided if desired and extensive help documentation can also be provided. System utilities such as indexing, setup and purging are either concealed from the user or removed for execution on a remote host computer facility. Data integrity and availability responsibilities are also delegated to the host computer facility, or its remote data suppliers. Thus data saving, archival, backup and data-replication functions are host facility responsibilities, not concerns of the user.

The system is designed to require a minimum of actual text or data entry. So far as possible, item entry is affected by selection from lists of items, for example by highlighting an item, then clicking a mouse, or more preferably penning, to activate an item. The prescription management system is made as user-friendly to physicians as possible, for example, by using familiar professional terminology and abbreviations. Thus terms such as “Patient” or “Pt”, “Drug” or “Rx”, “Condition” or “Dx” and “Treatment” or “Tx” are used rather than confusing generalities such as “subject” and “item” that often appear in generic software. The Prescription Management System shown in this embodiment of the invention has been designed for use with small portable personal computers, especially handheld devices known as personal digital assistants. Those skilled in the art will understand that the system can readily be used on or adapted to other hardware platforms, for example, a physician's desk top computer and can be expressed in different software interfaces from that shown.

Of scientific note is that the system is privy to and operates at the confluence of three powerful emergent data streams: encyclopedic data on therapeutic agents intended to moderate particular conditions or patient problems; data on individual prescriber activity using skill and judgment to diagnose conditions or problems and make prescribing decisions selecting and applying therapeutic agents to diminish diagnosed conditions; and patient history data recording not only prescribing decisions but also the results of those decisions. Thus, the system captures not only prescribing activity but also the prescriber's intent, the problem or condition targeted by the prescriber in specifying a particular drug, and can track the success of that intent. The linkage of treatment with condition treated captures the reason why the doctor took the prescribing action that was taken. This intent may, and can legally, be different from approved FDA therapeutic indications for a drug.

What is claimed is:

1. A computer-implemented method for integrating healthcare related events and services for a customer having insurance coverage provided to the customer by a healthcare insurance provider via a web-based platform, the method comprising:
providing a link to a customer that enables the customer to access the platform so as to enter healthcare information that includes insurance information relevant to the healthcare insurance provider during an initial registration session;
receiving and storing the entered healthcare information via a secured storage medium;
receiving and storing coverage information from the healthcare insurance provider including indications as to whether a certain diagnostic or therapeutic is covered by the insurance provider;
comparing the entered healthcare information to the coverage information to determine whether the certain diagnostic or therapeutic is covered by the insurance provider during the initial registration session;
upon determining that the therapeutic or diagnostic is covered by the insurance provider, transmitting a communication to the healthcare provider indicating that the certain therapeutic or diagnostic is covered by the insurance provider;
upon determining that the therapeutic or diagnostic is not covered by the insurance provider, transmitting a communication to the customer that includes an uncovered cost due for the therapeutic or diagnostic and facilitating the payment process from the customer to the healthcare provider via a secure payment processor;
identifying a pharmacy that is local to the customer and accepts the customer's healthcare coverage;
transmitting the prescription information to the identified pharmacy and facilitating the payment process from the customer to the pharmacy via a secure payment processor; and
notifying the customer of the identified pharmacy.

2. The method of claim 1, wherein the step of providing a link that enables the customer to enter healthcare information further includes name, date of birth, shipping zip code, SSN, Medicaid Benefit Information, Gender, and Pharmacy NPI.

3. The method of claim 2, wherein the step of providing a link that enables the customer to enter healthcare information further includes a conversational AI agent configured to request the customer to accept a service and HIPAA agreement before receiving and storing the customer healthcare information.

4. The method of claim 3, wherein, upon determining that the therapeutic or diagnostic is not covered by the healthcare insurance provider, offering a discount program for a customer without insurance coverage for the healthcare related events and services.

5. The method of claim 4, wherein, upon determining that the therapeutic or diagnostic is not covered by the healthcare insurance provider, offering a cash only option for the customer without insurance coverage for the healthcare related events and services.

6. The method of claim 5, wherein, upon determining that the therapeutic or diagnostic is not covered by the insurance provider, facilitating a claim process between the customer, the identified pharmacy and healthcare insurance provider to enable the customer to access the healthcare related events and services.

7. The method of claim 6, wherein, upon determining that the therapeutic or diagnostic is not covered by the healthcare insurance provider, offering a cash only option for a customer without the insurance coverage for the healthcare services related events and services and facilitate a payment process via the secure payment processor by sending token, payment information and payment amount.
